(19) United States
(12) Patent Application Publication
(10) Pub. No.: US 2010/0146013 A1
(43) Pub. Date: Jun. 10, 2010

(54) GENERALISED SELF-REFERENTIAL FILE SYSTEM AND METHOD AND SYSTEM FOR ABSORBING DATA INTO A DATA STORE

(76) Inventor: Andrew Harvey Mather, London (GB)

Correspondence Address: KLARQUIST SPARKMAN, LLP, 121 SW SALMON STREET, SUITE 1600, PORTLAND, OR, 97204, US

(21) Appl. No.: 12/634,559

(22) Filed: Dec. 9, 2009

(30) Foreign Application Priority Data
Dec. 9, 2008 (GB) 0822431.3

(51) Int. Cl. G06F 17/30

(52) U.S. Cl. 707/803; 707/E17.005

(57) ABSTRACT

Embodiments of an unrestricted binary unambiguous file or memory mapped object are disclosed along with descriptions of corresponding reading and writing processes. The file or object may be used to store data of any type. ‘Binary unambiguous’ refers to a quality whereby the binary data stored within the datastore (file or memory map) is always and uniquely identified by a binary type identifier readily discerned from the self same map. Similarly, the term ‘unrestricted’ refers to the capacity of the protocol to accept data of any type, nature, format, structure or context, in a manner that retains the binary unambiguous nature of embodiments of the disclosed technology for each data item. A storage object so created may be easily read by dedicated software, and as well as with the provision of appropriate metadata, be transferred between data stores without requiring intervention from a computer user or administrator.

### CROSS REFERENCE TO RELATED APPLICATION

This application claims priority to Great Britain Patent Application No. 0822431.3, filed on Dec. 9, 2008, and entitled “A Generalised Self-Referential File System and Method and System for Absorbing Data into a Data Store.” Great Britain Patent Application No. 0822431.3 is hereby incorporated herein by reference in its entirety.

### FIELD

The disclosed technology relates to methods, systems, and computer programme products for reading, writing, and storing data of multiple types in a single logical data structure, which shall be referred to as a generalised self-referential file system. Additionally, it relates to operating systems for manipulating such files, and to methods and systems for absorbing or merging such files into a destination data store.

### BACKGROUND

The storage protocols currently in use in the computer industry fall broadly into two categories: those which are proprietary in nature and not intended to be shared between applications, (though specialist conversion programs may exist); and those that are intentionally public and open, and designed to store data in a reasonably generalised format. While the former are clearly restricted in scope, and difficult to interpret without skilled knowledge, even the latter public forms suffer from difficulties of ambiguity. That is to say that their content may not be automatically and unambiguously absorbed into a further destination data store, without human intervention to interpret the nature of the data contained and organise it at the destination store.

While file formats exist in their thousands, and are broadly invented to suit the nature of any underlying application, each of these is designed for a particular purpose, and rarely are the nature and content advertised for dissemination and absorption by third parties. In the same way as above, files are also unable to be absorbed immediately and automatically into a destination store without the skilled intervention of a developer, familiar with both the original data file and the destination repository.

Where such files protocols are designed with a more general intent, such as XML, they can indeed contain data that is useful, and can be absorbed programmatically into a target repository. However, this programmatic absorption can be carried out only after a skilled developer has analysed the data schema involved, and written the absorption program accordingly. For example, once a data schema is known and published, there exist mechanisms in XML to declare the schema to be of a particular type, whose details are held in a DTD (document type definition) or schema. After the schema is examined, an absorption routine can be developed that can verify that subsequent documents satisfy this schema, and can then absorb data as required. It is not possible to absorb such an XML document, without prior examination at least in the first instance of a particular schema by a human operator.

The applicant's earlier published patent GB 2,368,929, describes a facility for flexible storage of general data in a single file format, and provides a generalised relational expression for expressing relations between data items. However, that facility focuses on a particular format that, while having a minimal overhead, uses a typical and proprietary data format that would in due course suffer the same vulnerability to change or error as any other proprietary format.

The applicant's earlier application GB Application No. 0802573.6 (GB 2,457,448) filed on Feb. 12, 2008, which is hereby incorporated herein by reference, provides a Universal Data file Format (UDF), that makes it possible for an application to encapsulate data in a manner that allows for its spontaneous contribution to such a data store without prior human design or modification of the data store.

This is the first of two primary aims of the preferred embodiment, the second being that data contained in such a store be capable of being exported automatically to a further compatible store without human design or interpretation, and while maintaining referential structure within the data.

### SUMMARY

In one disclosed embodiment, an unrestricted binary unambiguous file or memory mapped object that may be used to store data of any type, and a mechanism for transferring such data from one data store to another, while preserving the readability of the file is provided. As used here, the term ‘binary unambiguous’ is intended to refer to a quality whereby the binary data stored within the datastore (file or memory map) is always and uniquely identified by a binary type identifier readily discerned from the self same map. Similarly, the term ‘unrestricted’ refers to the capacity of the protocol to accept data of any type, nature, format, structure or context, in a manner that retains the binary unambiguous nature of embodiments of the disclosed technology for each data item, provided only that the user has provided a binary type identifier and a set of bytes encoding the data for storage.

A storage object so created may then be easily read by dedicated software, as it is of simple definition and is durable in nature, since its generality removes the need for repeated updates and versions of the underlying protocol. A description of example reading and writing software is provided.

The nature of embodiments of the disclosed technology helps eliminate the need for external schema documents, reserved words, symbols, and other arcane provisions, invented and required for alternate models of data storage. It is common in the art that data protocols are restricted in many ways, principally by schema (restricting context, relationships, and types), by standard types (with typically limited support for non-standard types) or symbology (commas in a CSV file, <and> in a markup file (XML, html)). Any such restriction typically limits the scope of data that may be contributed to a store, and/or results in requirements to declare versions of the file protocol in such a way that the particular set of special symbols and keywords can be publicised and accommodated by developers skilled in the art.

In practice, this means that stores require skilled and complex interpretation, which precludes an automated generalised routine from manipulating an arbitrary file or data store in any but a trivial and inadequate manner.

Embodiments of the disclosed technology eliminate these restrictions, and so provide a novel means of unambiguous and spontaneous contribution of data in an unrestricted and arbitrary manner, sufficient to allow true automated processing of novel data in a way that allows spontaneous contribution of arbitrary data, and seamless merging in part or entirely of compatible data stores or extracts from same, based on a simple algorithm, in a manner impossible to replicate with the common popular standards of SQL, RDBMS, XML, CSV and other storage media.

Embodiments of the disclosed technology therefore address the mechanisms or considerations by which the data is rendered capable of being transferred, and is subsequently merged. It should be noted that transfer does not imply simply the accurate transmission of bytes from A to B, such as may be expected for example of a networking protocol or file copy and paste. The consideration here is that the protocol supports referential data as an intrinsic feature, in that a first store may and typically will contain records which comprise entirely or in part references by record ID to other data records, which are intentionally public, such as triples, which if copied and pasted naively as values would give rise to inappropriate modifications in the intended data.

Simply put, allowing some generic reference identifiers for the moment, if a triple, for example, in the source document referred to items 12, 27, 61, then by pasting this data to the end of a second file, it would only be by the utmost coincidence that the three items referred to in the source file as 12, 27, 61 might be identical to the items identified in the destination file as 12, 27, 61.

Thus a claim in the first store to the effect that A.B.C for example might be transcribed as X.Q.T, and indeed it is unlikely that the result would be even meaningful. Clearly however, automated transfer of such data requires an understanding that the source data type comprised at least in part references, and an algorithm for storing that data by conversion to new and equivalent references in the second store.

Thus the mechanism of transfer here refers to a means not only to copy and paste value data, but to reconfigure referential data prior to storage in the second store, so as to retain the integrity of the referential data.

This is a problem familiar to operating systems and serialization protocols, both of which tend to assume and require tightly controlled environments in a relatively narrow context. A block of bytes from a computer's active working memory would be essentially meaningless to any application other than the operating system's kernel.

One disclosed embodiment therefore seeks to invert the normal coding relationship and provide a powerful, referential data tool outside a normally proprietary and closed operating environment.

In this embodiment therefore we demonstrate the means to express information of arbitrary nature and complexity, to store it in one store in a manner that it remains externally readable and accessible via a clear and well defined algorithm, and then by means of a minimal additional descriptor we further allow such data to be properly interpreted into its constituent value and referential components, for accurate reconfiguration as modified but equivalent data in a second store.

The file format provides therefore the basis for a data store that is unrestricted in binary scope, and essentially unrestricted in size also, subject to appropriate clustering routines to manage a plurality of discrete and necessarily fixed capacity storage devices and similarly constrained individual stores, whose capacity is fixed by design for reasons that will become clear.

### BRIEF DESCRIPTION OF THE DRAWINGS

Embodiments of the disclosed technology will now be described in more detail, by way of example, and with reference to the drawings in which:

FIG. 1 is an illustration showing the logical structure of records stored in a data structure such as a memory map or in a file;

FIG. 2 is an illustration showing in more detail an example file stored according to the preferred data storage protocol;

FIG. 3 illustrates a memory map of a device, on which data according to the example protocol is written; and

FIGS. 4 and 5 illustrate a system utilising the example data protocol.

FIG. 6 is an illustration of particular records from the file shown in FIG. 3, as they would be logically stored in a Relational Database.

FIGS. 7 and 8 illustrate the basic processes for reading and writing single records respectively;

FIG. 9 illustrates a basic process for initialising a file;

FIG. 10 is an illustration of an example process for preparing a ‘write’ buffer prior to writing to a file;

FIG. 11 is an illustration of an example process for writing records;

FIG. 12 is an illustration of an alternative example process for writing records;

FIG. 13 is an illustration of an example process for declaring a type;

FIG. 14 is an illustration of an example process for declaring data;

FIG. 15 is an illustration of an example process for extracting record bytes from a file;

FIG. 16 is an illustration of an example process for reading data;

FIG. 17 is a schematic illustration of a protocol for transferring data between near and far stores;

FIG. 18 is a schematic illustration of the content of the near store before transfer;

FIG. 19 is a schematic illustration of the content of the far store before transfer;

FIG. 20 is a schematic illustration of the content of the far store after transfer;

FIG. 21 is a schematic illustration of the transfer;

FIGS. 22 and 23 are flowcharts illustrating the steps of the transfer process.

### DETAILED DESCRIPTION

A preferred embodiment of the disclosed technology comprises a binary mapped data storage protocol, for the explicit storage of data of arbitrary binary type and arbitrary content, which may be implemented in memory such as a disk hard drive file.

The protocol creates a discrete storage entity, with a well defined start point, known as a seekable stream in the art. Implementation on a non-seekable stream such as a network stream, would be possible, provided that the stream could nevertheless be deconstructed and managed into individual component messages, segregated to support clear start and end points in that case.

In particular, the preferred embodiment provides a desirable quality of a truly durable and open data storage, in that its content and structure is determinable by a simple and well defined algorithm, and it is entirely independent of keywords, magic numbers, prior definitions and data design (schemas), and limitations in definition and scale, while at the same time retaining its capacity for unambiguous data storage of both value, referential, and hybrid (mixed value/refs) data.

By providing a mechanism for an unrestricted scope of data storage, novel data may be stored based on evolving needs without modifying the underlying storage protocol, so that an earlier embodiment will still be able to read a later store, thus rendering the protocol not only backward compatible, but forward compatible also.

Current protocols examine the means by which to share data only after some aspect of human intervention is involved, so that a database for example has a schema designed by a human, and then it is considered how to share that information with another application.

By considering the question only after human design and preferences have been allowed, transfer of meaningful structured data becomes possible only after consideration of the ramifications of the choices made by that human, typically a skilled developer, in designing a database schema for example.

In practice, this means that data is shared only after a skilled engineer, occasionally but by no means always the same developer, has examined both the source and the intended target, and devised a manner to express the transfer between the two, and thence codes a transfer mechanism accordingly.

Thus, transfer from a schema-dependent source such as rdbms, using a schema-dependent protocol such as xml, is highly engineer dependent and must be managed on a case by case basis.

By contrast, by addressing the sharing and transfer of data at a level below the threshold requiring human intervention, data becomes intrinsically shareable without human intervention, and only after we have resolved the means to do this do we then allow the user to express content as they see fit, which, if they have provided the indicators requested, will then be automatically and seamlessly shareable without further human intervention.

Thus a database really can be merged with a spreadsheet, at the touch of a button, provided that both are encoded in the protocol described here.

In the following discussion therefore, the reader is requested to bear in mind one possible purpose of the protocol, namely a datastore that can be accurately dissected into its constituent data items in a manner whereby each data item is characterised by a unique binary type identifier, without resorting to keywords or special characters, and in such a manner therefore that an automated algorithm will suffice to accurately write a file compliant with the format, and to read data from such a file or storage device, so eliminating many of the circumstances in which a skilled developer would be required to intervene, if say one of the current popular and alternative protocols were used in its place.

It will be noted that a file format without any particular structure or characteristics would be essentially random. Our goal then is to provide a minimal structure that does not require revising to maintain its core goals of spontaneous contribution and automated transfer, while accommodating an expansion of facilities.

As noted in the introduction, one of the current most popular data protocols is XML, a protocol complementary to rdbms, and which is similarly strongly namespace and schema dependent. This means that despite its supposed generality, a developer creates in effect an entirely new file protocol every time a novel schema is invented and expressed.

The need to separate the indicators for structured and referential data, away from human design and context, has not been recognised in the art, nor which indicators, if provided and separated, would allow automated merge and transfer independent of the data content and context.

This is perhaps not surprising, as the need for a schema seems to be strongly ingrained, and is indeed fundamental to, for example, rdbms systems.

The move to the semantic web model shows some recognition of the flexibility available by going beyond schemas, but since it is implemented in xml, it still falls into the limitations noted above.

By addressing the need for automated transfer up front, prior to human design and intervention, we are able to reduce the complexity of interpreting data for transfer, to a simple check or read of a designator for each binary type, which is then sufficient to allow distinction of referential and structured data, and so provided for its accurate transmission and storage, reconfigured as required, in the destination store.

The storage protocol has been strictly designed at the outset to achieve something which no other protocol has achieved, namely a capacity (when suitably utilised) for a truly human-independent, binary format that can be read, examined by a standard computer algorithm, and automatically manipulated for the purpose of absorbing its data into a destination data store without any prior examination by a human being, and without a necessary creation of a data definition document or schema, which in itself would require human intervention.

Given such a truly automated process, then it would be conceptually possible, limited only by physical constraints such as storage and processing capacity, to absorb all compliant data documents contributed in this format into a single coherent data store without a limiting schema.

By design and definition, if we provide a protocol that allows any two arbitrary stores to merge to comprise a single, coherent store, then by doing so iteratively, we can reduce the set of all possible stores to a single store.

Also by design, by providing spontaneous and arbitrary storage, the protocol provides a substrate that could equally well be the preferred medium for any application requiring data storage or persistence, not simply an rdbms or data application, such as for example a spreadsheet, accounting package, even a text document such as this.

It therefore follows that many, if not all of the mainstream applications that are familiar to us, could have been written with this protocol as the persistence medium, had it been deemed appropriate.

It therefore also follows, that since any two arbitrary and compliant stores may be merged into a single larger, coherent store, that the set of the majority, if not all, data files and other applications files on the planet could be merged to a single coherent store, capacity allowing.

Recognising that individual devices are limited with respect to processing power and storage capacity, nevertheless a plurality of such devices and stores can co-operate via general and automated routines to share information in a manner as to create an effective single store across a plurality of devices, so that our claim and vision remain valid and viable.

In short, and going far beyond any existing protocol, none of which were designed with such a goal in mind, it would be possible to build a datastore or virtual datastore (much as the internet is a virtual network, in the sense that there is not one network, but many) with unlimited capacity, global scope, and containing all information extant in the world that the world had chosen to contribute to the store.

We are thus making possible a single, coherent store for an individual, organisation, nation, or for the planet: in short, a global brain.

The features and characteristics of exemplary embodiments of the disclosed technology will now be described. Also, to aid understanding, we provide a glossary of terms used within the description:

Protocol: a set of specifications for how data may be written to, and read from a storage device—any reading or writing application or process will necessarily embody the protocol in software code or in hardware;

Binary Type: the type of data that is represented by the binary encoding within the computer. We may refer to such types by their intuitive names, such as string, integer, float, html, image, audio, multimedia, etc. However, such references are only for readability, and are not explicitly meant as binary type identifiers required by the protocol.

Standard Type: a proprietary definition of a binary data type provided within a software application, operating system, or programming language. Standard data types are usually denoted using reserved keywords or special characters. As noted above, in the preferred embodiment, no proprietary standard types are stipulated. The preferred protocol does of course rely on binary types to be defined by users of the protocol, and proposes a root binary type which can be used in the manner of a standard type by way of common usage rather than requirement. The provision of binary type definitions therefore remains flexible and adaptive. See sections 9 and 13 later.

Gauge: specifies the length of the data records in the protocol in bytes, and how to parse that record into a coherent structure. Specifically, it specifies how many of those bytes are used to refer to what will be described as the type identifier (Type ID) and how many comprise the space allocated to the following data segment.

Thus, a protocol having a gauge of 4×20 indicates a record of 20 bytes in length using 4 bytes to refer to the binary type identifier of data, and the remaining 16 bytes being given over to user data.

Self-Referential Files: a characteristic of the example system, in particular denoting a file that contains a plurality of records to store both data and binary type identifiers for the data. The file is self referential in that in order to determine the binary type identifier for a particular record of data, the store refers back to records declaring binary identifiers, and the records declaring binary type identifiers refer to a root record, which in turn refers to itself.

Record: a subdivision in a region of memory that is uniquely addressable and is used for storing user data. Records receive a unique record identifier (Record ID or Reference, abbreviated as ID or Ref). In this system, each record is deemed to contain user data of only a single binary type, and is provided with an explicit binary type identifier so that a computer algorithm may accurately process the data based on recognition or otherwise of that type.

Type ID: the first element in the record, the Type ID, designates the binary type of the client data held in the remaining part of the record. Choosing the appropriate Type ID is done according to the principles of a self-referential file system, as noted below.

Thus the Type ID noted earlier is also a Record ID, being a reference to a record which itself is deemed to carry a designator of the intended binary type, which binary type identifier is deemed to be chosen consistent with the root designator, typically a Guid.

This indicates that the file so constructed is capable of being read and processed in support of automated data transfer without the need for reference to external schema specifications or media.

Fixed Record Length: the amount of memory in bytes (or other suitable measure) assigned to each individual record is predetermined by the protocol, and is independent of the length of the user data that is to be stored. Thus, more than one record might be required to store a particular instance of data. In the example system, each record has the same length.

Document, File or Map: In the context of this discussion, the name given to the memory space used to store all of the records, Document or File is typically used in the context of hard disk files. Map is typically used where the embodiment is stored within random access memory.

The characteristics of the preferred data storage means have been explained in detail the applicant's earlier application number GB 0802573.6, which is incorporated herein by reference. For clarity, a brief summary of those characteristics is repeated here. However, for a discussion of the motivation behind the selection of those characteristics, the reader should refer to that document.

### Characteristics of UDF

### 1. The Map Originates at a Fixed-Starting Point.

The protocol is appropriate for use where a fixed starting point to the map can be externally determined, such as with a file or memory mapped object. We refer to that starting point as byte offset zero, as commonly done in the art. The alternative is to have a format with special characters to ‘interrupt’ the flow of 1's and 0's, and so indicate key boundaries. Once special characters are admitted, then special rules need to be invented to deal with situations where those characters are not intended to be special, which commonly requires the proliferation of yet more special characters. This is undesirable.

### 2. The Map Comprises an Integral Count of Records of a Size and Nature Specific to the Embodiment.

The nature and purpose of the preferred system is the arbitrary storage of data of unspecified nature but explicitly declared. The demarcation between data entries is preferably not provided by special characters, for the reasons outlined above. The boundaries are therefore assigned without demarcation, and are therefore implicit in the map or document. Demarcation is inferred in the protocol by requiring records to be of a single fixed record length. This facilitates the calculation of binary offsets and provides a simple means of providing record identifiers and additionally referencing such records in other records within the map as described below.

3. The Records within a Document are Consistent with a Single Gauge within the Protocol

That is to say that for a single embodiment of a gauge structured according to the protocol, every record in a given file of that gauge shares a single consistent length, and split between the Type ID and client content; and two such files sharing a common gauge share the same record structure. Thus it is sufficient to know (or be informed) that a file is of a structure conforming to a particular or preferred protocol gauge to read it successfully (in the manner described below).

### 4. Records are Referred to by Integral Id, Monotonic Increasing, and One-Based.

With a fixed starting point, and fixed length records, it is simple to provide each record with an implicit record index or identifier, as a 1-based, monotonic increasing integer.

The binary offset at which the nth record is to be found is readily calculated then as (n−1)×(record length), with the first record (id=1) starting at binary offset zero.

We elect to make the first record ID 1, for a 1-based index, rather than zero, as many operating systems initialise integers to zero by default, which would provide an apparently valid but nevertheless inappropriate reference from an uninitialised integer.

5. Record Identifiers are Signed Positive (Greater than Zero).

This may seem trivial or obvious, but in conjunction with the gauge, sets the upper limit for a valid record id. For a gauge using 4-byte references for record identifiers, there is a choice between allowing an upper limit based on the common ‘int’ (signed 4 byte integer) binary type, and using the upper limit of the unsigned integer type. While the latter would provide a greater upper limit (approximately 4 billion compared with 2 billion), it may introduce ambiguity where the coder compiled reader/writer applications using the more restricted signed int32 type, so that record identifiers beyond 2 billion (int.MaxValue) would require special handling. For this reason, we prefer to limit the protocol to the safer, lower limit of the signed integer representation of a particular gauge.

6. Record Identifiers as a Maximum are 1 Less than the Maximum Positive Number

This is rarely likely to be an issue, but it avoids an inadvertent infinite loop in at least one coding language (C#), in an otherwise reasonable looking loop:

for(int i=1; i<=int.MaxValue; i++);

This will never terminate, as the C# embodiment increments i beyond int.MaxValue, which as a signed integer, rotates back to int.MinValue, and so continues execution.

We therefore advise restricting the maximum record ID to one less than the maximum positive representation in the preferred embodiment.

### 7. Records are of Arbitrary Binary Type.

Since we intend to provide a general storage medium for any binary data, of any type, whether currently known or as may be invented, we need therefore to allow records to store data of any binary type. The mechanism for this is illustrated in the sections below.

### 8. There are No ‘Standard’ Types Intrinsic to the Embodiment.

Most protocols opt for short term convenience of the (human) user over that of a generalised interpreting algorithm. Thus they tend to be advertised with a limited set of initial types such as string, integer, float, datetime, which are described and declared typically using text keywords, which are then expanded over time as users find more types convenient. See discussion of binary types and standard types above.

The standard types of course, like special characters, then require special characters, or keywords of their own. These must be advertised, published in books, and learned by users, who when developing interpreters must look for these special keywords.

Further, any interpreting algorithm developed for an early release of a protocol must subsequently be revised or rejected, if a later version of the protocol is released to accommodate a widened variety of types, (or modified structure). Since it is our aim to release a single protocol, it is nevertheless apparent that simple rules make for durable protocols.

Standard types identified by keywords are preferably avoided in favour of an unambiguous declaration of binary type. The means by which standard types are eliminated in the preferred embodiment is by the self-referential binary type declaration, as discussed below.

### 9. Binary Type is Identified by Unambiguous Binary Identifier.

An accurate interpretation of the otherwise meaningless binary 1's and 0's, depends on identifying a binary type. In a self-referential system as described, the root binary type designator is itself of a particular binary type.

The correct interpretation of bytes therefore requires three elements:

1) a (human) convention as to a hypothetical binary type, e.g. ‘big-endian 4-byte signed integer’;

2) an identifier for such within the storage protocol or coding language (e.g.: in text based coding languages, it would be a string keyword: ‘int’, ‘Int32’, ‘integer’ or ‘long’ for example, all of which are variously used to designate the same thing in the art, according to context); and

3) the assignment of the identifier to the specific bytes in question.

We have considered the impact of these necessary steps, and their associated embodiment in current protocols, and have adopted an implementation in the current protocol that provides stability and longevity in the sense of essentially no versioning, and automated interpretation of data.

As regards the first step, the human conceptualisation of a type, this is external to the protocol, but once such a type is conceived, it will then be designated by an identifier per the second step.

As regards the second step, an appropriate choice of binary type identifier will depend on the choice of a designator binary type for root, and that particular choice of will generate a ‘family’ of documents consistent with that root binary type and family.

Thus it would be possible to specify ‘string’ as the root type designator, and then provide keywords ‘int’, ‘datetime’ etc. as subordinate binary types.

A human-language dependent model is however preferably avoided, and so Guids are used as the root designator, with a particular guid being the suggested and preferred root guid for the ‘UUID’ (Guid) type.

Subordinate types, such as int or datetime, are then first provided with a Guid designator, or binary type identifier, at the discretion of the client embodiment.

As regards the third step, we have further insisted that the binary type assignment to data be performed locally, within the file, so that no external resource is required to accurately determine the identity of the binary type by which the data is stored.

Thus, each distinct data item or record in the system may be rapidly assigned a binary type identifier, based upon which further more advanced processing may follow.

### 10. A Self Referential System Mandates at Least One Root Identifier

For explicit binary type identifiers to be able to be present in the file when they are not otherwise hard-coded into the protocol, suggests that they themselves must in some fashion be considered ‘data’, and as such have a binary type identifier of their own.

Thus binary type identifiers, being themselves data with their own binary type identifiers, must necessarily include a circular definition. In general, circular definitions are ambiguous or undefined. However a special case of a circular definition is a self-referential definition, whereby a type definition refers to itself for its type definition.

It is still ‘undefined’ internally, since interpretation of its type depends on itself, but it does mean that if this is recognised, as a signature, and a suitably unique identifier is selected and published and used consistently, then any set of documents using this ‘root’ identifier then constitute a ‘family’ or culture within the protocol based on this root identifier.

The provision of this single core-type then provides a minimal violation of the ‘no standard types’ design rule which then allows a particular family or culture of files within the protocol to be unambiguous with respect to binary type declaration.

The choice of the binary type identifier for such ‘root’ elements, and the choice of binary type to be represented by that identifier, is a further element in embodiments of the disclosed technology as discussed below. This choice of binary type and binary type identifier, along with gauge, determine the particular embodiment of a generalised self-referential format.

This format is sufficient for accurate reading of contributed binary data, for writing of data, typically via a dedicated application, though not sufficient for fluid (automated) transfer, since no information as to the nature (reference, value or mixed) of the data is provided.

### 11. Preferred and Alternative Root Binary-Type Identifiers.

Globally Unique Identifiers (GUIDs) also known as Univerally Unique Identifiers (UUIDs) are well known in the art and provide means for identification that can, in practice, be considered unique. Given their familiarity, support within the art, and suitability as unique identifiers, GUIDs (UUIDs) therefore form the basis of binary type declaration in the preferred embodiment.

An example embodiment of the self-referential data system is therefore one whereby the root binary type is decided to be of binary type GUID (aka UUID), and the gauge is 4×20, being 20 byte records, with 4-byte (signed integer) reference, as described earlier, with an appropriate and requisite identifier for the GUID/UUID binary type such as {B79F76DD-C835-4568-9FA9-B13A6C596B93} for example. The means by which these declarations are made in practice will be further set out later in the document.

In alternative embodiments, however, other types of identifier could be used to suit requirements. It is possible for example to remain consistent with the self-referential underlying file protocol of the disclosed technology, while maintaining multiple root declarations. These may indicate entirely different binary-type identification protocols, such as a root binary type and subsequent binary types equally declared by a root string and subsequent strings instead of UUIDS, in addition or instead of a root declaration indicating a UUID-based declaration referential hierarchy.

However, in the same way that a markup file might contain both an XML document or segment and an HTML document, but that in practice it is common and preferred to keep these separate and to have single-use documents, it is a preferred feature of the embodiment that binary stores using the protocol restrict themselves to a single common root by which subsequent binary types may be identified.

Nevertheless the embodiment makes no restriction on what specific root identifiers are used. The generality and simplicity of the protocol is such that even if a further root identifier became popular, perhaps by means of pursuit of dominance of the standard by a third party, then by simple recognition of its existence, all such files using that root would become once more transparent and automatically open to process. While a party can isolate themselves if they wish by adhering to an arcane and unusual choice of identifiers which remain confidential, this ease of mapping one root identifier to another has the desirable effect that no single party or conglomerate can dominate the standard, any more than any single entity can dominate a particular spoken language.

### 12. Standard Types are ‘Common by Usage’ not by Declaration.

To revisit briefly the earlier comment on standard types, a standard type may not exist by ‘keyword’ declaration, nor is it desirable to insist upon a formal recognition of a standard type, at the expense of being inflexible as regards future requirements.

As we have seen however, at least one ‘root’ identifier is required to start the unambiguous binary type declaration process. Beyond that, ‘standard’ types exist only as preferences within the ‘root’ family.

That does not preclude however ‘advertising’ preferred identifiers for common types, and it is anticipated that as with IBM and the PC, and Microsoft and most everything else, when and if Microsoft and/or the Linux community choose ‘preferred’ identifiers, they will likely become common standards.

Thus, it is envisaged that users of the protocol can and will inform interested parties as to their preferred identities. However, such identities are options and choices only. They are not an integral part of the protocol, nor ever should be assumed to be so.

### 13. Each Record of Data has an Explicit Binary Type.

‘Blobs’, meaningless bytes (meaningless as in ‘of undeclared type’) are of no interest to us, nor we hope to the data community at large. A record without an explicit binary type is therefore in our view meaningless as data, and is ignored. We require therefore that every record intended for interpretation as data to have an explicit binary type. Data that is un-typed (has binary type identifier zero, outside the range of the file, or to a record whose type is other than the primary binary-type-identifier family, commonly uuid) is not treated as legitimate data for the purposes of normal engine functions, data exchange, or data absorption.

It is also emphasised that such binary type declaration (the integer TypeID) must be declared by self-referential declaration (a binary type identifier in the same file) and not by ‘common usage of a known integer’ (eg: 3=Int32, 4=string). See the discussion of standard types in section 12 for the reasons.

### 14. Private Usage of Untyped Data is Overlooked.

As long as no inference is made about such data for the purposes of data exchange, data description, or data storage, then private usage of un-typed data is overlooked. Meaningless (for public data purposes) however does not quite mean ‘useless’.

One very useful ‘private’ use of such ‘un-typed’ data can be, for example, to provide a signature or list a series of ‘flags’ at the beginning of a file, which while not formally data, can be an indicator to the engine, as to source, style or other information.

A further usage can be the provision of a ‘gauge’ indicator, so that the gauge of a file can be readily determined or verified.

What they are not is formal data, and any attempt to read them should fail, or return a warning or be otherwise explicitly detectable (such as by returning a TypeID associate with the contained data). (We distinguish between tolerant failure—recognising data as un-typed and behaving appropriately, perhaps refusing to return it—and intolerant failure, where the application aborts. We do not consider it appropriate that the application should abort).

Further, any such usage must still comply with the fundamental file structure being set out herein. There is no tolerance for corrupted structure files, ‘special’ headers, ‘personal’ key identifiers or magic numbers (in place of referential type identifiers) or the like, by design. The protocol is strict, and simple, so that users may have some assurance as to its structure, and so that algorithms can be written with a high degree of reliability.

Thus, un-typed content is tolerated, but is not considered ‘true’ or good data, whereas corrupted structure is never tolerated.

### 15. Each Record has an Intrinsically Declared Binary Type.

The ‘records of the data protocol are not intrinsically structured data in the sense of an RDBMS. Rather they are more akin to individual slots, holding arbitrary data, which may or may not have an internal structural representation. They inevitably will have such an internal structure in all but the most arcane applications, since only truly random bytes have no intent to be ‘interpreted’, and that interpretation will require understanding and structure, even for something as simple as an integer.

Since they are arbitrarily assigned slots of arbitrary type, we therefore require that each record or slot should have its own intrinsic binary type declaration.

### 16. Binary-Type Byte Allocation.

To consider and contrast an alternate (not-supported) binary type declaration model:

If ‘standard’ types were allowed, a possible means of binary type declaration might be then that a single byte would suffice, with up to 255 different types (with 0 for un-typed), as a binary type declaration. However, as indicated above, binary types should preferably be indicated by GUIDs, which are themselves 16 bytes long (as binary data—their string representations are longer, and variable, but we refer only and explicitly here to their binary representation).

However, it would be wasteful to store a full 16 bytes as a binary type declaration, in each and every record, given the preponderance of data generally to fall within a limited set of commonly used types. Thus, we have appreciated that it is advantageous to use or allow some form of referential identity to specify or declare data types.

### 17. Self-Referential Binary Type

The self-referential binary type is an element in embodiments of the disclosed storage protocol that helps ensure that files are both self-contained, binary unambiguous and stable for the purposes of reader/writer algorithms. They are also relatively compact, as it allows explicit binary type identification for individual records or slots by guids, yet while using typically far less than the 16-bytes that comprise a guid to do so.

In the example system, it is by design that the document structure comprises solely and consistently a contiguous series of records. There are no sub-divisions or partitions proprietary in nature or otherwise difficult to determine, such as an arbitrary segment of 80 bytes to be interpreted as records, followed by a further arbitrary segment of 9000 bytes to be considered as a byte[ ], based on a keyword buried in the initial 80 bytes, as typified for example in the RIFF document format.

To appreciate the structure of an entire store in this protocol it is sufficient to understand this simple but strict adherence to a gauge-based fixed-length record structure. This is by design.

A record declaring an original root binary type is in the preferred embodiment a record containing a GUID, the particular root GUID being selected externally to represent the conceptual UUID/Guid binary type.

The root record both contains bytes describing the core conceptual binary type ‘GUID’ and is therefore of binary type GUID, which means it points to itself, or as we define it, is self-referential.

Further binary types are defined in the preferred embodiment by arbitrary selection of GUID by the developer/designer which are then stored as an array of bytes, with the RecordID of the original Root declaration record (not necessarily 1 (one)) as their binary-type-identifier.

Thus, the storage protocol is self referential with respect to binary type in two senses: every record has a binary type declared by GUID which is declared in the same file; and the root of the GUID hierarchy, of type GUID, points to itself.

Storing a binary-type GUID within the data store, immediately releases us from externally defined or derived URLs, schemas, or other forms of validation.

That is not to say that a human understands what to do with an arbitrary GUID, as they are essentially 16 byte random numbers. (Skilled developers will appreciate that they can be more than that, but it is sufficient for this explanation to consider them as such). Rather it is to say that a computer recognises a GUID as a common programming type, which can be used as an identifier and indicator as to further programming requirements.

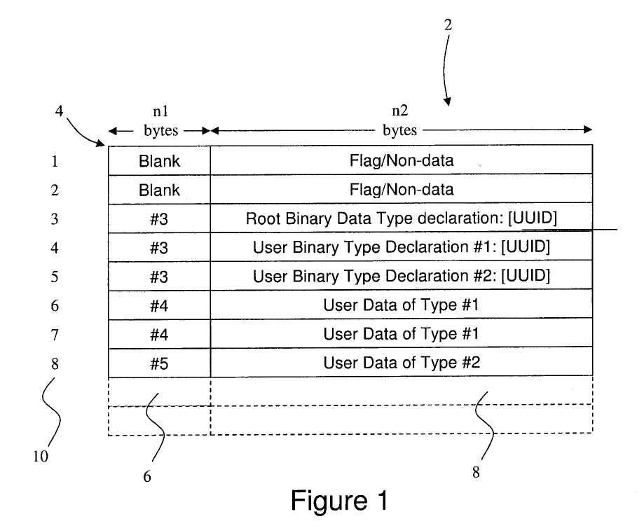

Reference shall now be made to FIG. 1, which logically illustrates the data structure outlined above. The figure shows a table 2 representing the usage of memory space in a computer system. It will be appreciated that the memory space could be provided as dedicated computer memory, or on a portable memory device such as a disc or solid state device. If provided as dedicated memory within a computer, the table is effectively a memory map. Otherwise, the table typically corresponds to a file.

The top left corner 4 of the table represents the first byte, byte zero in the memory map or file. The table then comprises two columns, and a plurality of rows. Each row is a data record.

A first column 6, called the Binary Type column, is used to store a reference to a record, in order to indicate the binary type of any subsequent data in that row. The second column 8 is used to store data, and is called the Data column.

Counting from byte zero in memory, a subsequent predetermined number of bytes n1 of the file or memory space are reserved for storing the first entry or instance in the binary type column. The next contiguous section of bytes, number n2, is then reserved for the first entry or instance in the data column (the widths of the columns in bytes will be explained in more detail below).

Together, the bytes reserved for the first instance in the binary type column, and the bytes reserved for the first instance in the data column constitute the first record. The record number is indicated schematically to the left of the table in a separate column 10. It will be appreciated that column 10 is shown purely for convenience, and preferably does not form part of the memory map or table itself.

In repeating fashion, the next record is comprised of the next n1 bytes of memory or file space for the binary type entry, following on without break from the last byte of the previous record, and the next n2 bytes for data.

Although the table shown in FIG. 1 is useful for purposes of illustration, it will be appreciated that there is nothing stored in memory itself that defines a table, or even a table like structure. The bytes in memory are reserved solely either to store a binary type indicator, or to store data.

Structure is inferred by interpretation of the memory map according to the gauge and principles outlined above, until an inconsistency is detected, at which point error handling may be performed. This is consistent with file interpretation protocols such as may apply to eg: xml, or other proprietary formats.

### 18. Binary Type Plus Data is Sufficient for Each Record

It may seem obvious that if we've finally declared a type, then the rest should be data; but in fact there are (at least) two reasonable candidates for inclusion into the record structure.

a) Record ID

b) Data Length

### 19. Record ID is not Required in the Record Structure

The use of a Record ID would offer ‘confirmation’ that we had the right record, if we included the record id in each record. Further, it would offer security in ‘open-ended’ streams, where bytes may be lost, that each new record was indeed as advertised, and of the appropriate identity.

In practice however, the fixed-starting point, fixed-record length protocol is entirely robust without such a mechanism, so that is eschewed. The security check in the open ended stream is better dealt with separately, by the selected protocol/embodiment responsible for passing/receiving the stream itself. As noted earlier, in a fixed starting point, fixed length file, the record ID can be inferred from the binary offset and vice versa, reliably and effectively. There is therefore no need in the preferred embodiment for a record id within each record/slot.

However, should a user require an embodiment with explicit record identifiers to be stored as part of the record, this would be possible, although it would create an entirely different and separate family of data files.

### 20. Data Length is not Required in the Record Structure

This does not preclude a given binary type including its own length data. BSTR's (Binary Strings) for example have a length prefix, where C-Strings (known in the art) do not, being null-terminated (have character zero where the string terminates). The protocol need only ensure that sufficient bytes are stored to cover all the bytes that were passed by the contributor.

Since the records are of fixed length, if there are fewer bytes passed in than are required to complete a record, the remaining bytes are required to be set to zero. Further, the binary type designer must be tolerant of the actual storage extending beyond the bytes input, to maintain a consistent fixed-width record structure, where such filling bytes are deemed to be assured to be byte-zero.

If the data contributor requires either a notation of the exact number of bytes passed in, (rather than the storage capacity allocated), they may declare a binary type with length integral to (i.e.: held internally within the databytes of) that type or may provide a separate record with a length notation and reference to the record containing the data. The protocol is therefore effective without the requirement for an explicit length specification for each data item or class of items.

### 21. Data is Stored at Least to the Last Significant Byte.

In the light of the above, especially where buffers are concerned, a 10 k (10,000 byte buffer) holding the string ‘Andrew’ will rapidly eat up storage capacity if the protocol attempts to store every trailing zero. However, the protocol does not attempt to ‘interpret’ the data as a null—terminated string (i.e. look for a first zero and terminate)—that is not its job, and may result in the making of inappropriate assumptions. Better to be strict and simple, and let a contributing/reading engines be ‘helpful’, as they see fit.

It is preferred however to avoid storing myriad zeros ‘unnecessarily’. This does not restrict the user, as shall be explained. The protocol therefore stores at least to the ‘last significant byte’ (last non-zero byte), and it may indeed store all the trailing zeros. However it is considered to be a matter of the discretionary embodiment whether it does so or not, nor need it maintain any record of the incoming buffer size. If the user needs that size specifically they can themselves define a binary type that includes that information and submit that as data.

### 22. Records May be ‘Reserved’ to Cover a Fixed Size.

Where a block of data is required for later filling with data, but the data is not yet ready, or the engine simply wants to see if there is enough room available, then it may ‘reserve’ a block of records by insisting on a fixed size, specified either in bytes or records (we recommend bytes, which is more intuitive, and also errs on the side of caution, if the user inadvertently specifies records). It can do by simply adding a block of records of sufficient capacity.

This takes us ahead to data which exceeds the record data length, while we need to finalise and clarify the individual record structure.

### 23. Gauge

The gauge defines the internal structure of records and files. Neither the reference size nor data length (remaining data bytes per record) need to have particular dimensions; except that once specified, they become a single, final and permanent feature of the example system or family, and all files with identical structure (and obeying the rules for self-referential binary type) are therefore by definition instances of the same identical gauge within the protocol.

In the example system outlined earlier, and commonly used as a preferred embodiment, files are of integral record count, records are 20 bytes in length, with 4 of those bytes being used to store an integer reference to another record in the file declaring the binary type.

This allows all common fixed-width data types up to the prominent GUID type (16-bytes) to fit within the data section (20−4=16 bytes) of a single record slot (singleton).

Once a gauge is specified, the capacity of the file can now be determined. Recalling that we allow only signed +ve (positive integers), within the meaning of the refsize (the number of bytes assigned to storing a binary type identifier and for providing references within a file), which in this example is a 4-byte integer, so that this embodiment would allow a maximum of approximately 2 billion records. (Strictly: max(Int32)−1)

For a 4×20 gauge, then, we therefore have a file size of approx 2 billion×20 bytes, or 40 gigabytes maximum file size. (The figure is precisely determinable since the maximum possible value of a 32-bit signed integer is precisely determinable. We use the approximations here solely for readability). The 16 bytes of the record not used for holding the 4 byte TypeID reference are used for storing user data.

Thus, for 16 bytes data per record, 2 billion×16 bytes of data can be stored, or approximately 32 gigabytes maximum data storage, of which some at least will be used (if the file is to be consistent with the protocol) to declare the binary types of the data in the file.

(Note that the binary types do not have to be all declared at the time of the file's first creation. They only need to be in the file at the same time as, or preferably before (with earlier id) the record whose type they describe).

The 4×20 gauge is particularly useful because it results in a practical file size capacity, and a common refsize (abbreviation for reference size, by which we store the binary type identifier) (int32), and because the 16 data bytes within the 4×20 gauge conveniently allows us to store a single GUID in exactly the data comprising a single record, (a.k.a. a singleton record, or singleton).

Other gauges could be used, providing data stores of arbitrary capacity for a given refsize, according to the length of record chosen for the gauge.

If we chose a larger gauge, maintaining the refsize, but enlarging the data to say 36 bytes, for a 40 byte total record, then the capacity of a single file would go up to 2 billion (4 byte refsize signed int max, −1)×36 bytes (data)=72 gigabyte capacity. However, with GUIDs being extremely common in the protocol, then any GUID record would use only 16 of 36 bytes, leaving 20 bytes per record as simple empty zeros.

If the ‘natural’ data to be stored was of length 36 bytes, or simply ‘large’, then the larger record-length may provide more efficient overall storage for that type. The final trade off will be against common usage (we prefer the 4×20 gauge), and efficient use of the finally required storage capacity.

A typical use of a larger gauge is of a 4×1024 gauge file which is used as a companion store for bulk data (images, media). Such a file has 2 billion (signed Int32 RecordID)×1024 bytes storage, or approx 2 terabytes capacity, and provides faster retrieval fewer records per bulk item at the expense of being relatively inefficient for ‘simple’ types such as guids. As a companion store however, that is an effective trade-off, where the primary store (in 4×20 gauge) manages the ‘fine’ grained data, leaving ‘bulk’ data to the companion.

We note that Int32, as with any multi-byte representation, may be big-endian, little-endian, or some other arcane representation. As the example embodiment makes clear, this raises no ambiguity, as each such variation as a representation will or should be represented as a different binary type identifier, preferably a GUID, which when used to describe a binary-type, we commonly refer to as a ‘TypeGUID’.

When referring here to Int32 integers therefore as RecordID, we intend the Int32 representation appropriate to the coding environment, and with an appropriate and unique GUID identifier which we denote as {gInt32} to match.

We also note that as a result of the binary clarity of the binary type identifiers, the same file could contain both types of integers without ambiguity. For references however, which are embedded ‘within’ records and so do not have associated binary type identifiers, they are deemed to be consistent with the Int32 representation of the TypeID identifiers in the file.

Thus the referential model of the file is determinable upon first reading, provided only that the gauge is accurately determined. An inaccurate gauge will almost certainly and promptly throw off similarly disturbing indications, even if the common 4×20 gauge were not in use, and no other indication of gauge were present.

For safety, a gauge indicator is preferred as the leading record, in an untyped (flag) record. The data bytes being the ascii representation of the refsize and record length, in the [refsize]×[record length] notation above.

### 24. Extension Records

With a fixed-length record, we are clearly limited in the amount of data we can store in a single record. The fixed-width design provides us with a simple, strict, well-defined structure, so we now extend it therefore encompass support for data of arbitrary length, subject to the remaining capacity of the device and/or protocol, by means of extension records.

To avoid magic numbers and special characters, extension records follow the same protocol as for any other binary type. A binary type is declared as {gExtension} (or {gExtn}), where the {g[something]} notation indicates a binary type identifier for something, in GUID form, but labelled conveniently for explanation and readability in text (eg: “{gDateTime}”) in this document.

Thus, {gUUID} [or {gRootUuid}] may be used to indicate the binary GUID used to declare items of type GUID, in other words the root of the binary type declaration tree. Subsequent types (e.g.: {gString}) will be of Binary Type {gUUID}, but will have their own GUID for declaration of such data, e.g. strings with associated binary type guid {gString}.

By identifying the conceptual type ‘extension record’ and assigning a {gExtn} binary type, which is declared as normal (with binary type identifier the record ID of the root {gUuid} binary type), we therefore enable the embodiment to handle records of arbitrary length.

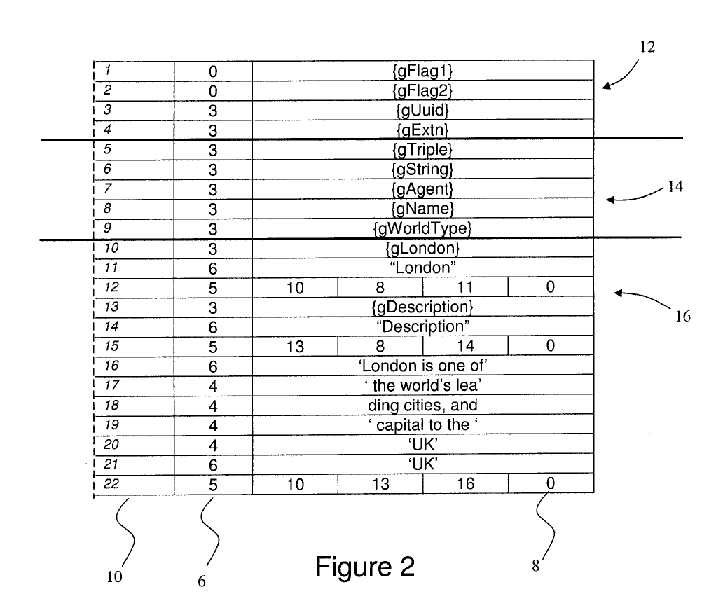

This concept is illustrated in FIG. 2 to which reference should now be made. FIG. 2 resembles FIG. 1 except that a binary type has been declared to indicate an extension record.

It will be appreciated that the root UUID {gUuid} and the extension type {gExtn} are the closest candidates to being ‘standard’ types which occur in the protocol, in the sense that they are commonly used, and by their usage in conjunction, arbitrary data of any length can be stored in an otherwise fixed-record-length protocol.

The inclusion of {gUuid} and {gExtn} as core-types provides a minimal set of ‘standard’ types which now support the spontaneous storage or expression of arbitrary binary (referential, structured, or simple bulk, value) data in a referential and binary unambiguous data environment.

Thus a particular gauge of the protocol, in conjunction with these two core identifiers, is sufficient to satisfy the first of the two goals for embodiments of the disclosed technology, being that of spontaneous binary storage of arbitrary type in a referential (structured) environment.

Since the {gUuid} and {gExtn} types are as arbitrary as any other in the protocol, it will be appreciated that any reading or writing process or engine may be considered tuned or sensitive to a particular root and/or extension type. It will therefore be advantageous for such fundamental types to be registered as a standard externally for common appreciation and usage.

As such and with the {gUuid} and {gExtn} identifiers recognised and in place, any reading and writing process preferably therefore has code that tells it how to respond if a record of the extension data type is found. This is straight-forward however, as the extension record binary type is used merely to indicate that the current record is an extension of the record immediately preceding it. Thus the concatenated set of data segments from the contiguous series of data records (initial record of non-{gExtn} type followed by a plurality of records of {gExtn} type) constitute a final single data item of arbitrary length, as originally submitted by a client application to the data store. Despite being a standard type, in the sense of common usage, it is pertinent to note that it is only recommended for ease of data storage, rather than required, and that in accordance with the other features of the protocol requires no special codes or characters. Thus a message comprising data consistently of length within the capacity of the data-segment of a single record may omit the {gExtn} declaration. It is nevertheless still desirable in practice to declare it, in order to confirm to the receiving reader that this is in fact the known and recognised {gExtn} type in use.

In the Figure, record 4 is used to store the extension binary type. As noted above, the data in the record will be a UUID representing that type for the purposes of the data and data control. Records 5 to 9 contain a user binary data type declaration; and records 10 onwards contain data specified as being of the variously defined binary data types.

### 25. Scalability—Enlargement by Clustering.

Since the protocol is of fixed record length, with fixed maximum record count as defined by gauge to ensure consistency with the self-referential goal of the protocol, it follows that a single store has a maximum size and storage capacity determined by the guidelines of the protocol and the gauge selected.

At 40 gigabytes approx for a 4×20 gauge file, for example, that may be considerably in excess of any reasonable XML file, and yet it may only represent a fraction of a terabyte RDBMS database. Ideally, we would not want the protocol to be restricted to such an absolute limit. Clearly one solution is simply to partition the data across multiple files.

Since each has a capacity (in 4×20 gauge) of approx. 32 gigabytes data per 40 gigabytes file, it is simply a matter of how many files to use to contain the data you wish to store.

The only item requiring particular attention in such a basic model of separated data files is that a means of distinguishing references from different files be established. Clearly a reference ‘27’ in file A is not except by extreme coincidence identical in type or nature to a record ‘27’ in file B.

In practical embodiments we commonly use a GUID as a ‘Source’ Identity in conjunction with each reference, thus ensuring that references from different sources are not inadvertently comingled or used out of context (of their particular file).

A complex, sophisticated clustering routine can of course be implemented, but the simple observation is that one file being full does not limit the final effective size of the data store. Clustering is a recognised technique in RDBMS, and in web farms.

While we do not intend to outline a full clustering algorithm here, we can at least indicate that at its simplest, the means to expand a virtual data store capacity is simply to add a new file, and to distinguish references (record ID's) in each file by providing each with an additional ‘source’ GUID identifier.

Identities are if (the protocol's recommendations have been followed) based on GUIDs, so simply put, the sum of the information across all files, is the sum of the information for that GUID in each file.

### 26. Scalability—Selecting a Larger Gauge, Databytes.

As noted above, the 4×20 gauge is useful because it results in a practical file size capacity, and a common refsize (int32), and because the 16 data bytes within the 4×20 gauge conveniently allows us to store a single GUID in exactly the data comprising a single record, (aka a singleton record, or singleton).

However another means of providing scalability for the protocol comes from promoting to a larger refsize (reference size, by which we identify the binary type). We have not fully explored why the protocol is useful, and how to use it, from a referential perspective (internal to the data, not simply with regard to binary type), but if we allow for the moment that 2 billion records simply might not be ‘enough’, and it is desired not to split across multiple files, then moving to for example an int64 as refsize, we would have Int64.MaxValue or approx 9 billion billion possible records.

With a gauge 8×16 therefore, with 8 byte (int64) refsize and maintaining a 16 byte datablock per record, the maximum file size would be approx 9 billion billion×24 bytes, or in excess of 200 billion gigabytes; with a data capacity per file approaching 150 billion gigabytes. This is more than enough for a single data file/document for the foreseeable future. If however need arises, by the same mechanism it is a simply matter to expand the gauge by moving up to the next appropriate integer refsize.

### 27. Summary of Characteristics:

The resulting protocol is extremely simple in its core structure, yet provides an effective referential data management environment. Describing why it must be that way has been, step by step, a longer process. To summarise, therefore exemplary embodiments of the system possesses one or more (e.g., all) of the following characteristics:

a) binary type identifiers (which in the preferred example are GUIDs) for data are declared locally in the file as records;

b) records containing user data comprise initially a reference to a record within the file defining the binary type identifier (preferably guids) per a);

c) the remaining bytes (typically following the binary type reference) are deemed to comprise the user ‘data’ for the record;

d) the binary type identifier data records should in preference be declared ahead of (lower record id, though it does not strictly matter) the data records containing the data they describe;

e) a file contains a root binary type record (in the example system a GUID), not necessarily the first record in the file, and subsequent record defining a binary type should point to the root record; as also should the binary type identifier of the root record itself, since the root binary type identifier in the preferred embodiment is an arbitrary instance of itself (by preference a Guid representing Guids);

f) the root record is self-referential, (as noted in e) above);

g) an ‘extension’ binary type allows the system to absorb data of any length within the remaining capacity of the device or the protocol itself, by design;

h) records are of identical fixed length throughout the file and the protocol, and begin at byte zero, so that they can be referenced without the need for special keywords/identifiers;

Although, the discussion of each of these characteristics has been chosen is lengthy, the final result is a simple gauge, a clearly defined file structure, and a self referential algorithm, with GUIDs as preferred identifiers, and an explicit instantiation of such an embodiment provided only that a core-uuid type and core-extension-type are defined. The protocol characteristics have been chosen as desirable contributions to a truly general file format, capable of arbitrary contribution by anonymous third parties, nevertheless with the assurance that data of any type and nature (if supplied with an appropriate binary type GUID) can be safely and reliably stored.

Furthermore the resultant binary data file can be reliably identified without further installed readers or proprietary software beyond that necessary to follow the few clearly defined and simple rules described herein. The end result is desirable not simply for what is present, and for the capabilities provided, but also for what is absent, and for what pitfalls have been avoided.

The example system therefore provides a data storage protocol that will be flexible, durable, and support automated absorption, a facility unique to our knowledge among all extant file formats and protocols, and absolutely and certainly impossible with the most popular protocols, XML and RDBMS.

By eschewing markup and by relying on fixed length records, the current embodiment allows a reading application to jump from a reference in one record to an immediately and well-defined offset in the file comprising the target of that reference, by means of a simple arithmetical calculation.

This enables the preferred embodiment to act as both messaging protocol (akin to typical use of XML, for ‘small’ documents/data stores), and as a fully expressed and indexed data store akin to an RDBMS at the other extreme, both with the same transparent and well-defined protocol.

The example system therefore has been carefully thought out to provide a data storage protocol that will be flexible, durable, and as indicated may support both low-key messaging akin to XML and high-mass, indexed data stores, akin to RDBMS.

Furthermore, it will support automated absorption, a facility unique to our knowledge among all extant file formats and protocols, and one that is certainly and absolutely impossible in the common usage of the most popular protocols, XML and RDBMS. This will be described in subsequent sections.

### An Operating System

As discussed above, references are useful for the declaration of binary types. Further, however, it will also be apparent that any system capable of operating with distinction between value-based data objects and reference-based data objects approaches the preserve of a traditional ‘operating system’ such that if such an operating system may be considered to be a set of memory across which data and referential integrity are maintained for a set of well-defined operations, primarily storage and retrieval, then this protocol constitutes in large part the means to provide the base referential storage for such an ‘operating system’, and thus may be considered to be the substrate by which by addition of a set of ‘operating’ procedures a true ‘operating system’ may be implemented, as understood in the art.

That the protocol may be implemented as a memory map clearly identifies it as a candidate therefore for at least an embedded and structured storage embodiment for a chip or otherwise dedicated processing device or medium; and by supplementing the referential store with appropriate operating procedures, a true ‘operating system’ may likewise be implemented on an arbitrary device, store, or medium.

Thus, far from being simply another file protocol, the cleanliness, strictness, and simplicity of the protocol lend its use to strict, dedicated and high-performance applications, and make it a nascent candidate for a data-focused operating system to sit alongside the two dominant and popular kernel (chip-focused) operating systems of Unix and DOS/Windows, and in particular possessing a naturally minimal footprint to enable embedding in restricted capacity devices such as RFID's.

Having described features of the protocol, its operation and implementation will now be discussed in more detail.

It will be appreciated from the above that data should not ever be simply ‘written en bloc’ to disk, disregarding the type protocol, and simply writing eg: 150 data bytes in sequence, without any intervening {gExtn} identifiers (in the 4×20 gauge). It is a design principle, absolute and strict, that a 3rd party reader should be able to iterate through the file from record ID 1 to the last record ID, and request the binary type identifier (as a ref) and thence the binary type identifier (preferably a UUID) defining the binary type. They may then read or act upon such information as appropriate.

If data is written ‘en bloc’, disregarding the protocol, then the first four bytes of the record following the first user record will NOT represent a self-referential type, but random data (according to that input).

If the reading algorithm is fortunate, the incorrect type data so obtained will point to a non-GUID, or inappropriate type value, so indicating probable corruption (certain, in this case); if not, and it points to a record that happens to contain a GUID, worse still a recognised type GUID, then an entirely incorrect inference will be drawn, without obvious error until subsequent actions and corruption have followed.

The use of the example storage protocol will now be explained in more detail with respect to a computer system framework.

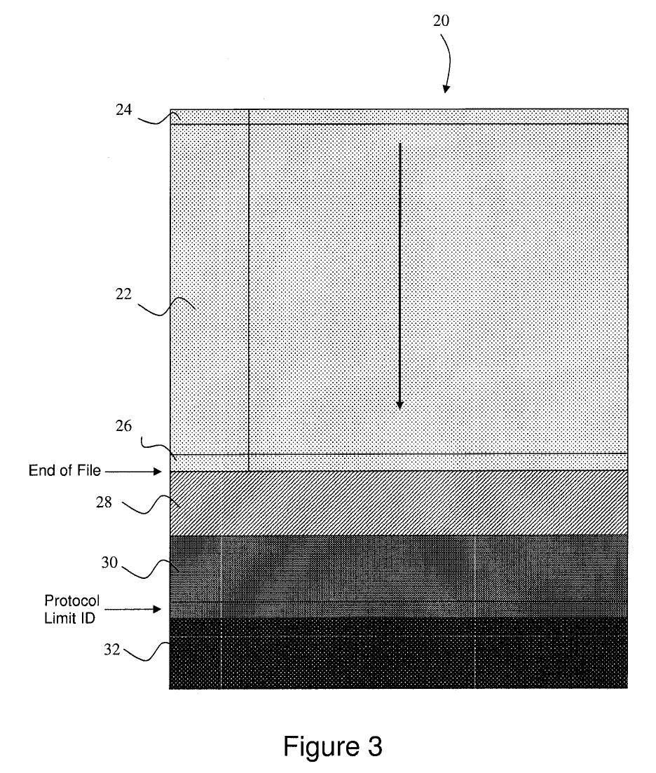

FIG. 3 illustrates a memory map of a storage device 20, on which data according to the example protocol is stored. The storage device has a memory in which a file 22 has been created. The file 22 contains first record 24 and a last record 26.

The unused (usable) space on the device is illustrated by region 28. This could be used merely by making the file in which the data is stored larger. The limit to storage within a single data store is then either decided according to which is smaller, the remaining protocol capacity, or remaining device capacity. If the remaining device capacity is less than the remaining protocol capacity, then a region, here region 30, will be theoretically valid in the protocol, but inaccessible, since no device capacity remains to implement it.

As discussed above the protocol capacity is limited by the gauge, and specifically the refsize, which defines the number of bytes allocated to identify the record reference to binary type. In this example, the usable device capacity is less than that of the protocol, resulting in region 30.

If on the other hand, the device is large enough to encompass the full remaining protocol, then it is the protocol that will limit the single store capacity, as references to records beyond the protocol's last record ID will return errors, if the protocol is correctly implemented. This is a safety measure to ensure that a file created consistent with the protocol will always be readable by another algorithm coded consistently with the protocol. Region 32 illustrates unusable device capacity outside of the protocol.

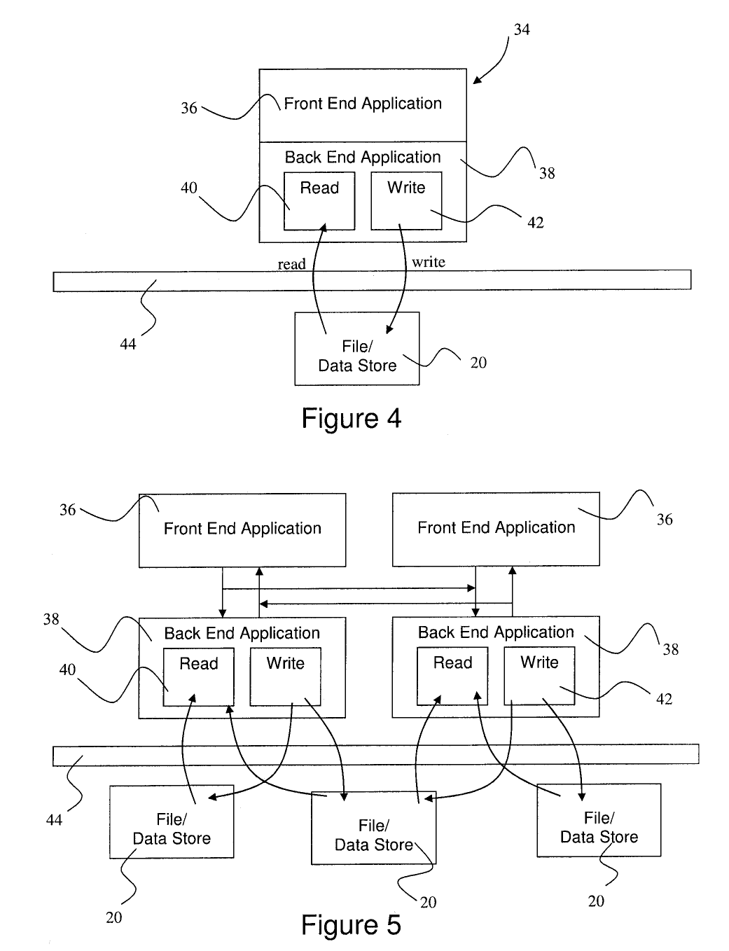

FIGS. 4 and 5 illustrate how the data protocol could be used in a wider system. FIG. 4 illustrates application 34 for reading and writing data according to the protocol described above to and from a device 20. Device 20 may be any suitable storage device or medium, such as internal memory, memory provided on a network, a hard disk, or portable memory device.

The application 34 is shown as having a front end 36 for providing a graphical user interface for a user to enter and view data. The application 34 also includes back end application 38 for handling the writing and reading of data to the data store 20. Back end application 38 has a “read data” control element or process 40 and a “write data” control element or process 42. It will be appreciated that although the front and back end applications and read and write processes are shown as separate components they could be provided as a single monolithic application or as separate modules.

Read and write processes encode the protocol discussed above, such that when data is written to or read from the store 20 the protocol is obeyed. During the reading and writing process, an encoding list or index 44 is preferably consulted to ensure that the binary data in the store 20 is interpreted correctly in terms of its type.

The encoding list or index 44 may be provided in memory on the same computer or server housing the application 34, or may be accessible across a network.

In the example discussed so far, it has been assumed that a single application accesses a singe data store, whether remote or local. However, the advantages provided by the data protocol will be more apparent when it is used on a network involving a number of different computers and data stores. This case is illustrated in FIG. 5.

FIG. 5 shows a plurality of front end applications 36, which may be provided on the same or different personal computers. The front end applications communicate with back end applications 38 located on one or more servers accessible via a network. The back end applications have read and write processes 40 and 42 as before.

A plurality of data stores 20 are also illustrated. These may be provided on separate servers, personal computers, or other storage resources available across a network.

As shown in FIG. 5, particular back end applications 38 may provide access to different data stores, allowing the user via a front end application to request one of several locations where the data is to be written or from where it may be read. As with FIG. 4, each of the read and write process utilises encoding list or index 44 is order to interpret the data types stored in the data files.

### Reading and Writing

Reference will now be made again to FIG. 2, to illustrate in more detail the operations of reading and writing a file according to the preferred protocol, described above.

The example file shown in FIG. 2, contains data that stores an identifier for ‘London’, and a description of London, as a string. The complexity may seem burdensome for such a simple item, but the consequences of remaining strictly within the protocol and embodying the data in this manner are that a simple, strict computer algorithm can accept and process this file without human intervention, while retaining accurate binary and structural integrity.

The example file comprises 22 records, diagrammatically divided into three sections 12, 14 and 16 for the purpose of understanding typical usage and roles. No such ‘sectional’ view is implicit or required by the protocol itself.

The first section 12 contains typical critical records, such as leading flags in records 1 and 2, that is signals that may be used to indicate a file's compliance with a particular reader/writer engine; a root UUID declaration {gUUID} in record 3 (the GUID declaring the ‘GUID’ binary type), which is self-referential; and an extension type {gExtn} in record 4. The extension type {gExtn} is declared as a GUID, by binary type identifier ‘3’, indicating that it is of type {gUUID}. The contents are deemed to be the identifier for an ‘extension’ record, as noted earlier.

Without a {gUUID} declaration, there is no root, and so no effective protocol. Without {gExtn}, records are restricted to singleton records, and data per record to a fixed, gauge dependent width, here 16 bytes. The file is deemed to be a typical 4×20 file, refsize 4 bytes, 20 bytes record length, whence the TypeID is 4 bytes, and the DataBytes is 16 bytes in length.

The second section 14 comprises typical common declarations for data types. A final application or file may have many more of these. Also, there is no requirement that they be all declared at file-inception. In certain desirable embodiments, novel types can be declared at any time. The diagram illustrates five user-defined data types: Triple (record 5), String (record 6), Agent (record 7), Name (record 8) and WorldType (record 9).

The final section of the file 16, for discursive purposes, is the client data, which is where the final items of interest and their relations are noted. The use of types to describe data will now be discussed in more detail.

Of the example types defined in the common section 14, ‘{gString}’, for a string type declaration (itself of type 3: {gUUID}), may perhaps be the only self-evident one. Data according to type ‘String is stored in records 16 to 20 for example. Note that records 16 to 20 contain the phrase “London is one of the world's leading cities, and capital to the UK”. This phrase is large enough to require storage in five records, all of which except the first are typed {gExtn} to show that they are contiguous extensions of the leading record 16 so that the final, single data item is the concatenated array of bytes from the data sections 16 to 20 respectively.

We will briefly describe the other common types, so that the reader may get a sense of how we regard and structure data:

{gTriple}: is a Triple, as defined in GB 2,368,929 (U.S. Pat. No. 7,430,563), which allows declarations of the form: [subject].[relation].[object]. It obviates the need for schema declarations in databases and XML, and so supports spontaneous data contribution, transfer, and absorption between data stores without human intervention, at the structured data level. In the current example, three triples are declared, in records 12, 15, and 22:

1) {gLondon}.{gName}.“London”

2) {gDescription}.{gName}.“Description”

3) {gLondon}.{gDescription}.“London is one of the world's leading cities, and capital to the UK”

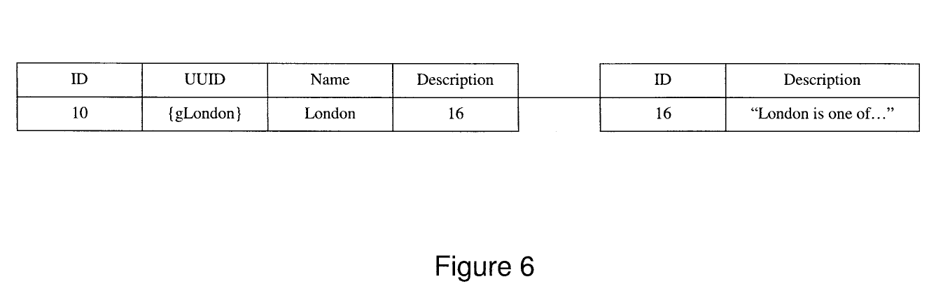

The approximate RDBMS equivalent of these triples is illustrated in the ‘pseudo-tables’ in FIG. 6. It is beyond the scope of this application to describe the equivalence and differences here, but the diagram may help the reader assemble the elements of the illustrated file more easily into a rational whole.

The other identifiers declared in the ‘common’ section (designated such for this discussion only) are:

{gString} - used for storing string types.
{gAgent} - a common type beyond the scope of this embodiment.
{gName} - used to declare an (English) name for a binary (GUID) identity
{gWorldType} - provides classification, typically via a triple, since the
protocol does not need nor provide tables, with their explicit and
restrictive classifications.

The example could declare {gLondon}.{gWorldType}.{gCity} for example, but in the interests of brevity we have restricted the example to simply declaring a description for London.

It will be noted that {gString}, {gTriple} (also {gAgent}) and obviously {gUUID} all declare well-defined binary types. (Strictly, string is subject to encoding, and we use UTF8 in a typical embodiment). {gExtn} is a particular ‘binary type’ allowing continuation of binary types.

By contrast, {gName}, {gWorldType}, {gLondon}, {gDescription} are all conceptual types. There is no intended interpretation of 1's and 0's for the concept of ‘classification’ ({gWorldType}). It is simply an identifier for a concept, whereby we can ‘classify’ things, or likewise ‘name’ them, or ‘describe’ them.

The instance data (in for example triples) will have an explicit binary type (typically a string for a ‘name’, and a ‘GUID’ for an identifier), but that binary type belongs to the instance, not (as is implemented in RDBMS) to the field or relation, or concept itself.

The use of such identifiers is common in the art, and recognised in RDBMS, so will not expand further here, except to note their declaration in the example, and their usage (here, in triples).

Note also that we have not included the (English) names for these declarations, for brevity, which we could otherwise have declared using triples and {gName}, as we have done for {gLondon} and {gDescription}.

By operating with GUID identifiers, we become language independent for data, as far as the computer is concerned, though users will still need locally interpreted language. We simply note here the mechanism for such declarations.

We restrict ourselves to triples here, for structured relations, but any binary bespoke type could be equally well created. To illustrate reading and writing such files, this example will suffice.

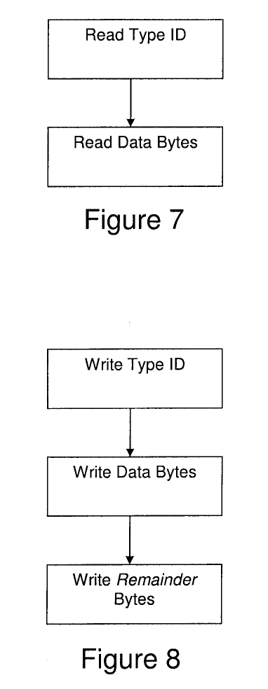

The absolute primitives upon which all other operations are based are ReadSingleton, and WriteSingleton, as illustrated in FIGS. 7 and 8

We have stripped out the ‘Seek’ element, preferring a model based on RecordID's, which will be covered in the Read Record and Write Record Operations described later. Here we simply note that the action of reading a singleton is to read refsize bytes, where refsize is that determined by the gauge of the file, typically 4 bytes as a signed integer.

Thereafter the reader reads the remaining databytes bytes, where databytes is the other element in the gauge. The first four bytes above constitute the Binary Type Identifier, and these latter 16 bytes the ‘client data’.

Since the file is self-referential, the TypeID (the first four bytes as a reference to a record within this file), will be valid if it points to a valid RecordID (integer>0, and <=the number of records within the file). In a typical and well-defined file in the preferred embodiment, the TypeID will further point to (be a record ID reference for) a record, which will itself be a GUID declaring the binary type of the client record.

To know what binary type our client data is, we read the GUID of the referenced record, whose own TypeID, being a GUID, should be that of the root {gUUID} declaration.

Thus, if it is not, we do not have an anticipated GUID, and as such we do not have as we expected a well-defined file. Thus, the protocol is strict, and it is readily determinable if it appears to have been adhered to, in that regard.

Thus in the example, “London”, the string, in record 11, is declared as type 6, which references record 6, {gString}, whose own type is type 3, or {gUUID}, as expected, indicating that record 6 is indeed a GUID and we can read its data and so derive the {gString} GUID, which tells us the type of record 11, as we desire.

In practice, this apparently long-winded approach occurs only once per binary type, as once the {gString} record has been accessed once, it can be stored in memory so that we simply map the ‘string’ type to ‘TypeID 6’, (in this file), or as required in other files, so that we achieve nearly the same performance as for hard-coded binary types, but while retaining flexibility and independence as to binary type.

Writing a singleton occurs similarly, by writing its appropriate TypeID (record ID for the record in which the binary type GUID is declared) and the associated data, bearing in mind that for a singleton, the data cannot exceed databytes bytes in length, in this example 16.

The one subtlety of a WriteSingleton request is that it must be ensured, if the write occurs at the end of the file, that all databytes bytes are written, else the file will no longer have integral length with respect to records, thus the write remainder bytes step in FIG. 8 ensures that zeros are written to the file to ensure a consistent record size.

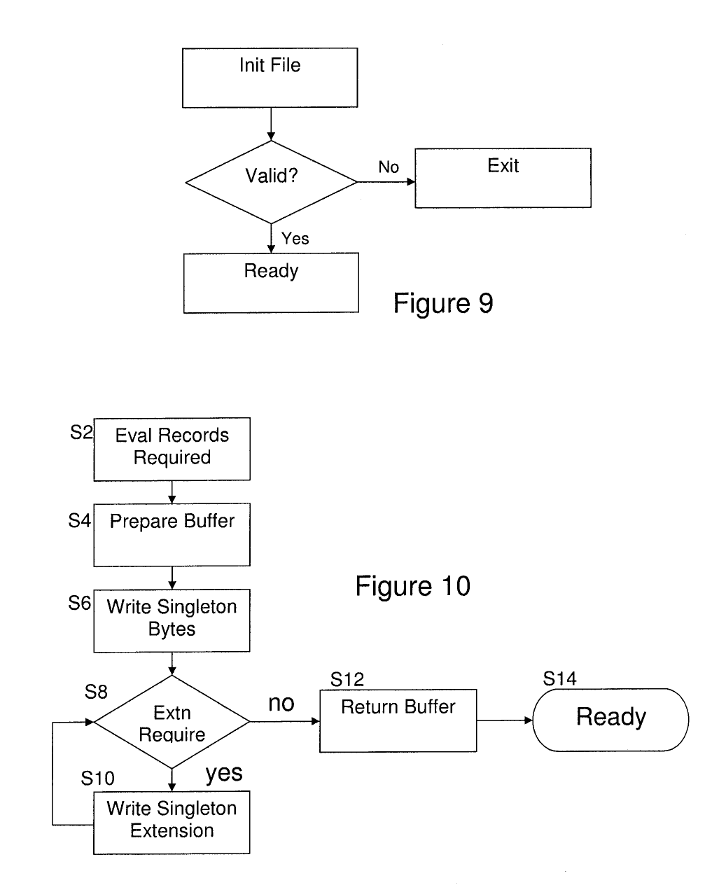

In order to make effective use of the file, we first initialise the file, and check that we do indeed have a root declaration, and if appropriate, an extension record. This is illustrated in FIG. 9, which simply acknowledges that before we can do proper work, we must first validate these items.

The checks and actions can vary considerably in complexity, but at a minimum:

a) if available, a gauge flag or determiner should be read

b) the file should be integral with respect to the presumed gauge

c) lead flags may be present and should be noted

d) a root, self-referential, record for GUID should be present

e) a record for {gExtn} is strongly preferred

The closely defined structure of a well-ordered file in the protocol is such as to make it readily and rapidly apparent if a file is being read with the incorrect gauge. Nevertheless, a gauge indicator is a valid and useful device to either confirm use of a common gauge, or highlight use of a different gauge.

The simplest, minimal, gauge indicator is that of a leading flag, preferably placed as the first record in the file (since the file structure cannot be broken down into a ‘presumed’ record structure until the gauge is known, or presumed prior to contrary indication). Since the gauge comprises well defined integer literals, eg: ‘4’×‘20’, and using the ‘×’ notation in common use, a suggested preferred gauge indicator is as a byte array comprising the refsize bytes as an ASCII literal ‘4’ for example is ASCII 52, and the ASCII literal ‘4×20’ is represented in bytes as ‘52 120 50 48’.

The indicator is then placed as a flag (TypeID zero) as the leading data bytes in the first record, immediately after the refsize bytes of the binary type indicator, here zero. As it happens, since the indicator will be written after the zero bytes of the initial typeid, an implicit declaration of the refsize is also made.

A non-standard gauge can then be reverse interpreted back to two integers, whence for example on opening a file and finding the first non-zero characters at offset 8, and finding then the bytes 56 120 49 48 50 52 followed by (at least one, typically many) zeros, the ascii string ‘8×1024’ is interpreted from the bytes, when the two key integer literals 8 (refsize) and 1024 (record length, aka reclen) are determined, the 8 bytes refsize confirming the earlier discovery of the first non-zero byte at offset 8.

Thus a gauge literal indicator can readily be implemented, and is recommended even in the common (4×20) gauge in the preferred embodiment.

No ‘name’ literal (cf: xml) is suggested or recommended at this time, or until a publicly agreed standard is decided upon, and perhaps not even then, as the gauge hint and file protocol are sufficiently robust in and of themselves to accurately and reliably highlight inappropriate interpretations of non-gauge files, or non-protocol files.

Without d), a {gExtn} type, all Read/Write operations are restricted to Singletons, and data of arbitrary length beyond a singleton data length may not be stored. A {gExtn} type may be ‘late’ declared, but this is generally considered inadvisable. Early declaration (shortly or immediately after the {gUuid} declaration) ensures that both reader and writer are using the same {gExtn} identifier; else multi-record data entered with one identifier {gExtn1} may if the reader assumes a different {gExtn} type ({gExtn2}) be misinterpreted as singleton data, with some ‘unfamiliar’ following singletons of type {gExtn1}. Early declaration of the {gExtn} in use provides reassurance as to the common agreement for the {gExtn} identifier in use.

If it is further desired to validate the file for consistency with respect to eg: Type Declarations (all such binary types in the example are GUIDs), and or any particular specialist knowledge with respect to flags, that can be done at this time.

A specialist data store with a sophisticated indexing paradigm can use the same protocol, but will want to be assured that it created and so has some control over the higher level structure and indexing, overlaid onto the structure provided by the preferred protocol outlined here. The advantage of the structure is that the file remains readable, no matter how complex, for both diagnostic, debugging, and data absorption, extraction and transfer purposes.

Once a file is ‘Ready’ to be read or written to, more formal operations can begin. Ultimately, all operations hinge on low-level Read and Write operations, but given the carefully structured nature of the protocol, we do not advise allowing the user/developer access to a traditional ‘Seek/Read/Write’ methodology.

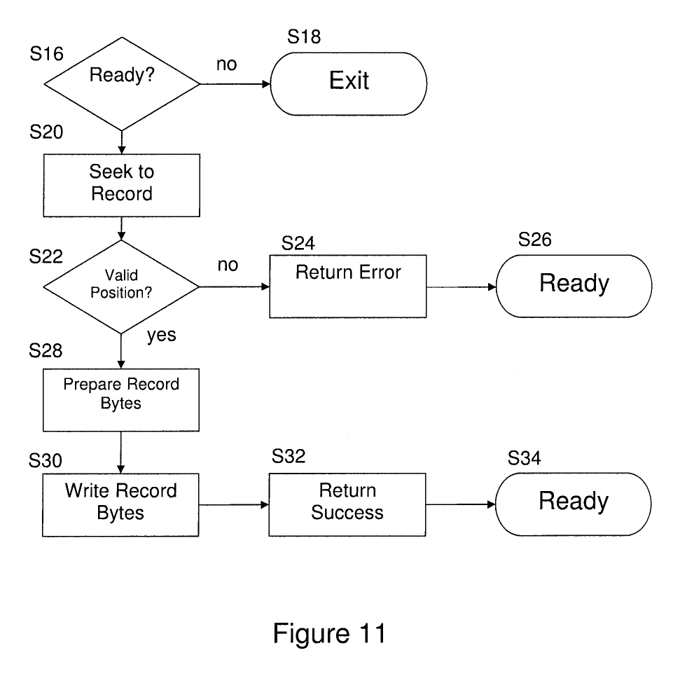

Although the protocol supports data of arbitrary length, it must first be prepared or ‘striped’ into a buffer that is consistent with the protocol, which process can in principle be understood with reference to FIG. 10.

The steps involved in Writing an arbitrary data block are:

In step 2) Evaluate the records required: the deemed gauge of the file determines the databytes per singleton, so for example, to write 40 bytes, with a 4×20 gauge (with 16 data bytes per record) requires 3 records: 16+16+8=40, with 8 bytes remaining unused in the 3rd record.

The final striped buffer for writing therefore will comprise three records, and since each record comprises 20 bytes (in 4×20 gauge), that means a buffer of 60 bytes.

In Step 4) A buffer therefore of 60 bytes (3×20 bytes) is initialized to zero, into which the data can be ‘striped’.

In Step 6) the first singleton is written to the buffer and comprises the intended TypeID of the overall record (6, in our example, for a {gString}), followed by the first 16 bytes of our data (here: ‘London is one of’)

In step 8) while there is more data to write, step 10) writes further singletons to the buffer comprising the {gExtn} TypeID (here 4), and the following 16 bytes of data, until the data is exhausted.

In Step 12) the resultant buffer is now striped into a form that is consistent with the protocol and is ready to be written en-bloc' to the file as required. The process ends at Step 14.

It will be noted that this process, since it occurs in memory, is considerably faster generally than performing a sequence of individual writes, and less risky than having to coordinate such a sequence in a multi-threaded environment. Nevertheless, it is simply one illustration of how a record which may possibly require extension records can be handled consistent with the preferred protocol.

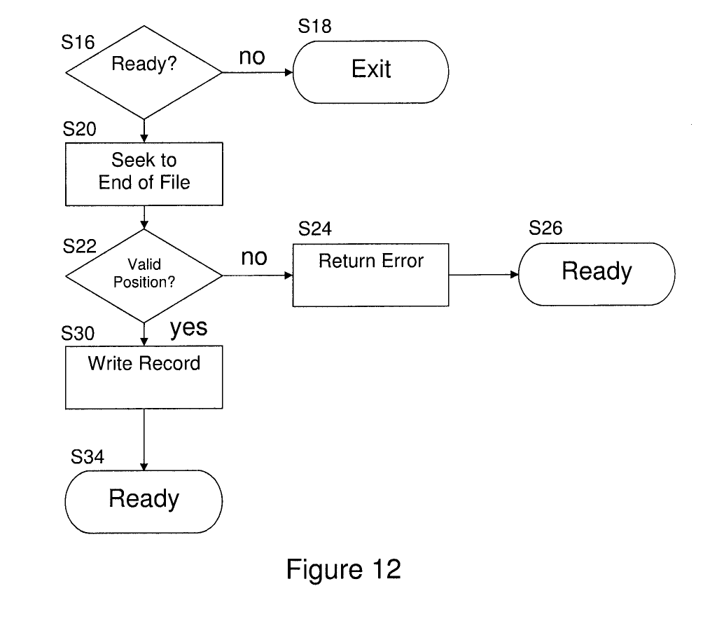

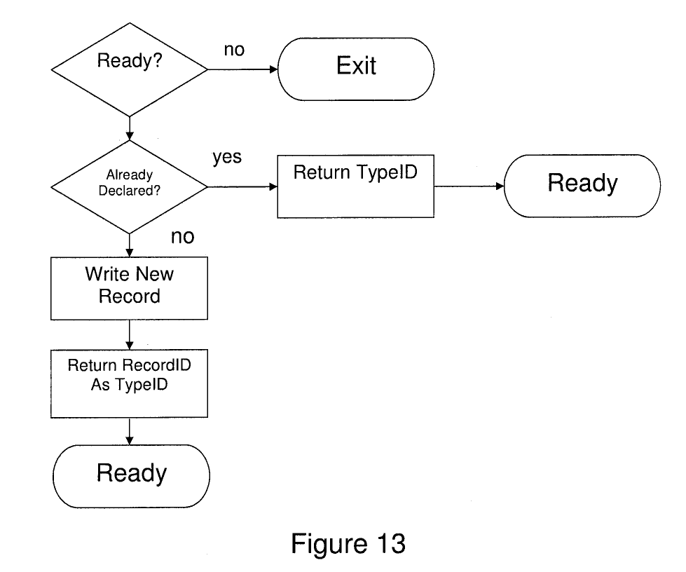

As illustrated in FIGS. 11 and 12, writing such buffers now follows the simple Seek/Write model, though in the preferred embodiment the Seek is implicit in the Write method, by asking the client to designate the intended RecordID (FIG. 11) in a call such as bool Write(int RecordID, TypeID rt, byte[ ] baData), or allowing the engine to perform the seek (FIG. 12) by moving to the end of the file in a call to int WriteNew(TypeID rt, byte[ ] baData). In which case, the function returns an integer RecordID identifier for the record just written, or 0 or a negative integer for a failure. The write process begins in step 16, with a determination of the readiness of the engine. If not ready, the process exits in step 18.

In a multi-threaded environment in particular a distinction may be made between a writer being not ready by reason of the file being full, the writer being uninitialized, or for corruption or other error (in which case the write fails and exits); and being not ready while waiting for a write-access-permission (in which case the procedure can wait indefinitely or for some timeout, according to implementation).

A ‘Seek to record’ request is made in Step 20, and a query as to whether a valid write position has been obtained in Step 22. This is a low-level operation using the underlying operating system's seek/read/write methods, not a method supported for client (user) use. If the position is not valid, an error is returned in step 24, and the process exits and waits in step 26. If the position is valid, then the buffer is accessed to prepare the record bytes in step 28, and the bytes written in step 30. A ‘success’ indicator is returned in step 32, whereupon the process exits in step 34.

It should be noted that implementations of the disclosed technology preferably implement safety checks such that for example ‘buffer overruns’ are avoided, by which a larger write is subsequently requested over an original data record of smaller capacity. A ‘later’ request to write data requiring 10 singletons over an ‘earlier’ record of say 8 singletons would overwrite two following singleton records, causing probable corruption of the data file except where such overwritten records were carefully and previously identified as ‘spare’.

Such checks and procedures represent responsible coding practice as may be expected to be understood and followed by individuals skilled in the art, and as such are not outlined here beyond intimating and acknowledging their appropriateness, and the protocol's capacity to accommodate them.

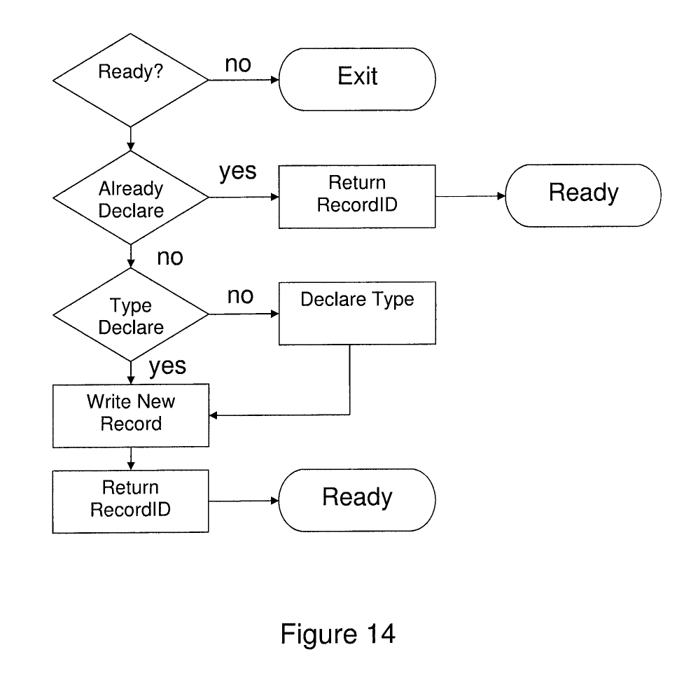

The process of declaring a binary type is illustrated in FIG. 13 to which reference should now be made. In order to declare a binary type such as {gString}, the core processes above are used, with the typical addition that the application or engine (36, 38) may preserve a list or index of recognised and common identifiers, for performance reasons, and will seek to ensure that such identifiers are re-used, rather than having new identifications being repeatedly made.

These are preferences however, and according to the intent or specification of the engine or file, it may provide sophisticated indexing, or it may simply allow repeated re-declarations, each with a different identifier. Each is valid and appropriate, and neither violates the protocol, according to need.

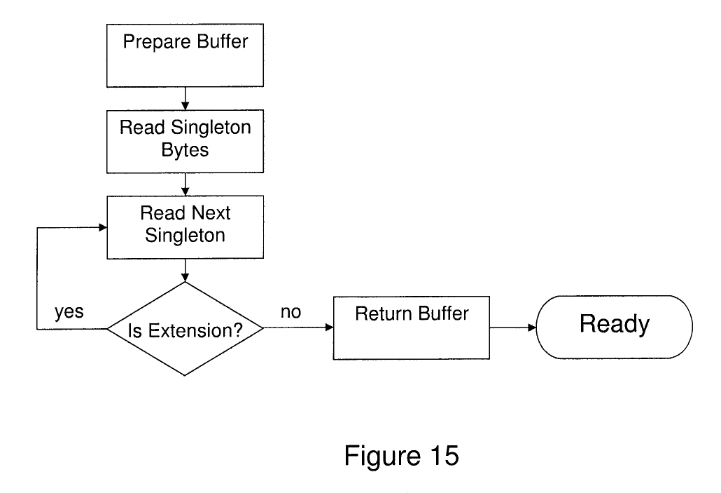

The full process for contributing data then is to first declare its type, and thence to declare a record with that TypeID, followed by the data, per the lower-level functions outlined above. This is schematically illustrated in FIG. 14. As it is up-to-the user to identify the type for the data, the engine is preferably provided with a look-up facility to search through the list or index of identifiers.

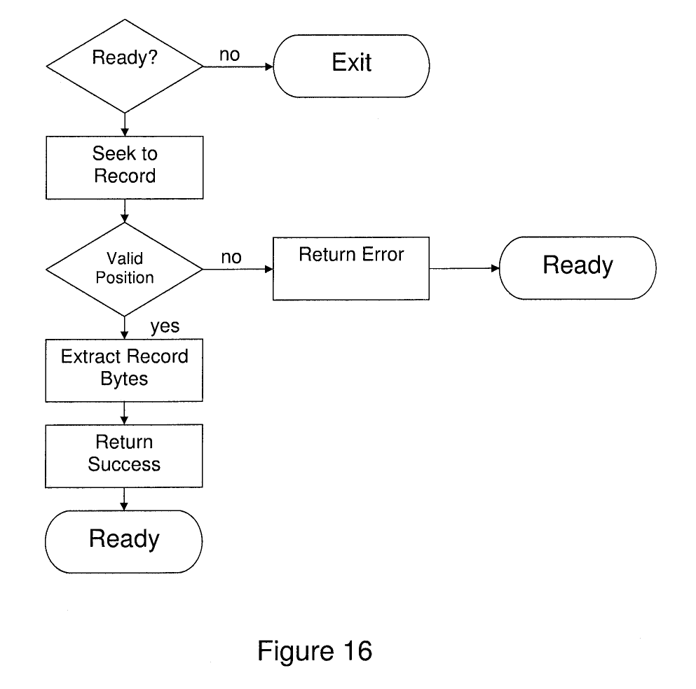

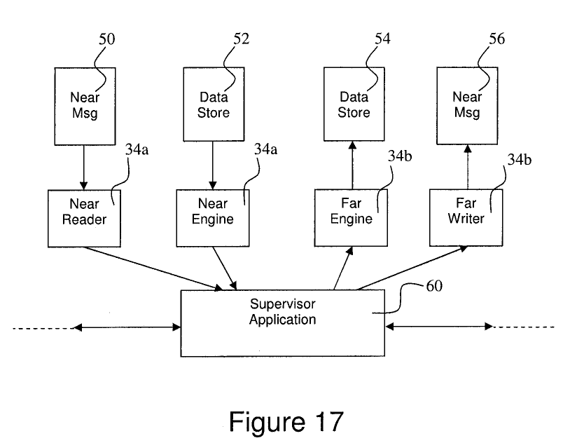

Reading Operations are illustrated in FIGS. 15 and 16. FIG. 15 illustrates the operation of a single Extract Record Bytes. The Extract Record operation is one that is normally simply embedded within the relevant public method such as ReadSingleton, but is separately named here for ease of exposition. FIG. 16 illustrates the actions involved in the read process, including the Extract record action. Reading data reverses the flow of the Write Singleton operation, based on the core Read Singleton operation, which reads a TypeID (integer, 4 bytes in our example gauge), and some data. To ensure that it is not an extension record, a full read requires a loop or algorithm to check subsequent records, and append the data part of each record (which will be typed as {gExtn}) to a buffer carrying the final data.

Without a ‘length’ field in the core algorithm, there is no magic means of determining the correct and accurate length for such a buffer, but the trade off is modest, given the increase in simplicity, and the avoidance of ambiguity outlined in earlier preamble. Performance gains can be achieved by anticipating the potential for extension records. The ‘Prepare Buffer’ step in FIG. 15 is slightly simplified therefore, and various modes for its implementation would be apparent to the skilled developer.

Two simple and common approaches may for example be to store a list or collection of the data segments, until the extensions are exhausted, and assemble them finally into a single contiguous data item; or to read in blocks of records (since disks habitually have an efficient ‘sector’ size, typically in excess of the singleton size), and likewise make a list or collection of such blocks, examining each for the termination of extension records, and so finally preparing and extracting the data into a contiguous data object (typically, a byte array or coding object representing a record/data object with its type and data bytes).

The Read Record algorithm requires a ‘seek’ to the appropriate record, and thence an Extract Record Bytes operation as outlined in FIG. 15. Depending on the intent and nature of the operation, it may be sufficient to return simply the TypeID in place of the binary type GUID, since if the end client algorithm wishes to validate or determine the GUID they can do so simply and directly by repeating the Read algorithm on the TypeID itself. In practice, typical reading embodiments will hold common TypeID's in memory, obviating the need for such a step, or allowing rapid assignment and determination of the associated GUID if required.

All other operations, in common with any storage protocol, ultimately hinge on the operations for read and write, and given the nature of the protocol, it is well advised that they not only be carefully structured in practice to ensure that errors are handled benignly, without corrupting the underlying data, but also that ultra-low-level file operations (seek, read and write of raw bytes, unstriped, and randomly within the file) are permitted only under the most controlled of circumstances.

In practice, such operations are likely to be entirely prohibited, given their risk (especially writing to a ‘random’ location within the file), in a ‘normal’ engine, though they may have some merit in a diagnostic engine. In practice again, however, even there, the simple and well-defined structure of the protocol makes it far more effective and clear for diagnostics if the diagnostic-reader is also tuned to the intended gauge, using the RecordID=TypeID+Data pattern.

The overhead of data striping for extension records is a small price to pay for clear and strict adherence to the protocol. With extension records in place, the protocol can truly be said to support storage of any type, of any length, subject only to the remaining capacity on the device, and in the protocol, the latter being restricted by design to allow ensure only so many records as may be referenced using a signed refsize integer.

It will be appreciated that in the example data protocol provides a truly general data storage facility of well-defined but indiscriminate (not identified for knowledge-structure) data that may be advantageously used in combination with the truly general data structuring facility, that is the subject of GB 2,368,929 (pending US patent 2005/0055363A1), which offers the minimal solution to declaring external, or explicitly structured data (akin to that in a relational database, but more publicly accessible, and open).

The separation between the roles of advertisement of knowledge-structure (as typified by schemas and storage systems that rely on such, such as XML and RDBMS) and the accurate storage and identification of binary objects (of arbitrary or indiscriminate structure) is by design.

The biggest obstacle in the automated assimilation of data is the inappropriate use of embedding human knowledge into binary structure identifiers. This forces an interpreting algorithm to become familiar with the ‘concept’ behind the binary identifier, before interpretation, storage or transfer are possible, which since human concepts are intrinsically arbitrary and subject to interpretation based on language and context, means that a file may only in practice be read by someone who either designed the original file or schema, or who has examined the file or schema and believes that they understand it (by which token it is also apparent that it must have been written in a manner and language understandable by the intended user, and must be accessible at the time of intended interpretation).

This places an extremely high human dependency on the reading process, and would therefore be untenable in a system for universal and automated means of data exchange and absorption. For this reason, in the preferred embodiment the interpretation of the binary data for computer (absorption) purposes is free of any such ‘human’ knowledge dependencies.

This is one distinction between the currently disclosed protocol and those such as XML and RDBMS, with their high human-knowledge dependencies woven into the binary nature of the storage representations, which preclude their absorption into further, typically larger, binary stores by a simple automated process.

While the protocol is strict with respect to identification and structure of its basic interpretation (records with self-referential binary-type identification, preferably via GUID), it makes no presumption as to the ‘human’ knowledge aspects of the data, and as such is freed from human-dependency for sharing and absorption, while retaining the potential for higher-level knowledge encapsulation, via mechanisms such as Triples or other custom knowledge-encapsulating data types.

The preferred protocol nevertheless supports similar facilities to RDBMS (with suitable higher level modules), and so applications for use with the protocol should implement suitably rigorous algorithms to respect the integrity of the data already present. That the preferred protocol allows unparalleled freedom to contribute data spontaneously and on the fly, even if of entirely novel type or structure, follows from the design and principles outlined herein. Beyond the freedom to contribute lies the freedom to share, export or merge.

### Automated Merging of Data

Having described the preferred file protocol, a technique for automated transfer of the data between compliant stores will now be described. Two stores are compliant if the source supports reading per the generalised model described earlier, and the target supports spontaneous contribution per the earlier description.

Neither store need explicitly be capable of recognising, supporting, or providing the transfer protocol itself, though in practice for convenience this will often be the case.

The transfer protocol is facilitated by the use of descriptors that allow a software application or transfer engine to manipulate the data in the source and target stores and so complete the transfer. Advantageously, descriptors are provided for each binary type that is to be transferable. It is further preferable that even data types intended to be private are also described, so that the appearance of ‘lost’ or hidden data is avoided. In this way, all records of transferable binary types can be understood by the transfer engine and thence transferred to the target store. Furthermore, by storing the descriptors as records in the target store, the data is then capable of further transfer by the same model in an ongoing chain or flow of data.

The selection of descriptors can contribute to the success of the transfer process, and careful discussion of each will now be given.

### Scope

One aspect of the need to accurately merge stores is that not all the data in a store may be intended for public consumption. Indices for example may be maintained to order data for fast searching, but would be closely bound to the application which ‘owns’ the data store, and so be of questionable value to an application running the target store. Requesting that a target store absorb and index the index may not only be redundant and expend data storage uselessly, but may in a poorly designed embodiment even confuse the final index structure of the target store. Alternatively, certain records may for example highlight keywords in text with references to the original text, and while being useful in a target store, may alternatively be derivable by the target store according to its own requirements.

As a result, it is useful to be able to indicate within a file what data should be available for transfer and what should not. The Scope indicator is provided in order to make this possible. Three levels of scope are contemplated: namely ‘private’ data (such as indices), ‘protected’ data which is only conditionally transferred, (such as derived keyword references), and ‘public’ data (typically that which was contributed externally, and which is deemed appropriate for onward transmission and sharing).

The intermediate level of ‘protected’ scope will not be further described here, beyond acknowledging that there is a grey area between ‘absolutely private’ data (not available for transfer), and ‘absolutely public’ data (intended for transfer) data. Different techniques for resolving intermediate data (default-ignore, default-store, conditional-transfer) will occur to the skilled person and may be implemented in alternative embodiments.

The emphasis in the preferred embodiment is upon ensuring that data deemed ‘public’ to the context or operating domain is automatically sharable within that domain (ie: set of co-operating stores). The default behaviour of a preferred embodiment is that any data not deemed intrinsically ‘public’ by the descriptors be excluded from the sharing process.

The intermediate state (protected) was a natural one to consider given the affinity of the public/private distinction to coding practice, whereby certain data objects are only conditionally released in a class hierarchy. Data here however is neither intrinsically protected nor private in the sense of an operating system, whereby code which controls execution and compilation can indeed protect the ‘protected’ members of a class. The fact that a file is ‘readable’, means that it is by definition ‘unprotected’. The descriptors here are indicators of intent, to limit the propagation of data of marginal value outside the scope of the original store.

A higher level protocol might in the future wish to implement some form of protection for eg: password and similar data, which should only be extracted from the file under certain circumstances, and may require a security policy at a level determined by the final implementation and embodiment of the managing engine. This is an external consideration that can be legitimately provided without compromising the principles or design structures outlined here.

A Scope indicator is not an essential indicator, as ultimately, any application that can read a file can in principle copy all of the data, regardless of such scoping. It is however a valuable indicator of the usefulness of transferring data and so, while being optional, is therefore a feature of a preferred example.

### Reference and Value Based Data

Data, in the preferred file protocol, may be stored by value, or by reference. Triples are one example of storage by reference. Some means are therefore required to identify and distinguish between reference and value types.

In fact, since the data store allows arbitrary data, which by design is not under the control of the application, it is further possible that a user contributes binary data which is a mixture of reference and value data. It is therefore necessary to distinguish between three fundamental types of binary data, being Value-based (VALUE), Reference-based (REF), and Mixed.

It should be noted that reference types or types with ‘reference’ components do not imply that only one reference is so contained. The descriptions infer rather that at least one such reference is present (even if the referenced ID is zero, the equivalent to a null reference in the protocol).

From a design point of view it is considered preferable if records are always pure VALUE type or pure REF type, as algorithms for manipulating such records can then be implemented in a more simple fashion. However, there are occasions when mixed types are advantageous, especially when the data is not static but is dynamic or volatile. An example would be a ‘time-zone’ record, that holds the current time in some part of the world, or alternatively a financial price record in a trading environment. Both records are equally subject to change on an instant by instant basis.

With the time-zone clock, for example, if a separation between VALUE and REF based data was stipulated for data storage, so that the time value was stored as a reference, then every ‘tick’ of the clock would generate a new record with the current ‘tick-count’.

Thus, a record for the time in Tokyo, for example, could comprise two REFs, a first for {gTokyo}, and a second REF being continually updated with each new REF to the time, 3600 references per hour (at one per second for example). This would inevitably fill up the store with spurious records, which once that ‘tick’ had passed would no longer be required. Clearly this is not effective support for truly ‘volatile’ data and an alternate solution is desirable.

If, however, only a pure-VALUE record is used for the dynamic data, (since pure-REFS generates the problems indicated), then a concise 8 or 12 byte representation of time (4 bytes for a ref to timezone, and 4 or 8 bytes for the time value increment) becomes a 20 or 28 byte record, with now the full guid being required to identify the timezone.

It would be more concise to be able to continue to use an initial ref, followed by a value part. This is an example of using the time-zone ref (or value) as a key, or static leading part of a dynamic record.

Static leading bytes within a record allow stable indices to be created even with dynamic or volatile data, thus considerable reducing the reconfiguration of indices required if ‘pure’ volatile data is allowed. The preferred embodiment uses the static leading bytes model to index data, as will be described later.

The static ‘key’ allows a dynamic record to be found (and updated) by filtering on the key ‘mask’, and then reading the current dynamic part. A key however has to be distinctive enough to reliably and unambiguously distinguish one dynamic record from another. The smaller the size of an integer key, for example, the more likely it will be re-used, and the less suitable will the integer be as a global recognised identifier: countless databases around the world start their first record of each table with a ‘1’ (one), for example, yet each of those records is different.

The preferred file protocol uses GUIDs (UUID), as a reliable, practical, anonymous identifier that is unlikely ever to be re-generated by chance. However, if this is used as the key, the 16-bytes (the entire width of a single record in the preferred protocol) are used just to declare the key. This is inefficient in comparison to using just 4 bytes if a REF was used in its place.

It is true that the GUID still needs to be stored elsewhere, so that a ref uses a 20 byte guid record plus a 4 byte client ref, vs the 16 bytes if it is directly embedded in the compound record, but the GUID identifier would still typically be stored elsewhere, in order to allow it to be recognised and collated, as here for example, in a list of time-zones, so that once a GUID is contemplated to be used, it can typically be presumed to require an independent record of its own anyway, in which case the default preferred behaviour would be to be able always to refer to further instances of that GUID by reference.

It is therefore advantageous to use a REF for key, which commonly suggests that for dynamic records in particular, but other binary types also, that we require support for mixed Record REF+VALUE records.

It might be argued therefore that if a REF+VALUE combination is tolerated, then a VALUE+REF combination, and indeed any such combination, for example REF+VALUE+REF, REF+REF+VALUE etc should also be tolerated, so that a binary type may be described as a sequence of apparently random (to the computer) elements being either a REF or VALUE, as chosen by the binary type designer, a coder or developer.

We can however considerably simplify the task of the computer algorithm in managing such potentially complex sequences of REF and VALUE component elements.

It is clear that in the present fixed-buffer-size model, any combination of (various) REFS+(various) values can be shuffled by a binary-type designer into a REF part+VALUE part, where by a REF part a contiguous array of zero or more references. If there are zero references of course, the binary type is simply a value, and if the length of the value part is zero, then it is simply a ref (and if neither is present, it is empty, or blank).

In this manner we can see that the binary type designer could, if required to, re-order the design into two contiguous parts, an array of zero, one or more refs, and a value part of length zero or more bytes.

If the resultant design places the ref part first, we call this REF+VALUE. This is the preferred representation of mixed ref+value data, with refs leading, as the common usage will be for the hybrid data to ‘describe’ something, and the leading ref will commonly be an indicator to that something. In a time-clock example, the leading ref would be to {gTokyo} and the time-zone data would be only one of many possible facts knowable ‘about’ Tokyo, and searchable by enquiry on the leading ref.

In a wide gauge file, by contrast, with records of 1024 bytes, using a leading ref as the key would require storing the key (typically a guid) in a 1024 byte record, using only 16 of the 1020 data bytes. This is clearly inefficient, so that a mixed record in a bulk (wide-gauge) store would typically use a value based key, so that the preferred order would be VALUE+REF.

We have not yet found a reason to create such a record, but we have concluded that it would be prudent for the protocol be able to do so.

Rather than coding for two distinct cases therefore, we wrap the two cases into a single ‘RVR’ model, for REF+VALUE+REF. This does not refer to a single ref followed by a value followed by a ref, but to a conceptual ordering by a byte designer into three segments, comprising zero, one or more leading refs, a value part of length zero or more bytes, and zero, one or more trailing refs.

A ref or refs only record will have leading refs only, no value (length zero), and no trailing refs. A value record will have no leading or trailing refs. A REF+VALUE record can be represented with trailing refs zero, and a VALUE+REF record as leading refs zero.

It would therefore also be legitimate in the RVR model to support binary design with all three elements non-zero. However we would strongly recommend the designer keep the design as simple as possible, as we have found the REF+VALUE model to be entirely sufficient until this time, and while we support the full RVR model, only the simpler REF+VALUE may be utilised in some embodiments.

Indeed, for the purposes of exposition of the manner and means to transfer data by segregating into REF part plus VALUE part, we will consider only the simpler REF+VALUE case. If the reader follows that argument, then the implementation of the richer RVR model, with its trailing ref segment, can be handled by extension of the similar handling of the leading ref segment, a modification readily provided by a developer skilled in the art.

REF+VALUE will be used as shorthand for a REF part+VALUE part, comprising a contiguous block of zero, one or more REFs followed by zero, one or more VALUEs. A pure REF record can be regarded as comprising entirely a REF part and having zero bytes in the VALUE part, and a pure VALUE record as being comprised entirely of a VALUE part and having a zero bytes sized REF part.

Slightly more accurately, the VALUE part may comprise zero, one or more VALUE-bytes: ie: bytes for which a naïve copy algorithm is sufficient to transfer them to another store. It does not matter if the VALUE part is really 2×Int32, 1×Int64, or 8×bytes, as far as such a copy algorithm is concerned. VALUE data may simply be copied and no corruption will result.

Thus, if we consider transferring a simple REF+VALUE hybrid, then the nature of the record can be specified by identifying solely how many bytes comprise the REF part, and acknowledging that any bytes after that part must by definition comprise the VALUE part. Notice that the REFs part is specified by bytes, not by ‘REF count’ or number of REFs in the record.

Given that it will always be critical to appreciate the gauge (ie: the size of a REF) in order to transfer data accurately, the REFs-section length could be specified by means of a REF count. However, it is preferred to use bytes at least for consistency with the ‘static bytes’ parameter which will be described below. Thus, making use of a figure RefBytes=r, then according to r, the structure of a record can be described as follows:

r = −1 (entirely refs) then [RefPart] = the entire record,
[ValuePart] = null, or empty
r = 0 (entirely value) then [RefPart] = 0 bytes, [ValuePart] = the
entire record
r = 4 (one ref, Int32) then [RefPart] = 4 bytes [ValuePart] = the
remaining record
r = 8 (two ref, Int32) then [RefPart] = 8 bytes [ValuePart] = the
remaining record

For the last case, r=8, and for a system implementing Int32 references, the significance of the r bytes indicator means reading for example the first 8 bytes of a record as two 4-byte integers, treating them as references, and reading the underlying records so indicated to ascertain their value equivalents. This may involve a VALUE hierarchy if underlying records also comprise REFs. The remaining value part can simply be read and extracted from the record, and noted as being the VALUE part.

As will be described later, storing a data object representing the REF and VALUE parts accurately in the target store comprises an algorithm to translate the REF part (including any VALUE hierarchy) into a REF array, and converting that REF array into a byte array (converting each REF into its 4-byte representation, for Int32 refs), and appending the VALUE part, before finally inserting the record into the store.

### Static and Dynamic

As mentioned in the example above, records in the preferred protocol for handling dynamic data comprise a static part as key with the dynamic data as a ‘tail’ in the rest of the record. The REF+VALUE model allows the protocol to support hybrid mixed ref and value data, so avoiding for example using 16-byte Guid values as keys, or creating many spurious records as in the volatile time-clock example above.

The static part of the record can be used to provide a mask or filter for the record, by which a particular record containing the dynamic part can be found. However, from the perspective of a data store there is no intrinsic aspect to binary data that indicates how many bytes are static, any more than there is an arbitrary rule as to how many bytes are REFs. A further indicator is therefore required to delineate static and dynamic data in a record, so enable the record to be divided conceptually into its [StaticPart]+[DynamicPart] elements, using a StaticBytes value. The structure of a record can then be inferred solely from the StaticBytes value s, as follows:

S=−1: the entire record is static

S=0: the entire record is dynamic

S=n>0; the first n bytes are static, the remainder dynamic

S<−1; out of protocol—the record will be ignored for normal, public operations

With the StaticBytes indicator s supplied, the serialized bytes of a record can be passed to a data store for storage. According to the preferred data storage protocol, a command MatchInsert (as described below) will mask the first n static bytes of the record and filter the store for that masked portion, or if all the bytes are static, will filter for the entirely-static record. In this way, the data store can discern whether the record exists already in the store, even though the record may comprise a dynamically changing part.

Notice that specifying S=4 for an Int32 4-byte integer is not the same as specifying S=−1. In the former, ANY record with that particular integer will be found, regardless of any trailing bytes which may or may not be present. In the latter, only a pure record comprising solely the Int32 and no trailing bytes (other than zero) will be found. Thus, pure static records are always marked S=−1, not according to the length of the bytes they may happen to have.

Ultimately, therefore, only two indicators are required: RefBytes (to resolve the structure of the original record into a REF part and a VALUE part; and StaticBytes to indicate how many bytes to rely on for the static key, which if −1 may be the entire record. The descriptor protocol is therefore sufficient to enable any arbitrary but well-defined simple VALUE, simple REF, or hybrid REF+VALUE, accurately described (with the indicators) to be automatically transferred and subsequently stored in a further device recognising and compliant with the indicators.

### FluidDef Declaration

In a later part of the application we will outline a declaration model appropriate to the full RVR (REF+VALUE+REF) model. Here we outline one possible embodiment of a declaration sufficient to support the simpler REF+VALUE model, with static bytes indicator.

The information necessary for the descriptor protocol has been outlined above. In the preferred example, this data is combined and expressed by means of a high level descriptor known as FluidDef. The FluidDef definition is a mechanism for providing meta-data on the types of binary data and/or record structure stored in the storage protocol. This metadata is used by a merging data system to correctly handle the records as they are read from one store and transferred to another. The FluidDef is a preferred technique, and other techniques are possible as will be described later in the application. It will be apparent that without a mechanism like FluidDef or the alternatives as set out below, automatic transfer of data could not take place.

As noted above, there are two central indicators, RefBytes and StaticBytes, and an optional but useful Scope indicator. These can be encoded into the relevant descriptors in a number of ways, as indicated below. For example, beginning by serializing the data in order of ‘priority’ gives:
[TypeID (ref)][StaticBytes (value)][RefBytes (value)][(optional) Scope (ref)]

In the preferred protocol, which is self-referential, binary types are referred to within a particular file by their TypeID, which is a reference to its binary type GUID. Thus the TypeID is a reference. Further, there are two values, simple byte counts, for StaticBytes and RefBytes respectively, so there is immediately have a mixed REF+VALUE record candidate. We also have an optional ‘scope’ indicator, but which is strongly preferred to be present.

However, as presently listed, this is as Ref+Value+Ref type, which is contrary to the mixed Ref+Value model currently under consideration. That does not preclude its storage outright. It simply means that it will not transfer automatically, since its definition would not fit within the [RefPart]+[ValuePart] model.

Since we wish the binary type descriptors, here a FluidDef, to be transferred also however, we need to reconfigure the binary type design into at least a REF+VALUE hybrid, if not entirely REF or entirely VALUE.

A preferred declaration therefore takes advantage of the [RefPart]+[ValuePart] model, for the declaration itself.

Thus we can simply re-order the elements as:

[TypeID (ref)][(optional)Scope(ref)][StaticBytes (value)][RefBytes (value)]

Or

[TypeID (ref)][(optional)Scope (ref)][RefBytes (value)][StaticBytes (value)]

This record now comprises a RefPart with two refs: TypeID and Scope, and a ValuePart with two values: StaticBytes and RefBytes.

As the binary type designer, we have the choice of putting the TypeID before or after the Scope, and still complying with the RefPart+ValuePart condition. Anticipating however that we intend to ‘declare’ the subordinate Scope, RefBytes and StaticBytes as subordinate attributes of the particular subject Type, then clearly the TypeID is key. As such when we later introduce (MatchInsert) and later query for (MatchFirst) the declaration, we will need to do so on the TypeID, which in the lead-bytes indexing model, means that for the purposes, the TypeID should be first.

There is also a choice of putting StaticBytes before or after RefBytes. There is no obvious matching implication here, and in any case, it would not be practical to match ‘past’ the scope, with any reliability, since the scope is optional, and indeterminate for any given type. Declaring it is after all, the reason that the record would be written.

Thus, there is no strong indicator as to whether RefBytes should be stored before or after StaticBytes, nor is it of any consequence. The job as a coding developer is to identify the binary type structures we need or would find useful, ensure they are practical, and comply with any protocol requirements (as here), and then simply use them consistently.

The preferred embodiment store the values as Int32 integers, which makes them easily readable in visual decoders (which assist in reviewing a file) since REFS are also Int32, so that either of the declarations above would fit neatly within a single singleton (one-record) Aurora UDF Record. Alternatively, the values could be specified as Int32, Int64, UInt32, UInt64, Int16 etc., and there are indeed a plethora of ‘legitimate’ possible declarations.

Thus, an example of a public and formal type declaration for FluidDefs in the preferred embodiment is:

TypeGUID(FluidDef): {E5C9C749-1FF0-43b8-B27D-CF8722194912}
TypeID (self-referential indicator of the binary type being described)

| | |
|---|---|
| ScopeGUIDs | (as defined above, and stored by Int32 ref) |
| StaticBytes | (Int32, as defined above) |
| RefBytes | (Int32, interpretation as defined above) |

This definition can be regarded as entirely static, in that the definition of a type should not be subject to change. However, so that multiple declarations for a single TypeID, can be avoided it is useful to be able to ‘key’ by the TypeID. To do this, the number for StaticBytes is specified as 4 (as a single Int32 ref).

According to the above, there are two further refs, the TypeID and Scope ref. Even if the scope is not supplied (though it is preferred if it is), then the REF will be zero (the four bytes all zero), and should still be properly treated as a ‘potential’ reference, or null reference. Thus, RefBytes is the Int32 ‘8’.

The scope for FluidDefs is preferably ‘public’, as in this way any FluidDefs in a data store will be passed into the target store, as well as the data of the types they describe. In this manner, if such data is intended for extraction or onward transfer, the definitions required to make that possible will be present. If the scope of the FluidDef is not public, then the FluidDef would not be passed. Although, the data it defined could be passed, the passed data would then be stuck in the target store without means to transfer it onwards, unless the far target already ‘knows’ this type. However, this places far too great a demand on the target store and lessens the usefulness of the protocol, which aims to ensure that data can be passed successfully, the first time, and every time after that.

The FluidDef mechanism forms a desirable feature of the transfer process. Not only does it allow a single automated transfer between two stores, but in fact makes possible a cascading process whereby provided that the FluidDef is properly and legitimately passed (ie: it is public, and no contradictory definitions arise), then there is no reason to stop the data being passed across an uncountable number of stores. If a contradictory definition arises, then the data merging system may be configured to disallow the transfer, in part or entirely, and may further bring the conflict to the attention of a human operator who may visibly inspect the FluidDefs, and associated data and resolve the issue.

The FluidDef type therefore itself has its own FluidDef so that it too can be transferred. In practice, the FluidDef for the FluidDef type is declared like any other data type in the protocol. First, a GUID is declared for the concept of the FluidDef itself. Imagining that the GUID receives a nominal record ID of ‘6’, then ‘6’ will be the ID, and TypeID, for the entire record defining the FluidDef GUID and the ‘subject’ TypeID for the FluidDef of the present example.

Declaring the ‘Scope.Public’ GUID {gScopePublic} by storing it as a record in the store, and receiving a nominal reference for that record of ‘7’, there is then sufficient data to store the preferred FluidDef, comprising the TypeID for the record, and the four Int32's per the structure above:
6: 6.7.4.8 (ie: TypeID(6): DataBytes((4×Int32) 6, 7, 4, 8))

Where the 6, 6 and 7 are all Int32 refs, and 4 and 8 are Int32 values. We note as regards nomenclature that all descriptions such as TypeID(6), TypeID({gTypeGUID}) etc. are included as means to encourage understanding, and imply no requirement for keywords in the protocol itself.

To extend the example to other binary types, a FluidDef for a simple static type such as ‘Int64’ can be declared as follows.

Assuming the {gInt64} TypeGUID has received a nominal ‘19’ as the TypeID, the FluidDef can be declared as a natural ‘public’ type, which is entirely static, and entirely a value, thus:
6: 19.7.−1.0

By contrast, a Trinity Triple, which is again entirely public, but now entirely REFS (thereby requiring a RefBytes indicator of −1), and which has precisely 3 static REFS (for StaticBytes 12), and a dynamic open REF to describe ‘ignore’, would be declared as follows, assuming a TypeID for triples as 9:
6: 9.7.12.−1

Any binary type which is properly described in this manner, can now be read, evaluated according to the principles set out herein, packed using a single common algorithm across all binary types, context and data, transferred, and serialized. In order to do this, it is necessary to be able to look up FluidDefs for a record once the TypeID of that record is known.

### Transfer Process

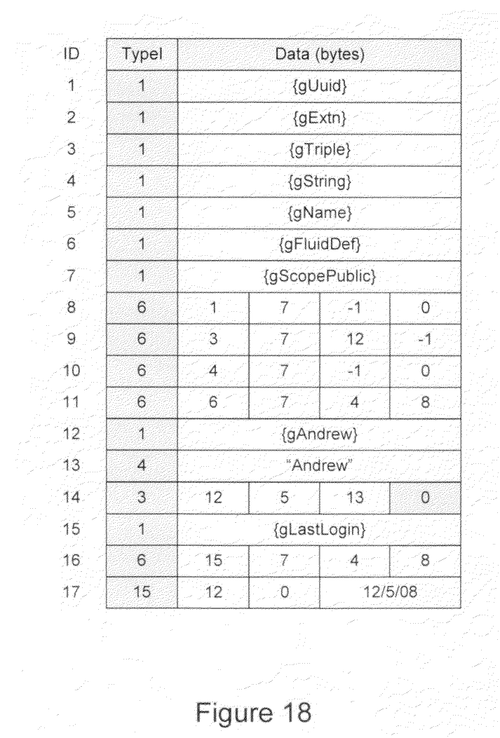

FIG. 17 is a simplified illustration of the FIGS. 4 and 5, showing the mechanism for transferring data between data stores in a local environment, where a single application can reference both near data source 50 and 52, and the intended far (target) data 54 and 58.

File/Data Store 20 of FIGS. 4 and 5 are shown here as respective data stores 52, 58, and files (messages) 50, 54. In the same way as before, applications 34 control reading and writing of data according to the protocol, and may be implemented in the integrated or distributed fashion of FIG. 4 or 5. In FIG. 17, the reading and writing applications have been divided into near reading and writing applications 34a and far reading and writing applications 34b.

In addition, a supervising application 60 is provided in communication with the reader and writing applications 34a and 34b in order to control transfer of data from one store or file to another. Although, the directionality of the arrows indicates data transfer from the near store to the far store, it will be appreciated that this is purely for illustration, and data could be transferred in either direction as required.

In the local environment, it is assumed that internal memory is sufficient to allow records to be transferred between the near and far stores, with re-configuration of data as appropriate and according to the algorithm outlined below, without the need for an intermediary (message) file or store.

Where it is impractical to hold open both source and target stores simultaneously, for example as may be true across a wide area network such as the Internet, an intermediary message store may be employed. The horizontal arrows from supervising application are intended to indicate links across the Internet or Wide Area Network (WAN), with supervising applications 60 at other locations (not shown), or with intermediate message stores at other locations (not shown).

Transfer of the data from one store to another across the Internet or WAN is preferably via a message, via any suitable means of data transfer known in the art, including but not limited to methods using TCP/IP protocols, or web services, or even email attachments for example where a client requests an extract of data from a web-site.

It will be noted that the source data may be either an unindexed store, called a message store herein, or an (indexed) data engine, and that likewise the target may be unindexed or indexed. Since the underlying file structure is identical at the lowest level, there is no significant distinction between an indexed or unindexed store for the purposes of the transfer algorithm.

An engineer skilled in the art may refine the final embodiment for performance purposes, by omitting the overhead of ensuring unique records in a simple message, but for the purposes of exposition and to emphasise how a common protocol addresses both cases, we will use the verbs and language commonly used in manipulating indexed stores, where the ability to ensure a unique (atomic) reference for an item is an advantageous feature of the embodiment.

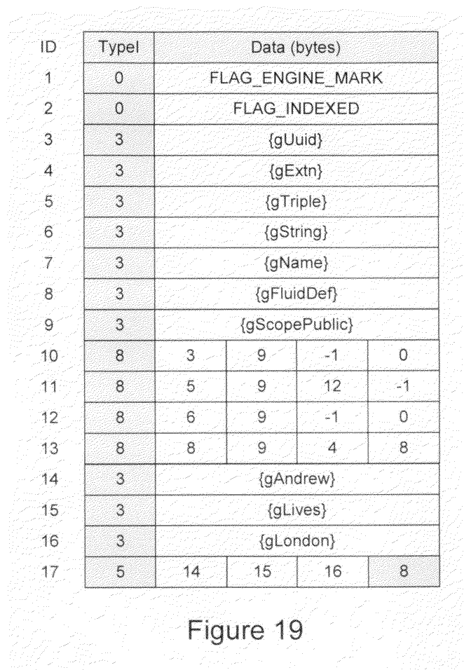

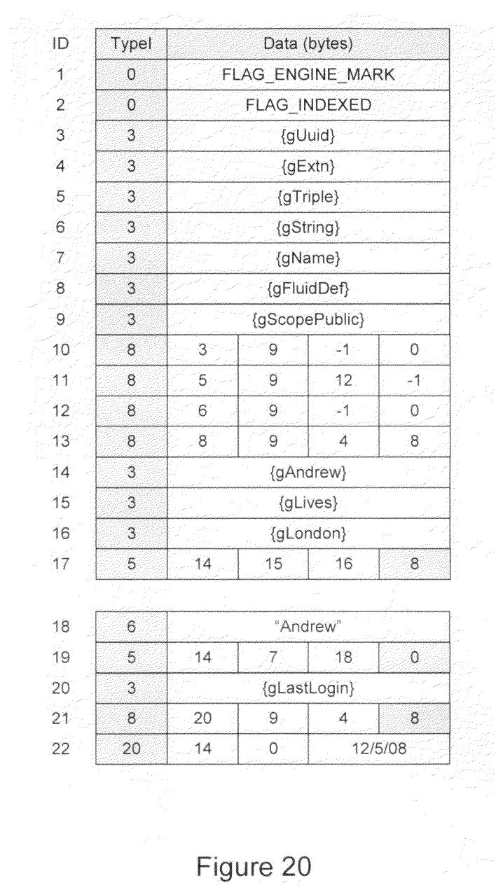

An example of data transfer from a near store to a far store will now be given to illustrate how FluidDefs are used. FIGS. 18 and 19 illustrate the contents of the near and far data stores 50, 52, 54 and 56 before transfer of data occurs. The structure of the data store is explained in more detail above with reference to FIG. 2, and so will not be repeated here.

Referring to FIG. 18, the near store 50,52 can be seen to contain a number of binary type definitions, (IDs 1 to 7), followed by a number of FluidDef definitions for specific Binary Types gUUID, gTriple, gString, gName, gFluidDef, and gLastlogin FluidDef records 8 to 11, and 16 are all necessarily of type 6 (as this record defines the FluidDef type), and in the first record part of each record the record ID of the corresponding Binary Type is given: 1, 3, 4, 6 and 15 in this example.

The example data store contains a message (in the data sense) embodying two facts that are to be transferred: a user's name expressed as a triple (in record 14),

[{gAndrew}.{gName}.“Andrew”], and a user's last login time, expressed as a custom record of binary type {gLastLogin} comprising two references (one for a user identifier, here a GUID {gAndrew}, the second reference being ‘reserved’ (left unspecified, as zero). In addition, there is a date field, comprising a value of eight bytes, such as for example an Int64 long integer denoting the Ticks (time increments) since CE Zero.

This record is complex in that it is dynamic (the last login time and the reserved field may both later be altered) and it is mixed (it comprises both references and values). This record type is not intrinsic to the engine, but is used here for illustration as it requires complex algorithmic handling.

Referring to FIG. 19, the far data store 54, 56 can be seen to comprise a similar (though not necessarily identical) list of binary type definitions in records 3 to 9. Note that although in this example corresponding types are found in both the near and far store, they have different record IDs as would likely be the case in a real example. One difference present in the far store illustration is that two example flags have been stored [data records of type zero, which provide useful ‘indicators’ at the start of a file]. Flags are particularly appropriate to indexed engines whose internal structure precludes naïve writing or appending to the file without appreciation of the engine's indexing algorithm.

The far data store also contains an example triple {gAndrew}.{gLives}.{gLondon} in record 17. The reader will recall that {gAndrew} is a readable form of pseudocode for a GUID representing a concept or type.

### After Transfer

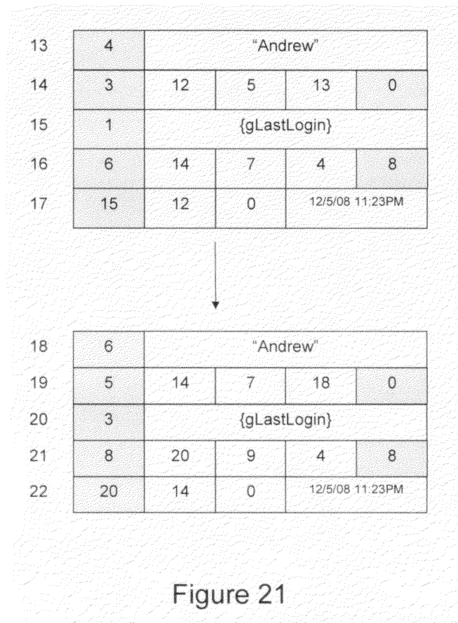

FIG. 20 shows the result of merging the near data store into the far data store, which follows from the technique presented below. As can be seen from the diagram, only five new records required adding to the far data store for the transfer to take place, and for the final far data store to contain the same data as the initial near and far data stores combined. The new records are shown slightly separated from the other records purely for the sake of clarity.

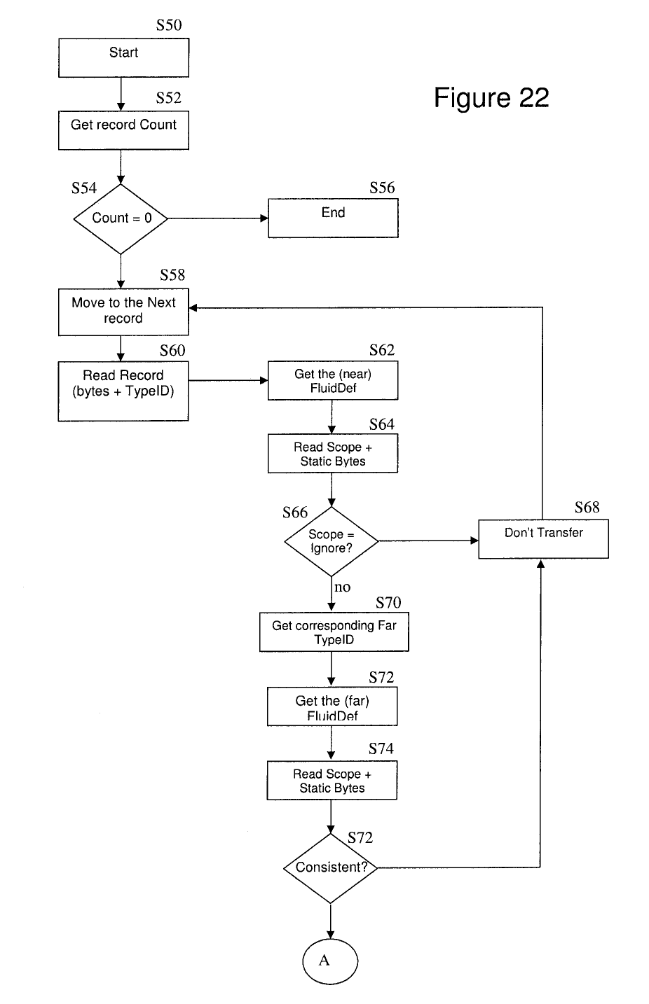

FIG. 21, illustrates how the transfer differs from a simple and naïve copy. The records cannot be copied directly to the far store but must be first interpreted according to their type, and subsequently added to far data store in a fashion consistent with that store.

As a result, it will be noted that of the five new records in the far store, none are identical to the naïve bytes which represented them in the source file. Thus each has had to be modified to ensure that it continues to accurately represent the meaning embodied in it that the original authors of the binary type intended.

Of the five, only two have their internal bytes unaltered, being the two value based records: namely, the string “Andrew” (the actual byte embodiment—according to the byte encoder of the string type, in our typical embodiment, a UTF-8 encoder); and the GUID {gLastLogin}, the type identifier for the custom ‘Last Login’ binary type.

The other three records all have their REF parts modified to reflect the accurate storage of the data they refer to: here, for simplicity, all pointed to simple GUIDs or other values, such as the string name. In practice, no such guarantee applies, and so the transfer algorithm is recursive, as the record being referred to may itself contain REFs which require prior transfer before generating a far REF for that record. In this manner, it can be seen that the algorithm, and hence the combination of file storage protocol and the algorithm, provide a true referential environment, with automated data transfer based on a single, well-defined protocol, provided only that the binary types satisfy a minimal declaration as to their Fluid Def [static bytes+data] embodiment.

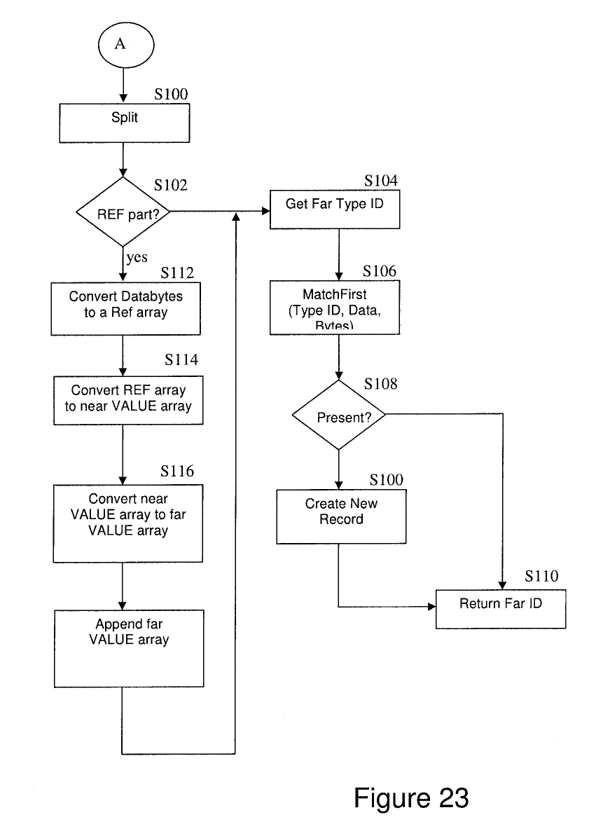

The process of the transfer will now be explained in more detail with reference to FIG. 22.

From the FIGS. 18 to 21 above, it can be seen that there are a number of value records (GUIDs and strings) to be transferred from the near to the far store, preferably without duplication in the far store (in an indexed store); some referential records (e.g. triples), the references of which will need to be modified so that they are based on the appropriate values in the far store; and a mixed record (last login) for which the references will need to be modified, while the value part remains unchanged.

For all of these records, the TypeID references will need to be changed. The (intentional for the purposes of the illustration) presence of flags in the far store means that even if the types had been declared in the far store in the same order, there would be an offset of two records. Thus, the core root GUID declaration is no longer simply ‘1’ (one), but is now the third record, and so has TypeID ‘3’.

One feature of the embodiment is that the transfer of data between the stores be possible for all possible transfers of data compliant with the above protocols. The following discussion of the transfer process, is therefore intended, based on a very few key verbs, to handle not just one such transfer, but all possible transfers of data consistent with the REF+VALUE model.

It is a further consequence of the transfer algorithm and underlying data protocol that it applies not simply to subsets of data within a given file, but to the entire file itself, no matter how complex, so that any application developed to store to such a file becomes automatically capable of transfer into a second compliant store. This is in strong contrast to, for example, spreadsheets or relational database files, neither of which have been traditionally designed to be absorbed automatically into either a second like spreadsheet or database, or into the converse, database (for spreadsheet) or spreadsheet (for database).

We thus enable not simply the exchange of data, but the potential in reduction in the actual number of such discrete sources, so reducing the number of potential sources which need to be targeted for any given enquiry to produce a successful result.

The transfer process for a set of records, either the entire file, or a subset of the records of the file, occurs as a sequential process of transferring each record to the far store, and receiving a reference to a record ID for that record in its turn.

The ID acts in part as an indicator of success. If a record is not transferred, the far ID will be zero. It also is used where the local (near) record is referenced in a subsequent record, so that certain of these Far IDs (RecordIDs as received by the transfer process) may represent such mappings of locally referenced records to far references with which we can construct an equivalent record in the target store.

These far record ID's may be temporarily stored in the supervising application 60 to facilitate the transfer process. In this way, if a record is to be transferred twice, as for example where it occurs as a reference in a subsequent record, the copy of the subsequent reference in the far store may simply refer to the earlier returned far reference, without needing to transfer an additional copy of the record for matching and detection. This is handled by the supervising application.

It is accepted as conceivable that advanced implementations may seek to optimise storage or perform functions that may modify reference stability, but it would be straightforward to insist that such operations occurred only while there were no other connections that might be compromised while such re-referencing was occurring. In other words, it is reasonable to suggest that an embodiment be created such that references remain stable for the duration of a connection, precisely to support enhanced performance by local temporary storage of references (RecordID's) whether in data transfer, or in normal data storage/retrieval processes.

The transfer process begins in step S50 with the activation of the supervising application 60, causing it to access the near store 50, 52, an in step S52 determine the total number of records contained in the store. At this stage, only the total number of stored records is required, regardless of whether TypeID, flags, or Scope indicators indicate that a particular record or set of records is or is not transferable. Determining the number of records is therefore a matter of dividing the number of bytes used for storage in the store or file by the length of the record gauge. See above for a more detailed explanation of the gauge.

This assumes that the intent is to transfer the entire content of the file, subject only to normal protocol limitations as noted above (TypeID out of protocol, flags, and scope private records are not transferable, by design). If the intent is to transfer only a subset of records, then it is presumed that a list of such record ID's has been passed to the transfer algorithm, based on client needs (eg: in response to a query or user selection), and that only those records plus supporting records (referenced in those records, type identifiers for those records, and fluid data declarations for those record types, as appropriate) will be transferred.

In either case, the transfer proceeds by sequentially attempting the transfer of local record ID's, from first to last, whether of the entire file, or of the list of Record ID's passed for transfer, and transferring first their supporting records, then themselves, as appropriate and indicated in the following procedure.

Once the number of potentially transferable records is known, the supervising application 60 makes an initial check that the store or file is not empty or misread. Decision step S54 therefore checks for a record count of zero, and on detection terminates at end step S56. Assuming a record count of greater than zero, the supervising application 60 enters a loop S58 in which each record in the file or store or subset of records requested for transfer is individually considered. Starting at the initial byte offset of zero, the file pointer moves to the next record for reading in step S60. Reading the record is explained in detail above. The result of the reading step, assuming a properly constructed record, will return a TypeID for the record, plus its naïve data bytes. The TypeID of a properly constructed record refers to the recordID of the corresponding record which stores the GUID used as a binary type identifier for that type. Knowing the binary type of the record it is then possible to retrieve in step S60, from the near store, the FluidDef for that type to indicate to the supervising application whether the record is to be transferred, and how it should be transferred.

A corresponding action to determine the deemed FluidDef as known or recognised by the target store, may also be carried out, and likewise any discovery of such a FluidDef in for example a local application (for example the transferring data engine) or registry (such as the Microsoft Registry), or a global particular resource (akin to xml documents publishing schemas), or global ‘standards’ authority registry, may further supply a FluidDef.

Where multiple FluidDefs are available, they should be checked for consistency. Dissimilar FluidDefs giving rise to contradictory claims as to the structure of the binary data will prevent transfer.

In step S62, the first step in determining the FluidDef for a TypeID is to find it. In the preferred embodiment FluidDefs are deemed to be entered as records keyed to the TypeID they describe. This means that we may use a searching verb, defined here as MatchFirst, to locate the desired record. MatchFirst is a core generic verb used in the preferred embodiment, providing a function somewhat equivalent to a ‘SELECT . . . WHERE’ clause in a traditional SQL embodiment, and returning the first RecordID matching the particular binary filter.

Unlike its SQL counterpart however, the MatchFirst targets not a complex structured table, but a single common implied index across the file or engine, returning the first RecordID whose leading bytes match the supplied filter, according to the following example method prototype:

| | |
|---|---|
| bool MatchFirst( | |
| TypeID rt, byte[ ] baFilter, int nCmpBytes, | // The parameters passed |
| | to the method |
| out int nRecordID, out string sError); | // The response from |
| | the method |

MatchFirst can be used to determine the record of type {gFluidDef}, that is TypeID=6 in FIG. 18, and which corresponds to the TypeID required. To determine the FluidDef record describing records of type GUID, that is TypeID=1 in FIG. 18, we seek to MatchFirst a record of TypeID 6 (FluidDef), with the first four bytes (Int32 reference), being those corresponding to the integer 1 (one), being the TypeID for {gUUID}. A comparison algorithm that can form the basis for MatchFirst is described later.

In the source data of the example, this is found at record 8, a record of TypeID 6 as required, with the sixteen databytes such that they represent the four Int32 numbers 1 (one), 7, −1 and 0 (zero). As explained in detail above, the first item indicates that the FluidDef describes the TypeID 1, as expected since it was sought specifically, using MatchFirst. The 7 is a further reference, this time to the scope of the FluidDef, which points to a record of Type 1 ({gUUID}) and reads {gScopePublic} indicating that this binary type ({gUUID}) should be regarded as having public scope, and so be transferred on request. The item −1 (minus one), indicates that the entirety of the record should be considered static, which is reasonable in that the GUID identifiers are critical to the preferred protocol, and as such should be referentially stable.

A non-negative value such as 12 (e.g. in record 9, describing triples), indicates that not all of the bytes are static. For triples, as noted, only 12 bytes are static, the last 4 being a dynamic field which can be switched as required to point to eg: {gFalse}, to switch the triple ‘on’ or ‘off’ (ignore).

A negative value other than −1 indicates either an error, a failure to comply with the design expression protocol as outlined here, or most usefully, a type intentionally not designed to be examined or transferred, or not capable of being so examined consistently, which then amounts to the same thing, as in none of these cases will any data be passed to the target under transfer.

The extension data type is one example of a type that contains legitimate data, but may not be a legitimate type for transfer, as its content will be read and transferred as part of a contiguous set of data, typed by the leading record (the non-extension record preceding a contiguous set of one or more extension records).

The last item 0 (zero) indicates that no bytes are reference bytes, which again is reasonable for {gUUID} values. A value of −1 would indicate that all bytes were references (Int32), and a non-zero value (which should be integrally divisible by the refsize of the gauge, for types designed to operate within that gauge), would indicate how many bytes were dedicated to references.

Notice that where multiple refsizes are operational, as may become common, such as binary types designed for 4-byte references (2 billion records max) and such designed for 8-byte references (9 billion billion records max) cannot be unambiguously interpreted by ref-byte-count alone, but require a refsize indicator, or policy to only accept binary types consistent with the store's refsize, which nevertheless again requires a refsize indicator.

In the initial embodiments outlined here, all such files are refsize Int32, so the weakness is minimal, but it has been resolved and eliminated entirely in a modified type description model and alternate fluid-def declaration (split model) described later in this document.

Thus by finding the FluidDef record, using MatchFirst, (MatchFirst(TypeID=rtFluidDef, FilterBytes=rtTypeSought, 4)), and then in step S64 reading the record and noting its constituent elements beyond the Type sought ref, [ScopeGuid, StaticBytes, RefBytes], the supervising application 60 is in a position to enact the transfer of the original record, if required.

In step S66, the scope corresponding to the TypeID is checked, and if the scope is not found to be public, so not available for transfer, then the transfer of that record terminates in step s68.

In this case, the far reference returned to the supervising application for such a record is zero, indicating that no such transfer occurred. Since it is possible that no transfer occurred because of an error, it is desirable that a distinction be made between returning zero as far ID for an error, and zero as far ID simply because such records are non-transferrable. In practice this can be achieved as known in the art by returning a method-success code from the function, and including the far ID as an ‘out’ variable; or by similar variation of method specification. Control subsequently flows to step s58, where the next record is accessed.

It will be appreciated that the scope identifier is a GUID and is therefore understood as indicating a Public scope by convention within the near store. Preferably, the reader or engine records commonly used GUID references such as scope in a local in-memory store, so that they can be used consistently within the stores or across different stores on transfer, and accessed quickly for enhanced performance.

If the two stores are both indexed stores, recordID's should by design therefore be atomic or primitive (a single, unique ID for a single, unique item of data), so that the inferential rule can be applied, viz: ID1=ID2 iff (if and only if) Data1=Data2 (including binary type).

In such stores, local memory caches can be reliably used to enhance performance for looking up commonly used identifiers and records.

### Transfer

Assuming the scope is public, and that the static and refbytes specifications are legitimate, (>=−1), and the actual data consistent with the definition, (at least enough bytes to match, for example, a non-negative static parameter or refbytes parameter), the transfer of this particular record can take place.

Otherwise, a far ID of zero is returned to the supervising application, and client, as appropriate, with any indicators that the embodiment may consider reasonable to describe the reason for a non-transferrable record. (An enumeration, common in the art, or error/success code, likewise common, may be provided and documented for the supervising application, and in automated ‘hubs’ or servers, such codes may be supplied to event logs, by design of the particular embodiment).

The supervising application now ‘knows’ in principle how to physically transfer the data from the FluidDef. What is subsequently required is a picture of whether that TypeID currently exists in the far store, and if it does, the corresponding recordID of that type, so that the TypeID reference of the transferred record can be allocated appropriately.

The far store is illustrated in FIG. 19. One should bear in mind that although corresponding types, GUID, Extn, Name, String etc are shown in the diagrams, corresponding types in the near and far stores will only be identical on the logical or data level, if the databytes of both records, serving as a declarations of that type, store the same GUID. Thus two binary type identifiers, both Guids, both documented as {gInt32} (ie: representing a 4-byte integer type on a nominal system) will nevertheless be treated as distinct types if their identifying Guids (the actual guids behind the ‘pseudocode’ {gInt32} notation here) are different. Using common or standard Guids may indeed be the case, where the type is a type in regular usage, such as may become common by adoption or by agreement in a standards body. Where different guids are in use, the automated transfer is still achieved, which is a primary design goal, and it becomes a matter for human observation as to whether to treat the two types as different in final practice in a client application. Formally, for the purposes of the protocol and by design, they remain so.

In this case, finding the appropriate TypeID for the record to be transferred, is simply a question of searching in step s70, the far data store for a record containing the appropriate GUID and returning the recordID of that record as the far TypeID of the record to be transferred. This can be achieved with the MatchFirst verb described above.

Given the far TypeID, the corresponding far store FluidDef (assuming one exists) can also be discovered in S72 and read in step S74 in same way as explained above. If no such previous far TypeID is available, then no FluidDef will have been defined, as it depends for one of its fields on such a reference, so that the far FluidDef may be immediately deemed to be null or unknown.

Preferably and as noted earlier, the near FluidDef and the far FluidDef are compared against one another for consistency in step S76, thus avoiding the risk and complexity of inconsistent stores, which may be in conflict with each other, or simply be inaccessible. Differences in the FluidDefs assigned to the same type but in different stores, would have a significant affect on the way the data is accessed and processed by the reading engine and thus constitute errors in usage by at least one and possibly both stores, by comparison with the intent of the original binary type designer.

If the two definitions are consistent, it does not mean that they are also consistent with that original designer's intent, but we can say that the two stores at least are treating such data consistently, and so can interchange the data without modifying its meaning or interpretation, according to such a FluidDef.

Thus, the system operates on the simpler, more reliable (in that it is independent of external sources) rule that consistency between stores, and clarity within stores, are both satisfied by the provision of a FluidDef in at least one such store (if the second has yet to begin using such data), and by the provision of consistent defs in each store, where both are already using such a binary type.

Finally, consistency here is defined as:
i) scope should tolerate transfer in each definition (if one device declares a type to be private, and the other device declares it as public, for example, then either a device is sending data it should not, or receiving data it does not wish to receive, so no such transfer should occur)
ii) static bytes must be consistent: in practice this means they must be identical, as to index off a different number of key bytes will give rise to a different set of resultant records stored, for the same set of records provided. Most obviously, where one store defines a type as static=−2, for example, and the other as −1, 0, or positive, then one store is declaring a type ‘invalid’ for transfer, while the other considers it ‘valid’. This is clearly inconsistent, similar to the scope argument above
iii) ref bytes must be consistent: there is a little more leeway in this definition, in that a refs record comprising two Int32 refs, for example, may be described as either refs=8 or refs=−1.
Inappropriate selection between the two may lead to inconsistent/invalid data storage, but it is not conversely and absolutely true that inconsistent declarations are themselves sufficient to cause inconsistent or inappropriate data storage.
Thus: declaring a ‘two refs’ type as refbytes=8 as above is entirely legitimate, provided only that the type never comprises more than two (Int32) references, else the trailing refs will be misinterpreted as values.
Likewise, declaring a ‘two refs’ type as refbytes=−1 is entirely legitimate, provided only that the type never comprises a hybrid (two refs+value), as may occur if a developer decides to ‘work around’ the definition for their own personal needs (and will then by implication even if legitimate be operating using the refbytes=8 definition for this type).
Thus, while the binary type is used as originally intended by the designer, then the choice of declaration between refbytes=8 and refbytes=−1 is immaterial. We would recommend in a preferred embodiment that fixed-length types used the explicit refbytes >=0 form.
Variable length types of course (unless otherwise constrained to within a fixed-length, in which they are effectively fixed-length types, as occurs with traditional rdbms database string implementations, for example), must be declared using the −1 form if there is no logical limit that the type cannot exceed.
It is also more effective to indicate a variable-length type as −1 than for example to supply a ‘maximum possible length’ as:
i) a different storage device may be capable of storing such data for such a binary type beyond such a length
ii) the storage device may take the maximum (which may be large, greater than 65 k, or greater than 2 billion bytes, if the designer chooses ‘obvious’ Int16.MaxValue or Int32.MaxValue lengths) and consider that a request to ‘reserve’ at least that number of bytes per record, whereas the protocol is explicit up to trailing zeros, and may need to store only a far smaller record, such as 6 bytes out of a 1000 byte buffer.

We have identified simple rules to encourage compliance by responsible users. The definitions are also simple enough to provide fast checking for clear and obvious inconsistencies. As such, we thereby provide a substrate onto which more advanced filters, adaptors, or processors can be layered, akin to the pipes-model, where such extra layers are deemed appropriate.

We can however provide a declaration protocol that is both simpler than the current FluidDef being described, and which also provides for the provision of both the refbytes (reference-part-length) and valuebytes (value-part-length) specifiers, so eliminating at least one possible source of error or confusion, being the implicit ‘value-part’ that is part of the current static-bytes+ref-bytes model.

This ‘Split’ model of FluidDef declaration is described later, and provides a simpler, more-concise, and more robust model for the vast majority of binary types and environments that we envisage supporting.

In the current model being described, the transfer process now compares the FluidDefs (at least one of course must be present for transfer) to evaluate a resolved FluidDef authorised or otherwise for transfer.

Thus in step S76, the supervising application compares the two retrieved FluidDefs for consistency. If they do not match, the transfer for that record terminates in step S68, and control moves back to the next record in step S58. The typeID for that record may be stored by the supervising application for further reference to obviate the need to repeat the process of looking up near and far FluidDefs for other records having the same type. Thus, if the TypeID had already been checked and been found to be un-transferable because of a difference in FluidDefs, then on discovering a record of that type in S60, control would flow directly to step s68.

As noted earlier, it is possible however that types not represented by the same GUIDs in the near and far store are in fact identical in practice, and have the FluidDefs that are the same in their constituent items. The type String in the near store may for example be identical in every way to the String type in the far store apart from the underlying GUID used in the declaration, and the record in which it is stored (used as the TypeID).

In these circumstances, it may be possible for the supervising application to disambiguate types in both stores by reference to an index of regular or conventional types in use in both stores. A look up table indicating key types, such as GUID, Int, Extn, Name, and String for example could therefore be maintained by reading engines, for later reference. This would not obviate the need for the FluidDef consistency check, but would allow different GUIDs representing the same type or even data concept to be associated with one another and possibly merged.

This however is deemed to be a human-need derived facility above and beyond the core automation layer provided by the protocol.

Once the Far Stores FluidDef has been verified transfer can take place. Reference should now be made to FIG. 23, which illustrates this process in more detail.

In step S100, the supervising application splits the naïve databytes of the record read earlier into a REF part, comprising an integral number of (Int32) REFs (else there is an error), and a remaining VAL part, of bytes that can be transferred without modification.

In step S102, a check is made to determine if there is a REF part to be transferred. If there is not, the record comprises only a value, and its data bytes can as such be inserted directly into the far store, providing the record TypeID is converted into a far TypeID, appropriate to the Type GUID. Thus, control flows to step S104, in which the far Type ID for the record is determined. This is already known from the steps above, and so can simply be retrieved from memory.

Transferring the new record into the far store, is then a matter of checking whether a corresponding record exists, and if it does not, writing the record to the far store. Of course, the checking step is optional, but it is preferred in order to avoid duplication.

The supervising application 60, can use the MatchInsert verb to handle atomic insertion of data into an indexed store as described above. In step S106, it seeks using a corresponding verb MatchFirst an existing record whose first [filter byte count] bytes match the first [filter byte count] bytes of the data to be added.

If, having queried far side store, a corresponding record is found to be present in step S108, the control flows to step S110, where the far store's ID for that record is returned. A new record is therefore not actually written in this case.

If in step S108, a corresponding record is not found in the far store, then a new record is created with the appropriate TypeID and data bytes in step S112, and the new far store ID is returned in step S110.

In either case, the supervising application stores the returned far store ID for subsequent use during the transfer process. If later records, in the near store, refer to the transferred near store record, either by reason of their local TypeID or by use of such record as an internal ref, they will on subsequent transfer to the far store require modification, replacing the current near-store-refs with the now-known far-store-refs to refer to the returned far store ID.

### Transfer of REFs

By definition REFs cannot be transferred by value, because although the ‘pointer’ values could be copied, they would then be meaningless, or worse, carry inappropriate meaning, in the far store.

References nevertheless are commonly used in the art, and a useful tool, so that we consider the provision of referential data support, which is also intrinsic to our declaration of Trinity Triples, for example, to be an integral requirement of the transfer protocol.

If the meaning of records that comprise references is to be copied over to a new data store therefore, it is desirable that, once copied, the references of the record point to the equivalent data in the new data, even though the record IDs of the records in each store are likely to be different. Thus, every operation must be reduced to transferring values, by a serialization protocol, in a manner similar to those already known in the art.

Furthermore, REFs may refer to records that containing VALUES or that contain other REFs. A simple REF record would be one such as a Trinity Triple, and where the REFS point only to VALUES, such as in the triple:

{gAndrew}.{gLives}.{gLondon}.

The transfer of a simple REF record, with refs pointing to values only, will be illustrated first; followed by a more complex example, with recursive references to non-value records. Thus, if in step S108, the FluidDef reveals that the record comprises one or more REFs, those REFs will need to be modified in order that after transfer the records effectively refer to the same records as before the transfer.

The algorithm for such a transfer will be similar in its core principle to any referential serialization protocol, but adapted to the particular needs of the protocol embodiment may be summarised as:

1. Convert the Databytes to a REF array (step S112)

2. Translate REF array to VALUE Array (step S114)

3. Introduce the VALUE Array to get a Far REF Array (Step S116)

4. Introduce the far TypeGuid

5. Introduce the far TypeID+FarRefArray

In the first and second steps, (steps S112 and Step S114) it is desirable that the gauge of the protocol is accurately understood. The preferred protocol works on an Int32 gauge, though the gauge could equally well be Int64, or other values. A singleton record of 16 data bytes (in the 4×20 gauge) comprises 4×Int32 refs, but only 2×Int64 refs, thus such clarity is crucial.

In the Split model of FluidDef declaration, the refsize is explicitly declared in each dependent type, so this potential source of ambiguity is eliminated. The static-bytes+ref-bytes+scope model being described here is a convenient and workable model for the common Int32 refsize gauge, but which is being superceded in our practical embodiments by the more concise and gauge and value-bytes explicit Split model.

For the time being however, the gauge is assumed to be Int32, and thus in the first step, the conversion between REFs and VALUEs occurs by simply reading as many Int32's as will fit with the currently-read record bytes, (4 in a 4×20 gauge file singleton record, as used for example in a Trinity Triple), and treating them as REFs. If the record continues with extension records, each such extension will offer a further 16 bytes of data, so there will always be an integral number of refs to read and translate into values in such a gauge.

In the step S114, the REF array is translated into to an array of basic integers, on the understanding that these integers represent references to RecordID's. This is akin to common practice in operating system, whereby integral types such as Int32, which are values, are used to represent pointers, handles, and the like in a referential manner. Having read the REF databytes, and converted them to an Int32 array, the REFs can be read to obtain a matching array of records (TypeGuid+DataBytes) which comprise the VALUES (by definition in this ‘simple’ case). This process is Illustrated in more detail below for a more complicated case.

Step S116, involves converting the record IDs of the near side VALUE array to the record IDs of the corresponding records in the far store. In the examples illustrated so far, records referring to other records have typically appeared further down the file or store. This logically reflects the order in which VALUE and REF records are usually created or added to a store or file. Thus, if the transfer of data was to begin at the first record and move through the store, we would expect that all of the records in the VALUE array would have already been transferred to the far store, allowing the near side VALUE array to be converted into a far side VALUE array simply by looking-up the record IDs of the records in the far store. These far side record IDs would have been returned in step S110 and be stored corresponding to the near side record IDs by the supervising application.

However, there is no requirement that REFs refer to earlier records, and it is therefore possible that when a REF record is encountered, it will not have already been resolved whether a corresponding VALUE record is present in the far store for each record in the VALUE array.

Where a convenient in-memory lookup table has been provided in the embodiment, the presence of a non-zero record ID or the presence of a ‘not-transferable’ flag or identifier (perhaps −1, an ‘out of protocol’ value) may provide a shortcut to knowing immediately whether a particular REF within the current record has already been stored, by prior need.

Such a short-term cache or memory-aid for enhanced performance is common in the art and will not be described here.

Where it has neither been stored already, nor failed to be stored (and flagged appropriately, the embodiment will need to attempt to transfer the record as for the first time.

Thus in step S116, each record in the near side VALUE array is introduced to the far store using MatchInsert for example to determine if it is present. If it is not present, it will be added and a far side ID returned. If it is already present, the existing far side ID is returned. By listing these IDs in turn, a Far REF Array is built up corresponding to the near, local or source REF array (as we may variously refer to it). The far or target REF Array (as we may refer to it), being a corresponding array of element size refsize (here Int32) is then converted into a byte array (sequentially writing the 4-bytes for each integer to a byte buffer), and in step S118 any VALUE part in the initial record is appended.

At this stage the REF record is almost ready for transfer. The only element that remains is to re-call in step S104 the far store Type ID for that record. Once that has been retrieved by the Supervising application, the adapted record can be written to the far store via MatchInsert as for steps S106 to S110 above. The transfer has now been completed.

It will be noted that MatchInsert refers to a particular method, which generalises indexed atomic storage of (possibly) new data, using a leading set of ‘key’ or ‘static’ bytes. Where the entire record is static, or where the key-byte count are explicitly known by prior declaration, the keywords Introduce or Primitive are commonly used to describe the same atomic storage method, with the provisos described.

Likewise, Recognise is commonly used in such systems, in lieu of MatchFirst, where the data is entirely static, or has explicitly declared static bytes as a requirement prior to storage.

There is no need, indeed it would be disingenuous, since it conflicts with the design intent of atomic storage, (primitive, single unique ID per unique data item) to ‘offer’ an AddNew method. If it is not yet present, MatchInsert, Introduce, or Primitive (according to the style/precise embodiment) will all add a new record if no such identical data already exists. If it does, the existing identifier will be returned.

The focus of the current application is as an enabling technology, so that the methods appropriate to transmission/recognition/addition are described. Methods and facilities for enhancements of the core facility to handle for example automated structured enquiry, (rather than here, automated structured storage), and other automated structured methods (such as provided currently by for example, RPC, Com, WebServices etc), are acknowledged and recognised as potential and valuable enhancements of the core protocols and engines, but not described in this particular application.

The particular example process for transferring records to a far store, via the preferred FluidDef model may be initiated by a Transfer(RecordID) command. The command proceeds as follows:
1. Read the Record (TypeID+DataBytes) corresponding to the ID passed as parameter;
2. Read the TypeGuid of the Record:
3. Get the FluidDef (Scope, StaticBytes, RefBytes)
4. Determine Scope [Ignore? Or Return 0 (ref null)]
5. Read RefBytes and split the DataBytes to REFPart+VALUEPart
6. If databytes comprise VALUEs only (no REFs), then Transfer the VALUE and return the Far ID;
   END
7. If databytes comprise a non-zero REFPart then:
8. Convert REFs to an array of local REFs for the current data store;
9. Create a same-length candidate for the far REFs array
10. Get the corresponding far REF for each non-zero REF by
   Transfer(SubRef)
   [recursive]
11. Insert far REFs into Candidate far REFsArray
12. Convert the far Sub REFs Array to a Byte Array
13. Append the VALUEPart to the far REFPart Byte Array
14. MatchInsert the Far Type Guid (equivalent to Transfer(TypeID))
15. MatchInsert the Far TypeID+Combined Far ByteArray

Error handling logic is omitted in this summary for brevity. Such would be required if the TypeID is zero or negative, or exceeds the file record limit, then there will be no TypeGuid and it will fail. Such error checking is well-established in the art and will not be described here.

The transfer example so far illustrates the transfer of records containing simple VALUES or simple REFs, that is REFs that refer only to further VALUE based records. REFs in a record could however refer to records containing other REFs, and the transfer in such a situation will now be described.

Considering an arbitrary binary type comprised of eg: a price and a date, as references to a price record, and to a date record respectively, a referential ‘price’ record might comprise references to three elements.

Such a binary type is not constructed in order to show how data should or must be stored, as the user is left free to design data types according to their needs. Nevertheless, this illustrates one possible and rational implementation of a binary type design process to store this data, consistent with the UDF and FluidData protocols, namely:

| | |
|---|---|
| {gString} ‘USD’ | [stored as Record 237] |
| {gFloat} ‘12.48’ | [stored as Record 248] |
| {gDate} ‘12/11/2007’ | [stored as Record 249] |

The referential price record might then be:
{gPriceRecord} 237 248 249 [stored as Record 312]

Indicating a price of USD 12.48 as of Dec. 11, 2007. Consider next a product, and a sale price concept as follows:

| | |
|---|---|
| {gShoes} | [stored as record 313] |
| {gSalePrice} | [stored as record 314] |

We might then express a triple as:
{gTriple}: {gNiceShoes}.{gSalePrice}.312

The colon after {gTriple} indicates in this exposition that {gTriple} is the intended TypeGuid or binary type for this data, while the dot notation is convenient to distinguish the elements of the triple, where here 312 is the reference to the price record noted above. The actual triple, in references, would be:

TypeID (3)+DataBytes (313, 314, 312).

A final zero (null) may follow to preserve the gauge (in our examples we use a 4×20, 20-byte per record gauge), and is commonly used to describe whether a Triple is to be ignored, by setting a ref to {gFalse}. Creating the near side REF array, enumerating the different records, gives a naïve interpretation as:

```
Record[
    {gTriple} +
        Records[3]{
            {gUuid} + {gNiceShoes},
            {gUuid} + {gSalePrice},
            {gPriceRecord} + ‘price record data’}
                    }];
```

However, the ‘price record data’ is itself referential, and it needs to be converted into portable values, so that part is another array, again of Records[3] size, being:

```
Records[3]{
    {gString} + “USD”,
    {gFloat} + 12.48,
    {gDate} + 12/11/2007}
```

This subsequently should be embedded in the near side value based record to give:

```
Record[
    {gTriple}
        + Records[3]{
            {gUuid} + {gNiceShoes},
            {gUuid} + {gSalePrice},
            {gPriceRecord} + Records[3]{
                {gString} + “USD”,
                {gFloat} + 12.48,
                {gDate} + 12/11/2007}
                    }}];
```

This ‘packed’ construct, which may be created in code and held in a memory object, is now a purely value-based hierarchy, and is therefore safe to transfer between processes and other processing boundaries (application, machine) to the far data store, in which the writing engine can reverse the process, unpack the value hierarchy and introduce the VALUE based records to identify the correct record IDs.

It is also possible, and typically simpler and faster, to avoid creating a complex value-hierarchy object, but rather to call Transfer on the sub-referenced item (here the price record) recursively, and such recursive calls are common in the art.

The transfer process may therefore be considered as comprising four different phases: the conceptual ‘how to transfer data’ procedural algorithm or protocol, which in a referential system must necessarily have an affinity for other referential serialization protocols known in the art, but which in its embodiment will target this particular protocol; the derived binary-type modelling and description paradigm, and its binary-type definitions (here a combination of TypeGuid+FluidDef) to enable such serialization in the target protocol; its expression into a generic but ‘real’ data expression of a {gTypeGUID}+DataBytes value hierarchy (the packing/unpacking example) for actual data, independent of the final actual store (and which may be simplified by anticipated reliance on a recursive TransferCall); and a final embodiment layer via a specific call to a particular device/engine (translating generic {gTypeGUID}+Data objects into protocol specific bytes and code), as here to finally store the data in the preferred protocol. This illustrates a basic example of packing and unpacking a referential record and finally storing it in one particular embodiment, targeting by design the intended Aurora UDF substrate and storage environment.

### Recursive Technique

The above technique prepares the near side array for transfer without reference to the far side store. As noted earlier, where the transfer process is intended to transfer between two stores both of which are simultaneously accessible by the transfer algorithm, a simpler and typically faster routine is possible which avoids complex value-hierarchies, and makes use of recursive method calls.

Even where the ‘far’ engine is apparently not accessible except via a low-level wire (such as an RPC call to a remote server, or a WebService call) or by a ‘non-executable’ message, such as a MessageQueue, or Email message, it is still possible to use the simplified model, again as is known in the art, using either a ‘message’ model (for disconnected, message-like protocols like Email, or in order to pack complex requests or data into simple byte packages for handling by then generic low-level methods); or via a proxy-stub model, again as known in the art and fundamental to RPC for example.

In the message model, the single source application acts as both source and target, by spawning a ‘message’ object and transferring the data into that object, using the algorithm noted here.

In the proxy-stub model, which is essentially a variant of the message model, the ‘proxy’ is not the source application, but a representation of the ‘far’ engine, which acts as the ‘simultaneously available’ target for the source application, and which then transmits the serialized data to the ‘stub’ which finally calls the far application ‘locally’, with the stub again treating the final far engine or store as its ‘target’ for its fluid-data serialization.

Messaging and proxy-stub/remote calls are well known in the art, and each such protocol describes its own serialization routines, most of which centres upon the means of describing the data, and the means of making calls (and generating or discovering access to such proxies and stubs).

The preferred file protocol therefore sits alongside such existing messaging/remote call protocols as email, web-services, rpc, soap; as well as the more recognised ‘static’ data protocols such as xml, rdbms, spreadsheets etc, which can be transmitted ‘blind’ but are not designed for automated merger into the target stores (despite what xml-enthusiasts may believe or claim—an IT engineer is always required to interpret the xml/configure the rdbms, at least for the first instance of every novel type of message).

For such simultaneously-present source-and-target scenarios, a recursive call variant of the transfer call is simpler and generally faster, omitting the need to specify specialised hierarchical-value-record containers. Both are essentially equivalent, and equally manageable and constructible by developers skilled in the art.

A modified algorithm in principle then to handle transfer by recursion would be, with respect to the latter part of the transfer routine:
[Only non-value operations continue past this point]

1. Interpret the source data as an array of references

2. Recursively call this transfer routine to get far references for these near refs

3. Create an equivalent far REF array

4. Store the far REF array with {gTypeGUID} as for the source record

The above is intended as a guide or overview of the transfer algorithm. No error-checking is indicated, nor do we discuss handling data other than referential or value based. Nevertheless, the procedure is the foundation of the type of final algorithm that is the working outcome of this embodiment.

This discussion indicates how data may be transferred from one store into another using the preferred FluidDef descriptor. Alternative embodiments may however rely on different mechanisms as will now briefly be explained.

### An Alternative Binary Type Fluid Definition: Split:

The FluidDef as described above does not specify the gauge refsize, nor does it specify the gauge value-bytes

Either of these omissions could cause ambiguity, if for example an 8-byte ref was read as two 4-byte refs or vice versa; and if a type was declared with 8-bytes as refs, and someone ‘worked around’ the definition and supplied three refs, the latter ref would be treated as a value.

Additionally, the FluidDef is dependent on the ‘right’ guid being present for scope. Additionally, the binary type structure cannot itself be hard coded, there is no indication of ‘endian’/OS sensitivity, and it is rather complex to manage

Thus, someone using a different guid for ‘public’ would break the chain. Likewise, being dependent on refs for scope, the strict nature of the binary type cannot be defined once, absolutely, by the designer. This latter goes slightly against the ‘universal’ goal of the model (which emphasises simple refs and values), but the goal of automating data at an ultra-low level makes this, we believe, a reasonable opportunity to automate 99% of the world's devices and data, and leave the truly esoteric to a more ‘general’ model.

Likewise, we decided that it was rather complex to manage the referencing, scope-checking, etc., for what ultimately should be a very simple decision: go/no-go (transfer) and static-bytes+ref-bytes+value-bytes; with at least a ref-size indicator (and preferably endian-indicator) as a bonus.

On reflection therefore, we decided to address these needs and fold the FluidDef and enhanced requirements into a 4-byte basic package, with byte(s) modifier(s) for the enhanced data so that it can be quickly, easily, and reliably interpreted; and capable of being defined by an engineer immediately, without further concern as to the Guid for public being changed etc.

Split Def—Bytes from Int32

The premise for a split is a self-acronymic binary type descriptor, being Static-bytes, Prior-refs, Li-teral Value, Trailing-Refs. We have earlier indicated the possibility of designing data to fit a leading-refs, trailing-value package, whereby in a hybrid (mixed refs/value) binary type, the indexing, for static bytes >0, will be via at least some part of the refs part.

If the user had in mind indexing by a value part within the hybrid, in a small-gauge, standard file, it is a simple matter to create a reference to the static value, and use that reference in the leading part of the binary type.

In a broad-gauge file however, such as for storing bulk image data, each record may comprise perhaps 1000 bytes or more, so that using a record of 1000 bytes to store for example a 16-byte guid reference would be wasteful, so that it may be preferred to embody the key value directly in the leading index (static-bytes) part.

If hybrid (mixed refs+values) are intended to be stored in such an environment, it then becomes possible that the preferred design of binary type for efficient storage is with a leading value and trailing refs.

Rather than implementing some hard-coded switch as to the orientation of the refs+value, vs value+refs, which it would be easy to omit or mis-specify, we have preferred to suggest a single definition format that encompasses both, being the RVR model, or Refs-Value-Refs, whereby a typical Refs+Value binary type can be expressed with the trailing R set to zero, and a Value+Refs binary type can be expressed with the leading R set to zero.

While not encouraged, a full (both R specified (non-zero) and V also non-zero) will of course be handled.

The full split definition then comprises the Static-byte count, (Prior) Ref byte count, (Literal) Value byte count, and finally the (Trailing) Ref byte count.

### Byte Restricted Specifiers

Clearly a random sequence of ref-element and value-elements will not naturally comply with the RVR model except by chance. However, binary types are designed by humans for the purpose of accurately encoding and decoding structured data into raw binary data and vice versa.

It is reasonable therefore to expect that a user (designer) wishing to take advantage of the fluid mechanism may choose to design such types in compliance with the model.

Since such design is deemed reasonable, it is further observed that the principle concern in designing such a type is that it accurately stores and locates binary data based on a leading key, whose extent is specified by static bytes.

We can observe that it is considered a reasonable goal to use 16-byte identifiers (guids) for such keys, since that enables a one in 256-billion-billion-billion-billion chance of random re-use of such keys.

That being the case, we can further observe that if 16-bytes provides such an assurance as a key, then if any reasonably skilled designer may certainly design their type to that level of tolerance, it certainly follows that allowing 127 bytes for such a key goes far beyond the needs of uniqueness.

As such it is a reasonable decision to provide a model that supports the specification of up to 127 bytes (which is the maximum value of a signed byte), and to support one further value as a legitimate descriptor, being that of ‘entire’, to indicate that all bytes beyond the current position are as specified.

In a signed-byte model, we use the value −1 to signify such, equivalent to 255 in a (typical) unsigned byte model. Thus we have a model that is safe for both signed and unsigned interpretation, with 0-127 being common to both, the special case of −1 (signed)/255 (unsigned), and all other values (−2 to −128, signed or 128 to 254 unsigned) being deemed invalid for type description, such that any definition using such descriptors will not be transferable.

Thus we can both increase the scope of the description to a static+rvr model and yet reduce its description to a simple 4-byte value, each specifying one of the elements as noted above, for static-bytes, prior-ref byte count, literal-value byte-count and trailing ref byte count.

The common usage of ints (Int32) in modern processors may mean that we prefer to write code using the signed model, but nevertheless the ranges should be restricted as noted above, so that the elements may be unambiguously translated to byte components within the 4-byte descriptor.

The static bytes can likewise be described by a single byte on the basis that if 16-bytes is sufficient for a globally unique key, then 127 bytes is certainly so. In practice we recommend that all static types have their static-bytes count set to −1 (255, unsigned), so that only dynamic (partial key) types have a static-byte count of zero or greater.

This eliminates the confusion as to whether to specify for example static bytes −1 or static bytes 4 for an Int32. For a simple Int32 value, we recommend −1. For fixed length types (RVR all comprising counts >=0), the actual size of the type is fully described in the RVR, so no information is lost.

Within the RVR component, where types are designed as having fixed-length elements within the 0-127 byte count range, it is recommended that the fixed-length specifier (0-127) is used rather than entire.

In this way, we may broadly ‘normalise’ type descriptors, and reduce the management required for tolerance of alternate descriptions.

Notice that while a ‘string’ binary type may happen to have, say, 6 bytes for eg: ‘London’, that we do not anticipate attempting to declare ‘strings’ as having a ‘fixed length’ of 6 bytes, when they are by design intended to be of variable length. This distinction is clearly understood, we believe, in the art.

Finally we also prefer and recommend that a refs-only declaration be made in the first (prior) refs component rather than the later (trailing) refs component, and may reasonably expect to normalize late declarations (x.0.0.y) to normal declarations (x.y.0.0) for consistency.

### Typical Descriptors

Thus, using signed integers in the text for clarity, in the range −1 to 127 for valid descriptors, here are some typical Split descriptors:

−1.−1.0.0:

Static (entire), Refs (entire)

The equivalent interpreted as unsigned would be:

255.255.0.0

The actual bytes stored are identical, by design. Further examples are shown only with the −1 (signed) usage for ‘entire’.

−1.0.−1.0:

Static (entire) Value (entire) [no prior refs, no trailing refs]

4.8.−1.0:

4-bytes key, 8-bytes ref (2×Int32 for example), (entire, remaining) is value

8.8.12.0:

8-bytes key, 8-bytes ref (2×Int32 or 1×Int64 say) 12-bytes value

−1.0.16.−1:

Static (entire), 16-byte value followed by (entire remaining) refs

4.8.16.32:

4-bytes key, 8-bytes ref, 16-bytes literal value, 32 bytes trailing refs

Notice that while the model allows the latter to be processed accurately, we would seriously question whether such a design is the most concise and appropriate. Nevertheless, it is a legitimate definition and could be processed accordingly.

### Valid Descriptors

It should be apparent that not every combination of randomly assigned splits from otherwise valid components (−1 to 127) nevertheless describes a legitimate split. Most obviously, for example, if the leading R is −1 (entire), then a subsequent value other than zero for V is inappropriate, since we have already declared that the ‘entire’ record comprises refs.

Further, where the gauge is known or 4-byte refs are intended, for example, a leading ref bytes of 3 or any other value >0 and non-integral to 4 would be inappropriate, as would a static byte count and leading ref byte count combination that implied a ref key of non-integral length, such as a static byte count of 3 with a leading ref byte count of 4.

These are arithmetic checks however that can be readily performed and encoded by a skilled developer. We will nevertheless summarise the particular combinations of RVR that we consider appropriate and inappropriate for legitimate transferable binary types.

It will be noted that a type being inappropriately described for transfer does not make it an inappropriate type. Extension, for example, derives its nature from the leading record, but therefore has no single legitimate descriptor itself. Its split can either be omitted, or set to a generic unspecified (Split.Empty) or otherwise invalid split, since a transfer of an extension record on its own without its leading record would in any case be inappropriate.

### Split.Empty

The ‘Empty’ split is defined as 0.0.0.0, and is deemed an ‘absent’ definition.

As a literal definition, for a given type, it would declare by definition a record keyed by zero bytes, so that any record of that type would match the definition, but further with neither ref nor value byte components, for an entire fixed length of zero. Ie: the data section would be entirely blank, in the protocol, being a record comprising solely of zeros.

Thus, attempting to store any data within such a type would be deemed inappropriate, by split semantics (since only blank is legitimate), and the type would be stored as and comprise a single blank record only, in any given file.

While there may be some arcane reason to wish to do so, it is clearly far more likely that the split has not been initialised, and so the recommendation is that the split is treated as absent.

### Split Validation

As noted earlier, validating the split static byte count comprises ensuring that it is within the range −1 to 127, and is consistent with the subsequent definition, in particular that a count >0 is consistent with both the declared length of the type (thus a static bytes of 20 on a type declared as: 20.4.4.4 would be deemed poor at best, since there are at most 12 legitimate bytes to act as the key, not 20 as declared), and is consistent with the ref-gauge where it is known, deemed or otherwise declared (as noted earlier).

[We will describe gauge declaration later in the enhanced descriptor section]

Within the RVR section, we can break down the possible combination to that of {−1, 0, n (1−127)} for each of the R.V.R (P.Li.T) elements.

There are therefore 27 such possible combinations, whose potential validity can be summarised as follows. ‘x’ indicates a wild-card (any of −1, 0, n) to cover a range of possible definitions not otherwise explicitly described. ‘m’ is used where a distinction from the first n is required.
[0 lead]
0.0.0: Empty—as noted above.
0.0.−1: Late declaration—normalize to −1.0.0
0.0.n: Late declaration—normalize to n.0.0
0.n.0: Fixed length value part
0.n.−1: Fixed length value+variable or large (>127) bytes trailing refs part
0.n.n: Fixed length value+fixed length trailing refs part
0.−1.0: Entire value (variable length or >127 bytes)
0.−1.−1: INVALID—anything other than zero after entire is invalid
0.−1.n: INVALID —anything other than zero after entire is invalid
[−1 lead]
−1.0.0: Entire refs
−1.x.x: INVALID —anything other than zero after entire is invalid
[n lead]
n.0.0: Fixed length ref bytes
n.0.−1: Fixed ref bytes+entire ref bytes—normalize to −1.0.0
n.0.m: Fixed ref bytes+trailing ref bytes—normalize to (n+m).0.0
n.n.0: Fixed refs, fixed value, zeros in trail
n.n.−1: Fixed refs, fixed value, remaining refs (variable or length >127)
n.n.n: Fixed refs, fixed value, fixed trailing refs
n.−1.0: Leading refs+remaining value (variable or length >127)
n.−1.−1: INVALID—anything other than zero after entire is invalid
n.−1.n: INVALID—anything other than zero after entire is invalid

It will be noted that one of the rules is to ensure that specifiers after −1 are zero only, since to declare something as ‘entire(ly)’ ‘x’ and yet followed by ‘y’ is at best redundant, since it is already entirely x, and at worst ambiguous or an error.

Other than that, a number of combinations with late declarations of trailing refs may be normalized to an early declaration form, where there is no intervening value-bytes declaration, but we would consider it poor form and a possible cause of ambiguity, or a possible indicator of a missing value-bytes declaration, or a poor and perhaps inaccurate understanding of the Split model if the simple normalized form (leading refs declared in preference to trailing refs) was not adhered to.

### PRACTICAL EXAMPLES

It has taken considerably longer to describe splits than it does to apply them in practice, so we will declare splits for some common or familiar types to demonstrate their practical application.

Int32 (4-byte, static signed integer)

Split: −1.0.4.0 [(entire) static, no refs, 4 value bytes]

String (variable length, static value)

Split: −1.0.−1.0 [(entire) static, no refs, entire (variable length) string]

Triple (3×refs key+ref (open ID), commonly used as ‘false’ or ‘ignore’)

Split: 12.16.0.0 [static 12 bytes (3×Int32 refs) key on a 16 byte refs record]

Note: an alternate definition of:

Split: 12.−1.0.0 [static 12 bytes key, entire refs]

This split would be equally legitimate, if the potential for refs beyond the key refs was intentionally open. If the intent is to have a single Open ID by design, then the former 12.16.0.0 is more appropriate.

Either declaration will result in data consistent with that split being transferred automatically, though attempting to supply refs beyond a single OpenID will lead to those refs being ignored in the first split definition, or otherwise raising an error during transfer, since only 16 bytes (room for one OpenID) were declared in the stricter, fixed length form.

### SplitA: Basic Splits

We refer to the basic split as defined above as SplitA, the basic split which defines the essential structure required for the transfer algorithm to be effective. As will be noted, by the descriptions already provided, once the distinction between ref parts and value parts is known, the algorithm may be applied, and data transferred.

The Split definition allows for a trailing refs-part in addition to the leading refs-part presumed in the earlier FluidDef model, whose treatment, conversion to a far-refs array, and embodiment as a final simple byte array follow as for the leading refs part, and is a sufficiently straightforward modification and addition to the algorithm that it is not further described here.

The specification of the split as four byte indicators, which can be conveniently stored as an Int32 composite, is compact and includes the trailing refs indicator, and is restricted by design to valid component elements (bytes) in the ranges −1 to 127 (signed) or 0 to 127+255 (unsigned), rather than the larger Int32 indicators used in FluidDefs, but in practice this restriction on the size of the indicators is not a meaningful restriction on binary type design, and is considerably more compact and practical for our purposes of supporting readily described binary types for transfer purposes.

Thus Splits (SplitA as noted here) provide a way of classifying and describing binary types in a compact and efficient manner for binary transfer, whose transfer can then be enacted via the algorithms noted earlier, modestly modified to allow for the additional trailing refs segment, which can be readily treated as per the leading refs segment, and so is not further described here.

### SplitB: Transfer Byte

While the SplitA provides a robust structural descriptor of a type for transfer purposes, it omits by design the qualitative descriptors that may reassure, modify, or affect a final decision as to transfer.

We have already alluded to a scope descriptor, so that we should like at least to be able to confirm a type as ‘public’ (intended for transfer, sharing), or to restrict it as ‘private’ (not intended for sharing, such as index types, which are internal to the file structure).

We therefore anticipate being able to declare a type's scope at least as Unknown, Public, or Private.

The current split (or fluid def) models further specify ref-byte counts, but in order to accurately convert them to references, two further items are required: the refsize (bytes per ref), which is typically 4, but could in due course be 8 bytes in super-large stores or extended cluster models.

Note that the Int32 refsize and Int64 refsize do NOT correspond to 32-bit and 64-bit operating systems, though there is an affinity. An Int32 does not cease to be an Int32 on a 64-bit operating system, and a binary type designed with Int32 refs must still be interpreted as an Int32, even if it is manipulated on a 64-bit operating system, or stored in an 8-byte gauge (8×n) file.

Likewise, 8-byte (or other gauge refs: 2-byte being the most obvious possible contender, for super-small devices) binary types should in principle be capable of being stored in 4-byte gauge stores, and properly handled.

In practice, typical engines may simply filter or choose not to handle binary types with refsize other than their own, for practicality, and we anticipate that the 4-byte refsize (which supports stores up to 40-gigabytes in fine-grain, 4×20 mode, or up to terabyte storage in 4×n mode) will be more than sufficient for most common applications.

Nevertheless, the assurance should be present that the gauge is indeed for 4-byte reference, if at all possible.

Likewise, while 90% (our estimate) of the worlds servers and pc's use Intel/DOS-endian byte-ordering (including both Linux and Windows, the world's two most popular or prevalent operating systems), it is still possible that a binary type may be designed for use with refs but for non-Intel compliant byte ordering, and we would therefore further like the assurance that the binary type (in particular as regards refs) uses Intel byte-ordering.

These distinctions: refsize (akin to 32-bit vs 64-bit, but applying to the internal, Aurora OS/Fluid Data management), public/private accessors, and byte-endian issues, are all familiar in the art, so their relevance here, applied to our particular needs, should not seem unreasonable to the skilled developer.

We can further note that:
without the declaration that data is public (or private) we CAN transfer data, but do not know if we SHOULD transfer data. Indices are simply not intended for transfer, but for internal private optimisation and structuring.
Without the declaration as to refsize and to endian (byte ordering) we know the number of bytes allocated to a ref segment, but not how to split that segment into individual refs, consistent with the binary type designer's original intent.

Therefore it is clear that these three indicators (scope, refsize, and endian) are highly desirable, indeed mandatory for accurate and appropriate transfer of data.

We will shortly disclose a simple, single-byte, 8-bit flag indicator to describe the above, of which for the above we will need in practice only 6 bits, or at most 7 bits.

If we can in fact constrain our usage to 6-bits, then we can further describe a binary type with respect to two further convenient attributes.

Bulk data (images) is entirely legitimate as binary data, yet by their nature, images and video are huge in relation to the fine-grained gauge for common relational data storage. It is therefore convenient to store these in a companion store, which could be of an entirely proprietary design, but for which in fact a simple broader gauge 4×n file is perfectly appropriate, thus maintaining consistency and readability of both primary and companion stores by a single common protocol.

We may choose to index the companion data by storing references in the primary store, which requires both an ‘external reference’ type, and a consistent synchronisation between both stores, lest a reference in the primary store no longer be appropriate in perhaps a restored companion store.

A more appropriate solution is in fact to provide an internally indexed companion store, based on a broad gauge 4×n, typically 4×1024 for example, which then operates both as an independent Aurora (indexed) store in its own right, and as a companion to the primary store as appropriate.

Transfer and storage algorithms would then operate with the companion store as they do for the primary store, both for external communication and as appropriate, for local communication between the primary and the companion.

The significance here is that by indicating a storage type as ‘bulk’ or ‘archive’, we can indicate that a binary type should by preference be stored in a bulk or archive store, rather than taking up significant resources in a fine-grained, primary store.

The provision of the flag in fact allows the pair to operate seamlessly as a single, coherent store, but that is beyond the scope of this application. It is sufficient here to note that such a flag is desirable.

It is also desirable to note that some data and binary types are ‘localised’ and do not transfer well across machines. A local filename for example may be practical on one machine, but there may be no corresponding resource on a second machine.

A ‘restricted’ flag (resources restricted to a local machine) allows us to filter binary types that should not automatically be presumed to exist on other machines.

These are advanced flags, but with a practical application. In combination, for example, a resource indicated by a restricted resource binary type may not naturally be transferable, but a resource that is archived in a companion, such as an image file, whose content has been archive, can nevertheless be transferred.

This is a common need in eg: web applications and document archives, so that if we can declare it in the common binary type descriptor, we will take the opportunity to do so.

### Transfer Byte

The final descriptor that we envisage for the first level of enhancement beyond a SplitA is therefore a SplitB, comprising a SplitA (basic Split) describing the essential structure of the type, enhanced with a Transfer Byte, which is a self-acronymic 8-bit flag array, as follows:

### Transfer:

T: ransferable
R: etain
A: rchive
N: umeric (iNtel)
S: witched (Sparc)
F: our (byte refs)
E: eight (byte refs)
R: eserved (restricted, resource)

We can then break this down pairwise to 4 two-bit enumerations based on the underlying flags as follows:

### 1) Scope: Transferable+Retain

Public: Transferable

Private: Retain

Protected: Transferable+Retain

Unknown: Neither

### 2) Endian: Numeric+Switched

Agnostic: Neither (eg: strings, operate on all systems)

Numeric: Numeric, Intel byte ordering, for correct interpretation

Reversed: Switched, reversed byte ordering, for correct interpretation

Sublime: Numeric+Switched: Byte ordering other than simple reversed

### 3) Gauge: Four+Eight

Unknown/Agnostic: Neither—(gauge not specified, hopefully not required)

Four-byte refs: Four—four byte refs

Eight-byte refs: Eight—eight byte refs

Other: Four+Eight—gauge other than four or eight byte refs

### 4) Location: Archive+Restricted

Normal: Neither—normal data, store in primary, transfer as required

Archive: Archive set—data resides in the companion store

Restricted: Resource set—data may not be appropriate to transfer off device

Archive Resource Archive+Resource: data available via archive if required

Of these four indicators (Scope, Endian, Gauge, Location), three are clearly critical if a possibly ambiguous interpretation (endian, gauge) or redundant transfer (scope) are to be avoided; so are clearly highly pertinent to the ability to transfer data automatically, both locally and across (possibly inconsistent, for gauge and endian) devices.

The latter indicator, for location, handles two similar issues arising from the common use and desired access to bulky resources. The presence of a resource on one device is no assurance of such a resource on a second device, and the location indicator provides a means of alerting as to binary types that contain references to such device-dependent resources, and which references should therefore not necessarily be transferred automatically between devices, while also acknowledging the presence and potential for companion stores, to centralise and archive such resources, so that they can in fact be transferred at least between archives, and so accessed and distributed as appropriate.

Thus the location indicator useful for enabling and restricting transfer of bulk data, and automatically segregating it from fine-grained, normal data, just as the first three are concerned with those issues for the normal fine-grained data.

As such we consider that the latter indicator (and corresponding two bit flags, for archive and resource (reserved, restricted, as you will) are appropriate and practical for inclusion in this common and first enhancement of the basic SplitA.

The corresponding split description is then known as a SplitB, comprising a SplitA and a Transfer Byte, typically stored as a 5-byte composite, though they may be stored and referred to separately as desired, and/or the Transfer Byte may be considered to be the leading byte in a second 4-byte integer, with the remaining three bytes reserved for future use. Either is appropriate.

We have implemented and recommend a single declaration type, comprising a reference to the TypeID for whom the SplitB descriptor is intended, followed by a four byte SplitA Int32 composite descriptor, and a one-byte TransferByte.

In principle, this binary type, if stored as such, comprises a record with SplitA thus:

4.4.5.0 [ie: 4 key bytes (the TypeID), 4 ref bytes (the TypeID) followed by 5 value (literal) bytes, being the SplitA followed by the TransferByte.

In practice, we elect to declare it as an 8 byte value part, for the reasons noted above, with three bytes reserved for future use.

4.4.8.0

The TransferByte for the core SplitB definition record is derived as:

T: ransferable: we clearly want to transfer (share) definitions, so true (1)

R: etain: no, we want it to be public (shareable): so false, (0)

A: rchive: no, normal data (0)

N: umeric: yes, we use refs, which are numeric, Int32, so true (1)

S: witched: no, the type is designed for Intel byte order, so false (0)

F: our: yes, the type uses four-byte refs (1)

E: eight: no, the type uses four-byte refs (0)

R: esource: no, the type is normal data (0)

Thus the composite value for that in a left-to-right bit-order as occurs in Intel endian systems is:

1+8+32=41

The same result can be expressed in four steps as:

Scope: Public (1)

Endian: Numeric (8)

Gauge: Four-byte (32)

Location: Normal (0)

For a given application or system, based on a given platform, with consistent refsize across an application and its designed types, a given type either has refs (in which case it is by definition numeric) or not, in which case it is either numeric or agnostic, so that a common shorthand abbreviated description of binary types in a given development/binary type design environment, can be reduced to:

Scope.Usage.Location:

Where Usage is a shorthand enumeration {Agnostic.Numeric.Refs} equivalent to the Endian/Gauge pairs:

Agnostic=Endian.Agnostic+Gauge Unknown (no refs involved)

Numeric=Endian.Numeric+Gauge Unknown (no refs involved)

Refs=Endian.Numeric+Gauge.[per system, typically Gauge.Four]

Thus, except for specialist type design for achive/resource management, most common type descriptors will be for Location.Normal (ordinary data, held in the primary store), and so simply depend on the two key indicators, Scope and Usage, viz:

Int32: Scope.Public+Usage.Numeric

Triple: Scope.Public+Usage.Refs

String: Scope.Public+Usage.Agnostic

While the binary type designer should be cognisant of the issues and considerations described as to Endian, Gauge, Location, in fact therefore we can provide an environment with automatically shareable data, for the bulk of common types, provided only that the user (designer) is willing to provide a SplitA as noted above, and in most cases, a simple combination of Scope+Usage to express common transfer scenarios and associated TransferByte(s); and where that is insufficient, based as it is on common defaults, a fully expressed Scope+Endian+Gauge+Location will define those TransferByte(s) that are not readily expressed in the shorthand.

When one considers that for the provision of five bytes, we have given the binary type designer (and data application designer) therefore the ability to share data automatically, based on a common algorithm, and with provision for complex structural types, references, and hybrids, as well as handling or indicating types that should or should not be shared, as well as sensitivities to operating system byte-ordering, and Aurora gauge, as well as the provision for preferences as bulk data storage, and restricted transfer for device dependent resources, that I believe that we have handled a lot of common and fundamental issues in a manner that is simple, robust and effective.

Simply put, the world today seeks to make data transferable after it has stored it in inflexible databases and proprietary applications. We have sought to ensure that the data is stored in a manner that is automatically transferable, by choice and design, before the first byte or data item is even contributed.

By supporting fluid transfer at the very first stage of binary type design, we hope to ensure that all subsequent operations and applications will have the facilities and availability of fluid transfer designed in from the outset, rather than left until after a complex store has been left solid and unmovable, replete with data, but isolated and incapable of being shared or absorbed.

### An Alternative Binary Type Fluid Definition:

Prior to evolving the FluidDef and Split models, which progressively covered more complex situations, to the point that we believe the Split model to be a sufficient model to support complex, hybrid, dynamic indexed data, we considered a much simpler type designator, being a TypeNature indicator.

This indicator is referred to as TypeNature, and is an enumeration, or well-defined set of possible integer values, which enjoy one of four values: Unknown, Value, Reference, and Ignore.

If the system does not know whether a binary type is a VALUE or a REF it cannot be reliably packed and so cannot be transferred. Likewise, if a particular type is to be ignored, it does not matter (for transfer purposes) whether it is a VALUE or a REF, as it will not be packed in either case.

In this example embodiment, the 3-state+null indicator, TypeNature flag, and the ‘concept’ of TypeNature can all be indicated by five indicators. These are preferably GUIDs as described above, and may be referred to as:

{gTypeNature}
{gTypeNatureValue}
{gTypeNatureRef}
{gTypeNatureIgnore}
{gTypeNatureUnknown}

The choice of how to declare one (and only one) of these values per binary type can be left to the final operating environment, but where the embodiment is implemented in the preferred file storage protocol there are two natural means of doing so:

1) to declare a custom record of type {gTypeNature}

2) to assign a {gTypeNatureIndicator} to a {gTypeGuid} as a triple

To create a custom binary type, we define the record elements as:

TypeGuid = {gTypeNature}
DataBytes = Refs[(ref)TypeID of the subject type, (ref)TypeNature)

Where TypeNature is a ref to one of: (gTypeNature)REF, VALUE, or IGNORE

Note that to avoid mixed VALUE/REF declarations, the DataBytes is a constructed as a pure-REF record, comprising two REFs, the first indicating the binary type to be described, and the second indicating the appropriate TypeNature transfer mode to employ (VALUE, REF, IGNORE). The final record would then look like:

TypeID({gTypeNature})+DataBytes([gSubjectType].[gTypeNatureIndicator])

Where [gTypeNatureIndicator] is one of:

[gTypeNatureRef]
[gTypeNatureValue]
[gTypeNatureIgnore]
[gTypeNatureUnknown]
or zero.

The latter two (gTypeNatureUnknown or zero) are unusual and redundant as any TypeID for which a form (ref, value, ignore) TypeNature is not declared will automatically receive a TypeNature enumeration of TypeNatureUnkown. A Scope indicator could also be included in this simple model as desired, in the same way as for TypeNature.

For reasons of ease of indexing, and stability of data, it is strongly desirable that data entities in such an environment based on this simple, essential verb Primitive( ) or Introduce( ) be static, so that if an entity declares for example a name ‘Andrew’, and returns an ID 27, that they do not subsequently find that another entity has re-written that entity as ‘David’, so that all entities previously named ‘Andrew’ now find themselves named ‘David’.

The process of transferring the data would then proceed similarly to that illustrated above for a FluidDef transfer, only the complexity of the algorithms would be reduced. Types would be either Value or Ref and not Ref+Value, and the static-bytes parameter would not be present. In practice however, the set of data types handled by TypeNature are simply a subset of the broader range which the latest SplitB model makes possible, and an algorithm supporting the latter would adequately handle TypeNature, using a default static bytes of −1 (entire), and an RVR of entire REFS or entire VALUE as appropriate.

Arguably, the lack of mention of static-bytes does not prevent creating ‘special’ case types, which ‘trap’ for eg: Triples, to implement 3-d indexing, and dynamic (keyed) matching (as we originally did, before refining the model to the MatchInsert model, which eliminates at least one of those constraints, by intrinsic support for dynamic data, and which still necessarily traps Triples to ensure 3-D indexing support).

In providing for a clear, simple and well defined file substrate, namely the file gauge/structure, and a clear, simple and well-defined binary type descriptor (latterly, Splits, but in more limited form, FluidDefs and TypeNature), we provide a clear and well defined mechanism for automated data transfer and merge independent of any human intervention, once the binary type designators (Split) have been provided.

Consider how much time and effort is spent writing ‘special adaptors’ so that a very limited set of applications can import/export/convert a very limited set of ‘other’ applications (typically to encourage marketing use, drawing users away from ‘other’ applications and manufacturers). This embodiment would not only make those special adaptors redundant, but would extend such ‘convertibility’ to all compliant data files.

Additionally, the universal nature of the protocol means ‘all’ files for ‘all’ applications, had they chosen this protocol as their base storage mechanism.

Had such a protocol been invented, it would be possible to merge spreadsheet data seamlessly into organisers, blending them with accounting packages, and graphics, presentations, all at the touch of a button. Indeed the distinction between a ‘spreadsheet’ and a ‘personal organiser’ or an ‘accounting package’ would disappear, at the file level, since the underlying files were similarly structured according to the protocol, and would only be the choice of viewer, which might be optimised for spreadsheet-like operation, in which distinctions would arise.

### Transferring Onwards

In the example above, one transfer has been described. What of ongoing transfers: not repeated transfers of the same or similar data now that they've been manually engineered, but leapfrogging automated propagation of data. The data carries its own definition as to how to transfer it, in the Fluid designator records (latterly, SplitB), and since those records are themselves declared as scope ‘public’, they too will be transferred in any transfer, so that the recipient automatically becomes capable of passing them on as appropriate to any further enquirer, or simply because that is what the device does: passes data along to an ever escalating, ever growing repository of global knowledge.

That ultimately is both the rationale for the Fluid Data protocol, and completes the description of the protocol, and its transfer methodologies in a manner sufficient to allow a skilled developer to explore and replicate this functionality.

Given the fundamental capabilities this protocol (especially in conjunction with the preferred file format, which supports spontaneous contribution) enables, provides a clear and innovative step beyond manually intensive and expensive engineering of data transfer feeds and messages between devices.

### Atomic Data

Having described the structure of the preferred data storage protocol, we shall now explain its use within a data storage and retrieval engine providing atomic data storage. At the heart of the atomic model is the issue of indexing, which as is known in the art, refers to the means by which a series or set of items may be ordered, so as to speed matching and searching operations.

The term ‘atomic’ is frequently used in the art in relation to a specific technique of data storage and indexing, and an application or operating system may for example be said to store strings ‘atomically’, or may even refer to data ‘atoms’. What is meant is that if a user attempts to store or refer twice to the same data instance, a string for example, then only a single instance will in fact be stored, and a common reference will in fact be returned to the user in both instances.

Atomic models have several advantages, principally that storage requirements are reduced (since a particular data item is stored only once), and that in a referential system such as described herein, an enquiry or match operation can be performed by reference to the string or data item, rather than by value only. That is then sufficient to determine the presence or absence of matches for that item by the presence or absence of references to that item.

Formally, a reference is intrinsically a one-directional indicator indicating a data item. In a given stream, if multiple instances of a data item are stored, then multiple references for a single data item may exist. In an atomic store, the reference becomes bi-directional, and unique, in that if a reference to a data item exists, then it will be the only such reference to such an item.

The principle of such atomic models are known, and applied occasionally and in a limited fashion, such as when an operating system stores resource strings ‘atomically’. However, in the preferred example described herein, an atomic model is applied as a general facility, throughout the store, and so used to enhance the general and novel protocol for the spontaneous storage of structured and casual binary data described above. Furthermore, the preferred atomic model is:

i) provided as an index with global scope (ie: there is a single such index across all data within the store, across all binary types);

ii) is embedded intrinsically within the store as protocol-compliant binary data; and

iii) supports a well-defined set of operations which are minimal in specification, but sufficient to enable all the operations that might be expected of alternative naïve (OS) and structured (rdbms) storage protocols.

The second of these is of particular note, as indices are typically considered ‘separate’ from the data they index. An examination of an RDBMS for example will not typically show ‘obvious’ index tables in addition to the core ‘data’ tables. It is however a requirement of the present protocol that an entire file may be read consistently with a single core algorithm, in a manner that enables diagnostic, client, and transfer applications to operate without concern for the particulars of any ‘proprietary’ (arbitrarily designed) file structure.

This means in particular also that whereas most data transfers rely on an ‘owner’ application, (eg: SqlServer to access a ‘SqlServer’ database), we are making possible data transfer regardless of the ‘owner’ application, simply by the file's compliance with the core protocol.

In this manner, a file or stream that has characteristics of a common ‘data’ file (document or spreadsheet, or other unindexed source file) and implemented according to the present protocol can, in conjunction with a preferred implementation of such an index, provide a storage and query engine that perform essentially all the functions as might be anticipated of a formal and complex RDBMS application, for example, while still retaining the transparent readability of a simple document. Since the preferred data format is a binary protocol, a document is intended to mean an ‘isolated, standalone file’ such as a spreadsheet, and for readability we mean the ability to read data items in both a sequential and random-access (by record ID aka reference) manner.

It will be illustrated further how the same basic indexing model can be applied to support both dynamic (occasionally changing) and volatile (rapidly, commonly changing) data, without constant re-structuring of the index sequence or hierarchy. The result, unlike traditional and alternative examples of both operating systems and data engines (RDBMS), is that a data storage engine is provided having a referential and atomic data model for storage and retrieval supporting both OS-level read/write and RDBMS-level structured storage/enquiry. The significance of this is that, like an OS, the preferred data engine is characterised as an agnostic, spontaneous data storage engine, and thus could be embedded onto a chip, and so provide the means for spontaneous storage of data items, with the enhancement that not only might an image, or telephone number be stored, but also any associated information at the sole discretion of the contributing application, without any need for a skilled and expensive intermediate engineer to oversee and enable that storage.

Although, the term ‘atomic’ is used here in the sense that it has been used in the art, it also has a very precise internal meaning for an atomic model of data, as it applies to the present embodiment as will become apparent.

### Indexing Data

An example will now be given to demonstrate how an index, which is to be atomic, and global to the store across all binary types, can be embedded into such a store. The choice of the final ordering mechanism by which the index is achieved is left to the implementation. Various indexing protocols are known in the art, including for example binary trees, 234 trees, red-black trees, hash-tables, linked lists and the like.

The focus will therefore be on illustrating how the data representations needed to support such an ordering can be embedded within the data store, consistently with the protocol. For its simplicity and familiarity, a binary-tree representation will be used as an example of such an ordering mechanism, to demonstrate how the basic operations necessary to support such a tree can be implemented in the preferred environment.

The first such mechanism is a comparison algorithm for comparing records, and allowing date to be ordered within the index.

The algorithm first makes a comparison of the Type ID, and then, only if the Record Types are found to match, compares the data in the records. The comparison of the Record Data Type is implemented by a CompareRT function (Compare Record Type), in which each record is determined as being either < (less than), = (equal to) or > (greater than) a target record. In the preferred embodiment, the comparison CompareRT algorithm is applied by using a Target record or filter, as follows:

The target record (a filter) is described as a [TypeID+Data (filter bytes)]. The TypeID is an Int32 (in 4×20 gauge) and integral to the protocol. Thus, TypeID can be tested explicitly, and by simple integer comparison, such that for a comparison of TypeID 12, the following would result:
[12<20]=−1 (where −1 signifies x<y)
[12=12]=0
[20>12]=1

Notice that the idea of ‘wild card’ (unspecified) for binary types is not supported. It is essentially meaningless. ‘Any’ binary type basically means ‘the entire file’, and if that was the intent then the reader could simply start at record 1 and proceed until the file is exhausted.

Thus, for a record 23 viz:
ID 23=TypeID: 12+DataBytes (some data)

And a filter of:
[TypeID (20)+DataBytes (filter)]

The result of the Compare operation of Record 23 against the Filter is determined entirely, by the comparison of TypeID. In this case TypeID (12)<TypeID (20), so Record 23 is determined to be ‘less than’ the Filter.

If the TypeID's match (both 12) then a comparison between the data bytes and the filter is carried out. If they are identical, then the returned value is 0. Although the details of an embodiment may be particular to that embodiment, without affecting the utility of the indexing mechanism, a preferred embodiment for comparing the data bytes of the record and filter is by simple byte comparison, namely: Record Bytes [18 204 29 19 0 0 0 0] against Filter Bytes [18 204 17 29 102 0 0 0].

At byte 3 (zero-based 2), 29 is greater than 17, so the record bytes are deemed greater than the Filter bytes. Since the protocol specifies a fixed-length embodiment for data storage, bytes of zero after the last non-zero byte are deemed to have no impact for comparison purposes.

Thus, to test for the Int32 29, in little-endian form [29 0 0 0] an existing record may comprise 16 bytes of data [29 0 0 0 0 0 0 0]. Although the stored 16 bytes are ‘longer’, since there is no discrepancy up to the end of the required filter or target (29 0 0 0) the remaining zeros are treated as having no impact, and a match is declared. Had there been an earlier discrepancy, the issue would be moot, as the earlier discrepancy would have determined the order.

Thus, in this basic example, the preferred strategy is to compare first the TypeID of a candidate record with the TypeID of the filter, and test for discrepancy by simple Int32 (gauge) arithmetic. If none is found, the data bytes are compared with the filter bytes, to test for a discrepancy. If none is found up to the common length of the candidate and filter, and the remaining bytes in either the filter or test candidate are zero, then the comparison result is deemed to be a match. It will be appreciated that the Comparison Algorithm described here illustrates the operation of the Match verb described earlier.

In many cases however, the intent is not to find the unique representation of an item within the databytes of a record, but all such items matching a key, mask, or filter. In this case, it is desirable to limit the requirement of the match to only the bytes of the key or mask, or to a subset thereof. For example, in a straight match of the candidate record [12 8 20 89 44 0 0 0] and filter [12 8 0 0] then because the candidate record has a ‘20’ in position 3 (2, zero based) and the filter has a 0, there would be a discrepancy, or mismatch. If the match condition was encoded as ‘match all bytes supplied in the filter’, the result would be that the candidate record would be determined as greater than the Filter (as 20>0). However, if the match was encoded as match (2) bytes, then since 12 and 8 agree (the first two bytes) in each of the candidate and the filter, so we could say that the record (bytes) for the candidate agree with the filter (up to the 2 bytes requested).

For this reason, the use of a ‘specified bytes’ or significant bytes model is preferred to express how many bytes should be used from the filter to determine a match, giving an entire match or a partial match. A match length parameter may therefore be passed to the compare algorithm to indicate how many bytes are to be matched. A match length of 3 for example would indicate that the leading three bytes are to be matched. ‘−1’ can be used to indicate that an entire match is desired.

Thus, it possible to compare records in the preferred protocol in a rational and consistent manner. This addresses ordering by naïve-byte comparison. It is not a collation algorithm, but does however allow a “left/right/match” flag to be determined as required for the indexing algorithm, in order to support first indexing, and then an atomic store.

To illustrate the indexing process, an example Triple will be indexed. For these purposes, the Triple is:
{gAndrew}.{gLives}.{gLondon}.

Notice that the preferred expression of data is via GUID identifiers, indicated by the {g . . . } notation. This allows the system to deal with the concept “Andrew”, namely a person of that name, regardless of other names by which he may be known. Thus GUIDs provide a useful ‘anonymous’ model of referencing, as known in the art, particular with reference to database synchronisation, and object (code object) identification. We extend their use to make them central to all semantic (human) declarations, eliminating the ambiguity of text as identifiers, and binding names only later (typically via Triples) to the identifier being described.

For the purposes of readability, rather than translating each string into its ASCII equivalent, or providing ‘real’ GUIDs for {gAndrew}, {gLives}, {gLondon}, a simple ordering test is adopted for ease of following the logic of the example. In this regime, the ‘pseudo’ GUID {gAndrew} precedes (is less than) {gLives}, because A precedes L in the alphabet, and {gLives} is less than {gLondon} because ‘Li’ precedes ‘Lo’.

It is coincidental that {gAndrew}<{gLives}<{gLondon}, and that they appear to be ordered. They actually represent a Triple: another Triple, such as

:{gAndrew}.{gLoves}.{gLondon}, would now be ordered {gAndrew}<{gLoves}>{gLondon}, since ‘Lov’>‘Lon’.

### Binary Tree Records

The premise of the ordering or indexing mechanism is that a binary tree will be created, comprising a root record, and subsequent child nodes (records) which will be designated left and right nodes. At each node, a single reference will be stored to an entity, which will be deemed the data element of the node being ordered.

While it is not necessary for a top-down scan of the tree to have access to the parent node identifier, we can readily include this in the design for convenience. Thus a typical binary tree node comprises:
Parent+Left (Child) Node+Right (Child) Node+Data Ref

### Declaring the Binary Tree Record

In order to store a binary tree record therefore, we first need to declare a binary type for the record by means of a binary type identifier, or GUID as described above. Assuming that a GUID is generated for this purpose, we may then refer to this GUID as {gBinaryNode} for readability.

To declare this as a binary type therefore, we simply store the GUID in the intended store, receiving a record ID say of 501. The TypeID reference that we will use (an Int32 in this gauge) will then be ‘501’ for any such record. In the 4×20 gauge of the preferred example, 4-byte integers are used as references for the parent, left, right nodes, and data ref. This will then comprise 4×4 bytes, =16 bytes of data per record, precisely that allowed by the 4×20 gauge. Thus we will use a single 4×20 record to encapsulate the data for the node, without extensions, whence its shorthand name, a singleton. Using singletons in this manner is preferred for convenience and efficiency where possible and appropriate. In different indexing protocols, multi-record data records, if appropriate could also be used. The reader/writer should make the storage of the basic binary data item {gTypeGUID}+DataBytes transparent with respect to gauge, simply writing extension records as required, and reassembling the segmented data back to a simple data item on read.

The root node will have no parent, and at inception, no children. In principle it would not be created without a data ref, which will be a reference to the first data item to be stored in the tree.

The final Triple is stored as a set of three records, one for each reference, plus a fourth record to declare the triple itself. In order to index the triple, at least one, and typically three more records at least are required. Naming the identities requires yet further records.

Storing a GUID for a Triple is achieved by storing {gUuid}+{gAndrew}, that is a reference to the (record ID of the) GUID binary type ‘TypeGUID’ or {gUuid}, plus the data bytes {gAndrew}. The GUID {gAndrew} itself representing that concept.

So given,

| | |
|---|---|
| {gUuid} + {gAndrew} | [stored as record 12] |
| {gUuid} + {gLives} | [stored as record 13] |
| {gUuid} + {gLondon} | [stored as record 14] |

And for the sake of completeness, the Triple binary type is represented as follows:
{gUuid}+{gTriple} [stored as record 3]

The Triple is defined (by means of a record ID, plus the three references and a zero (null)) as:
{gTriple}+(Databytes)[12, 13, 14, 0][stored as record 15]

It will be noted that by design, the gauge is a convenient fit for both GUIDs and Triples, the two most common storage types in the protocol.

### Binary Tree Creation

It is now possible to walk through a simple binary tree creation for the example.

Entering each in order, the individual elements {gAndrew}, {gLives}, {gLondon}, and then the triple {gAndrew}.{gLives}.{gLondon}, are stored as above. The first element, {gAndrew}, will go into root of the index, since it is the first node in the nominal index in order of entry. Thus, the first node comprises:

Parent = 0
Left = 0
Right= 0
DataRef = 12 [the REF to the record {gUuid} + {gAndrew}]

A new singleton record then to comprise root, as record 18, say:

[Node] TypeID (5={gBinaryNode})+Refs (0, 0, 0, 12) [stored as 18]

Entering a second node, the tree is scanned (in this case comprising only a root) and it is determined that {gLives}>{gAndrew}, so the second node is made a right-child of the root. A node is created as follows:

Parent = 18
Left = 0
Right = 0
DataRef = 13 [the REF to the record {gUuid} + {gLives}]

Storing this as say, 19, we have the node:

[Node] TypeID (5)+Refs (18, 0, 0, 13) [stored as 19]

A child node has now been created for the original root, as right child, so that record must be modified to:

Parent = 0
Left = 0
Right= 19 [** NEW **]
DataRef = 12 [the REF to the record {gUuid} + {gAndrew}]

Similarly, the {gLondon} is added, which is >{gAndrew} and >{gLives}, so is a right child of the {gLives} node, viz:

| | | |
|---|---|---|
| [New node]: | Parent = 19 | |
| | Left = 0 | |
| | Right = 0; | |
| | DataRef = 14 | |
| [Node] | TypeID (5) + Refs(19, 0, 0, 14) | [stored as 20] |

And the parent node ({gLives}, 19) is modified as:

Parent = 18
Left = 0
Right = 20 [** NEW **]
DataRef = 13 [the REF to the record {gUuid} + {gLives}]

Notice that the operations use the basic and standard methods appropriate to a low-level protocol stream (unindexed) being Read and Write. The identifiers have simply been written as required ({gBinaryNode}, {gTriple}, {gLives}, {gAndrew} etc.), and actual custom records of type {gBinaryNode}—the tree nodes. This has been done in a manner consistent with the protocol (properly defined, self-referential binary types for {gTriple} and {gBinaryNode}, maintaining the transparent readability at the level of the core data items type GUIDs+binary data. Yet, an indexing process that in due course will give a proper ‘atomic’ storage model, has clearly begun.

Completing, the example, by indexing the Triple noted above, namely:
TypeID (3={gTriple})+DataBytes((Refs)[12, 13, 14, 0]) [stored as 15]

To index this, the tree is scanned. It is not necessary to compare apples and oranges, e.g. REF bytes with {gAndrew}, because the TypeID is of course already different. It would not matter if there was a ‘junk’ or ‘variant’ type which mixed data types in a ‘generic’ handler, since the compare routine does not depend on ‘interpreting’ data, simply on ordering it for indexing purposes. It uses a simple byte array comparison therefore, but here, as noted, only the TypeID is needed, since the TypeID for a triple is 3 (in the example) and the TypeID for {gAndrew} (in root) is 5, so 3<5. Thus, the Triple is a left child of the root, viz:

Parent = 18
Left = 0
Right = 0
DataRef = 15 [the triple: TypeID 3 + Refs 12, 13, 14, 0]

Inserting this as:

| | | |
|---|---|---|
| [Node] | TypeID (5 = {gBinaryNode}) + | [stored as 21] |
| | DataBytes((Refs)[18, 0, 0, 15]) | |

The parent (root) is modified as:

Parent = 18
Left = 21 [** NEW **]
Right = 20
DataRef = 13 [the REF to the record {gUuid} + {gLives}]

For readability, a very simple algorithm has been used (scanning the tree and inserting left or right) to exemplify the process of providing a one-dimensional index for data items, across multiple binary types (as distinguished by TypeID, and the referenced binary type identifier), using a distinguishing Compare method, to determine < (less than), == (equals), > (greater than) for the purposes of assigning and navigating left and right. In practice, more complex algorithms allow for ‘node balancing’, and are well known in the art. The essence remains however, to be able to declare a new node, and read/write existing nodes, in the manner illustrated here.

On this basis, an Atomic Index can be provided for the file. First, however, two conditions need to be met:

a) it should be possible to consistently ‘find’ the root so that the tree can be navigated;

b) all (intended) records should be included in the index.

### Identifying the Index

Various methods can be applied to identify the index. The simplest is to look for the first record of type {gBinaryNode}. This will only work however provided that the root remains unchanged, and in certain algorithms, balancing the tree means shifting the root assignment between nodes, so that the original root may be demoted, and some other node take its place.

It would of course be possible to ‘keep’ the root in place, and re-write the data REFS etc. to reflect the desire to have the root be the ‘first’ index record. In a complex environment however, there may be a desire to have other ‘sub’ indices, as we will see with triples, and it is in any case perhaps desirable to insist on ‘explicit’ and unambiguous declarations for the root role.

A second method therefore is to declare a header record. Header records are well known in the art, so we will only describe a simple example embodiment as it may be encapsulated in a preferred embodiment.

In the example embodiment, an Index Header Record may be defined using the generic binary type {gIndexHeader}, we may decide that it comprises:

a) an indicator as to role;

b) an indicator as to method;

c) an indicator as to node type;

d) a reference to the root node.

Thus, the role may be {gMasterIndex}, the method {gSimpleTree} and the node is {gBinaryNode}, with a reference ‘18’ for the root node, as entered. Obtaining references for the TypeID for {gIndexHeader) and REFS for the other indicators, gives:

```
Type ID 7 = {gUuid} + {gIndexHeader}
      ID 8 = {gUuid} + {gMasterIndex}
      ID 9 = {gUuid} + (gSimpleTree}
```

And we already have
ID 5=gUuid}+{gBinaryNode}

This gives us a nominal header as:
ID 10=TypeID (7={gIndexHeader})+DataBytes((Refs) 8, 9, 5, 18)

This simple example gives several advantages over the ‘blind seek’ for a root node without a header, as it gives a predictable record to look for (it is possible also to look for the indicators and look for a header with those indicators), and it gives us an explicit reference for the root node. The indicators give explicit ‘hints’ as to role (master index), method (simple tree) and node type (binary node). If any of those elements are unexpected, we can anticipate that this file may have been prepared by another model entirely.

A reading application may be a diagnostic tool, for example, and such indicators may for example clarify whether to port ‘legacy’ information or attempt to unravel a corrupted file. The protocol described herein is strict and simple, making corruption far less onerous than in other complex environments, but nevertheless transparency is highly desirable, and the header assists that providing the assurance that an application intending to operate as a data engine may accurately manipulate (scan and store data in) the file without causing confusion or corruption.

With legacy applications, no one would dream of using a spreadsheet application to open a database file, and if attempted, the system would throw an error. However, the preferred data storage and retrieval engine allows precisely that flexibility, at least to read and benefit from other sources, in addition to providing a spontaneous structured store using indexing protocols as noted above.

In the example illustrated records were added and at the same time indexed. However, clearly, any records entered prior to the initialisation of the index must also be entered and this process is referred to as ‘catch up’. The verb use to deal with this is ‘Inform’. Thus, the index is ‘informed’ that TypeID (1={gUuid})+DataBytes ({gUuid}) is REF 1. Likewise, {gExtn} is Ref 2, etc. Normally, these would be the first records in the binary tree, but maintaining the flow of the example, the ‘new’ records are:

Parent = ? [to be determined]
Left = 0
Right = 0
DataRef = 1 ({gUuid})

The same node declaration can be made for {gExtn} with appropriate amendments. At the discretion of the implementation, flags and out of protocol records may or may not be indexed. Largely this may depend on the ease of administering the index to include/exclude out of protocol records.

### Triples and Multi-Dimensional Indices

To be effective, the preferred protocol should be able to match on any combination of the elements of a triple. Thus, for the three elements of a Triple [E, F, I]=[Entity, Feature, Instance] matching according to EFI, EF*, E*I, *FI, E**, *F*, **I, should be possible.

EFI, EF*, E** has already been indexed accurately, since a compare algorithm has been illustrated based on sequential comparison from the lead bytes. However, to accurately match for *F*, either every triple needs to be read, and tested for the middle reference being F, or another way to order the records for fast indexing needs to be found.

Two methods will be considered, in which the premise is the same: a second, and third index, for the other two dimensions of a cyclic index, are created.

EF* can be thought of as nm* in dimension one, m and n being filter REFS to match, the *FI can be thought of as np* in dimension two, that is cycled once to FI*. Likewise **I can be thought of as p** in dimension three, that is cycled twice to I**. In this fashion, we create ‘extra’ representations of the triple, cycled into dimensions two and three (one and two, zero based). These representations are then once again ‘lead-indexed’, but the lead is the Feature (dimension two) and Instance (dimension three), so that when wanting to match for Triples *F*, triples-cycled-once, as F**, can be matched.

When considering how to store these ‘extra’ representations, either ‘additional’ indices can be created for which the header definition, is particularly useful, and store ‘dimension-two’ representations in a ‘dimension two’ index, and ‘dimension three’ in a ‘dimension three’ index. The advantage here is that in fact no ‘extra’ representations are required, since the original data REF to the original triple is simply being stored in a ‘different’ order, as determined by the cycle.

To perform a store of the extra dimensions, or to match against the extra dimensions, an engine offering this facility first cycles the enquiry into ‘lead’ (as in leading) form, so that *FI is cycled once to FI*. The appropriate triples are then sought, for new insertion or match purposes, using standard compare (TypeID+data bytes) but using the second index (or third, if the third cycle is required).

This disadvantage is that of course at least one, possibly two, extra indices are required to be supported. An alternative is to keep a single, one-dimensional index (lead-indexed only), but to perform the cycling as noted above, and store that cycle. Thus for the triple EFI, it is possible to create the subordinate records:

Triplex_F: FIE (+ original Triple ref)
Triplex_I: IEF (+ original Triple ref)

This gives Triplex (triple, cycled) records, of ‘_F’ (cycled once to Feature lead), ‘_I’ (cycled twice to Instance lead). Assigning binary types to {gTriplexF} and {gTriplexI}, an effective multi-dimensional index can be created for the Triple type with only a one-dimensional primary index.

Thus index complexity is reduced (one primary index), and ‘pointer’ records are used to indicate from the cycled form back to the ‘actual’ triple.

The pointer is the fourth reference after the cycled triple refs, and points back to the original Triple ref. Thus the ID returned for EF*, E*F, and *FI will all be consistently the original ID for EFI (for that nominal triple), so that atomic referencing (one REF per ‘data item’) will be preserved, as regards the ‘naïve’ and core triple ‘EFI’.

The ‘indexing’ mechanism used to ‘get’ the record is arbitrary. It is the actual triples that ‘match’ the enquiry that are pertinent to the user, so we consider that it is the original TripleID that is most relevant to return in such an instance.

### SUMMARY

Thus, the preferred protocol described above can be advantageously used to provide indexed storage, having a facility to complete or catch up the index to ensure global scope. Furthermore, the index can be identified by a header to ensure consistent access to its root. The index can also support a plurality of indices (multiple actual indices) and allow a multi-dimensional index using a single index.

With this facility in place, the data engine according of the preferred example can be considered both a naïve, agnostic, spontaneous data store, akin to a disk drive or operating system, so that data can be stored ‘blind’ without prior engineering. This makes it convenient and adaptable for eg: embedding in chips and devices. Yet it also retains the capability of spontaneous structured data, providing facilities akin to an RDBMS (via custom types and triples). And with the indexed/atomic model, the engine can do so in an effective, efficient manner, using referential modelling, such as with triples, to identify and refer to items.

Thus an item may be stored blind, (an image, or other data, for example) and enhanced with supplementary data, again blind (without needing to be an ‘approved’ feature, engineered at the outset), sufficient to mimic the rdbms model yet with no prior engineering whatsoever. Moreover, the same item will retain only a single reference, courtesy of the atomic indexing model, saving space and improving performance.

Essentially, a hybrid OS/database on a chip has been demonstrated, though in practice it may not be installed on a chip directly, but may simply be coded as any other application, to be installed on a base operating system as required, and so provide a generic and indexed data store in that manner.

In the atomic model, the ‘first’ record found should be the ‘only’ record found, which is precisely the intent of Recognise.

Thus, a file/data protocol and a descriptor for that file/data protocol has been described in which:

a) the file protocol is capable of arbitrary, referential binary storage;

b) binary descriptions sufficient for automated merging are discerned;

c) binary indicators assigning the descriptions to each type are discerned;

d) those binary indicators are embedded or embedded into the file protocol.

In such a manner that two arbitrary and dissimilar engines following the conventions described herein provide a unique facility whereby a data store (normally the fixed destination for data storage) itself becomes a potential ‘transferable’ store of information to be merged into a second store. Although, similar facilities exist for OS-internal operations (across processes), and from OS-to-file operations (data serialization/deserialization), the provision of such an environment outside an operating system per se, so that it can be applied between files themselves, is believed to be new.

Having illustrated and described the principles of the disclosed technology by several embodiments, it should be apparent that those embodiments can be modified in arrangement and detail without departing from the principles of the disclosed technology. The described embodiments are illustrative only and should not be construed as limiting the scope of the disclosed technology. The disclosed technology encompasses all such embodiments as may come within the scope and spirit of the following claims and equivalents thereto.

What is claimed is:

1. A computer implemented method of storing data in a form suitable for transfer, comprising:
with a computer, receiving user data;
with the computer, receiving a unique identifier for the data type of the user data;
with the computer, creating a record in a data store, and storing the user data in the record with the indication of the data type;
with the computer, receiving user data defining the data type, the user data specifying for the data type at least the number of bytes of the user data that are intended as references to other records, or that are non-reference values; and
with the computer, creating a further record in the data store, and storing the user data defining the data type with the unique identifier in the record as a data type transfer descriptor.

2. The method of claim 1, further comprising:
with the computer, receiving a unique identifier for records containing a data type transfer descriptor; and
with the computer, storing the unique identifier in records containing data type transfer descriptors.

3. The method of claim 2, further comprising:
with the computer, receiving data defining the data type for records containing a data type transfer descriptor; and
with the computer, creating a further record in the data store, and storing in the record the data defining the data type for records containing a data type transfer descriptor, as a data type transfer descriptor for records containing data type descriptors.

4. The method of claim 1, wherein the act of receiving user data defining the data type comprises the number of bytes of the user data that are static, such that the remaining bytes are indicated as dynamic data bytes that can change with time.

5. The method of claim 4, wherein the user data defining the data type comprises 4 bytes of data indicates:
the number of static bytes in the record;
a leading number of reference bytes;
a number of value bytes; and
a trailing number of reference bytes.

6. The method of claim 1, wherein the act of receiving user data defining the data type comprises, with the computer, receiving user data specifying whether the data type is intended for transfer between data stores, or is not so intended.

7. A computer implemented method of transferring data from a first data store to a second data store, wherein data in the first data store is stored in one or more records, and for each data type of user data stored as one or more records, there is a data type transfer descriptor stored as a record, the method comprising:
with a computing device, reading a first record from the first data store;
with the computing device, identifying in the first record a data type indication;
with the computing device, identifying the record in the data store containing the data type transfer descriptor; and
based on the data type transfer descriptor and with the computing device, transferring records from the first data store to the second data store.

8. The method of claim 7, wherein the act of transferring the records comprises determining from the data type transfer descriptor, whether the record comprises user data that is solely non-reference value data, and if the record data contains solely non-reference value data, writing the first record to the second data store.

9. The method of claim 7, wherein the act of transferring the records comprises determining from the data type transfer descriptor, whether the record comprises user data that is intended for transfer between data stores, and only if it is, writing the first record to the second data store.

10. The method of claim 7, wherein the act of transferring the records comprises:
determining from the data type transfer descriptor, whether the record comprises user data formed of one or more references to other records, and if the record data contains such data:
determining the unique record identifiers in the first data store of the records referred to;
reading those records and any associated data transfer descriptors for those records; and
determining whether those records comprise user data that is solely non-reference value data, and if the record data contains solely non-reference value data, writing to the second data store the first record.

11. The method of claim 7, wherein the act of transferring the records comprises:
a) determining from the data type transfer descriptor, whether the record comprises user data formed of one or more references to other records, and if the record data contains such data:
b) determining the unique record identifiers in the first data store of the records referred to;
c) reading those records and any associated data transfer descriptors for those records; and
d) determining whether those records also comprise user data formed of one or more references to other records, and if the record data contains such data, repeating acts a) to d).

12. A computer readable medium having computer code stored thereon, wherein when the computer code is executed by a computer processor it causes the computer processor to perform the acts of:
receiving user data;
receiving a unique identifier for the data type of the user data;
creating a record in a data store, and storing the user data in the record with the indication of the data type;
receiving user data defining the data type, the user data specifying for the data type at least the number of bytes of the user data that are intended as references to other records, or that are non-reference values; and
creating a further record in the data store, and storing the user data defining the data type with the unique identifier in the record as a data type transfer descriptor.

13. The computer readable medium of claim 12, wherein the computer code, when executed by the computer processor, further causes the computer processor to perform the acts of:
receiving a unique identifier for records containing a data type transfer descriptor; and
storing the unique identifier in records containing data type transfer descriptors.

14. The computer readable medium of claim 13, wherein the computer code, when executed by the computer processor, further causes the computer processor to perform the acts of:
receiving data defining the data type for records containing a data type transfer descriptor; and
creating a further record in the data store, and storing in the record the data defining the data type for records containing a data type transfer descriptor, as a data type transfer descriptor for records containing data type descriptors.

15. The computer readable medium of claim 12, wherein the acts of receiving user data defining the data type comprises the number of bytes of the user data that are static, such that the remaining bytes are indicated as dynamic data bytes that can change with time.

16. The computer readable medium of 15, wherein the user data defining the data type comprises 4 bytes of data indicates:
the number of static bytes in the record;
a leading number of reference bytes;
a number of value bytes; and
a trailing number of reference bytes.

17. The computer readable medium of claim 12, wherein the act of receiving user data defining the data type comprises receiving user data specifying whether the data type is intended for transfer between data stores, or is not so intended.

18. The computer readable medium of claim 12, wherein the computer readable medium comprises a memory or a hard disk.

19. A computer readable medium having computer code stored thereon for transferring data from a first data store to a second data store, wherein data in the first data store is stored in one or more records, and for each data type of user data stored as one or more records, there is a data type transfer descriptor stored as a record, wherein when the computer code is executed by a computer processor it causes the computer processor to perform the acts of:
reading a first record from the first data store;
identifying in the first record a data type indication;
identifying the record in the data store containing the data type transfer descriptor; and
based on the data type transfer descriptor, transferring records from the first data store to the second data store.

20. The computer readable medium of claim 19, wherein the act of transferring records comprises determining from the data type transfer descriptor, whether the record comprises user data that is solely non-reference value data, and if the record data contains solely non-reference value data, writing the first record to the second data store.

21. The computer readable medium of claim 19, wherein the act of transferring records comprises: determining from the data type transfer descriptor, whether the record comprises user data that is intended for transfer between data stores, and only if it is, writing the first record to the second data store.

22. The computer readable medium of claim 19, wherein the act of transferring records comprises:
determining from the data type transfer descriptor, whether the record comprises user data formed of one or more references to other records, and if the record data contains such data:
determining the unique record identifiers in the first data store of the records referred to;
reading those records and any associated data transfer descriptors for those records;
determining whether those records comprise user data that is solely non-reference value data, and if the record data contains solely non-reference value data, writing to the second data store the first record.

23. The computer readable medium of claim 19, wherein the act of transferring records comprises:
a) determining from the data type transfer descriptor, whether the record comprises user data formed of one or more references to other records, and if the record data contains such data:
b) determining the unique record identifiers in the first data store of the records referred to;
c) reading those records and any associated data transfer descriptors for those records;
d) determining whether those records also comprise user data formed of one or more references to other records, and if the record data contains such data, repeating acts a) to d).

24. The computer readable medium of claim 19, wherein the computer readable medium comprises a memory or a hard disk.

25. A data storage system for storing data in a form suitable for transfer, comprising:
a data store; and
a data writer that in operation:
receives user data;
receives a unique identifier for the data type of the user data;
creates a record in said data store and stores the user data in the record with the indication of the data type;
receives user data defining the data type, the user data specifying for the data type at least the number of bytes of the user data that are intended as references to other records, or that are non-reference values; and
creates a further record in the data store, and stores the user data defining the data type with the unique identifier in the record as a data type transfer descriptor.

26. A data storage system for transferring data from a first data store to a second data store, wherein data in the first data store is stored in one or more records, and for each data type of user data stored as one or more records, there is a data type transfer descriptor stored as a record, comprising:
a data store;
a data reader that in operation:
reads a first record from the first data store;
identifies in the first record a data type indication;
identifies the record in the data store containing the data type transfer descriptor; and
based on the data type transfer descriptor, transfers records from the first data store to the second.
